(19) United States
(12) Patent Application Publication
(10) Pub. No.: US 2016/0188813 A1
(43) Pub. Date: Jun. 30, 2016

(54) SYSTEMS AND METHODS FOR EVALUATING MEDICAL PROCEDURES PRACTICES, AND/OR DIAGNOSES

(71) Applicant: TREATMENT SCORES, INC., Sebring, FL (US)

(72) Inventor: Bradley Richard HENNENFENT, Sebring, FL (US)

(21) Appl. No.: 14/868,624

(22) Filed: Sep. 29, 2015

Related U.S. Application Data
(60) Provisional application No. 62/198,383, filed on Jul. 29, 2015.
(60) Provisional application No. 62/056,747, filed on Sep. 29, 2014.

(51) Int. Cl. G06F 19/00

(52) U.S. Cl. CPC G06F 19/327; G06F 19/363

(57) ABSTRACT

Systems and methods for providing evaluation scores for medical procedures or clinical studies are provided. The evaluation scores are generated based on quantitative and qualitative information of the medical procedures or clinical studies provided from databases of peer-reviewed and non-peer reviewed medical information. To generate the evaluation scores, diagnostic features inputted by a user are also taken into account. These may include disease type, disease characteristic, disease progression, follow-up time, patient population, or individual patient characteristics such as age, gender, height, weight, health history, etc. A user interface is provided to conveniently show the medical procedures or clinical studies ordered by the generated evaluation scores. The user interface may also show the input diagnostic features as well as some of the quantitative and qualitative information of the medical procedures, clinical studies, or data.

### CROSS-REFERENCE

This application claims the benefit of U.S. Provisional Application No. 62/198,383, filed Jul. 29, 2015, and U.S. Provisional Application No. 62/056,747, filed Sep. 29, 2014, which applications are incorporated herein by reference.

This subject matter of this application may be related to the subject matter of the following co-pending patent applications: application Ser. No. 13/336,596, entitled “Method for Quantifying the Science of Medicine” and filed Dec. 23, 2011, and application Ser. No. 13/827,438, entitled “Systems and Methods for Evaluating Medical Procedures, Treatments, Decisions, and Diagnoses” and filed Mar. 14, 2013, which are incorporated herein by reference.

### BACKGROUND

The present disclosure relates to systems and methods for facilitating the review of medical literature and knowledge by medical professionals, patients, and others. Many medical social networks and databases can currently be used to calculate claim reimbursements from health insurance companies using models and formulas applied to the data from these networks and databases. Models and algorithms have also been provided to calculate insurance reimbursement from a medical claim and risk analysis for medical procedures. Such models and algorithms may use a variety of data such as patient history, procedure history, experience required, success ration, and other data available through a network or database. While there are many tools available to calculate payments and reimbursements to healthcare providers such as HMO or other medical groups, fewer tools are available for physicians and patients to evaluate and decide which of many therapeutic or diagnostic procedures to perform or undergo prior to the payments and reimbursements stage.

The following US patents and published pending applications may be relevant: U.S. Pat. Nos. 7,739,128, 6,827,670, and 5,915,241, and U.S. Publication Nos. 2013/0238353, 2012/0166217, 2009/0125348, 2008/0201172, 2006/0293923, 2002/0138306, and 2002/0184050.

### SUMMARY

The present disclosure relates to methods and systems to quantify or rate medical or clinical procedures, diagnoses, and/or studies through a network-based or web-based repository of quantitative ratings generated by the system. The quantified evaluation or rating may be based upon a multiplicity of inputs, including the interested medical or clinical procedure, diagnosis, and/or studies itself; a social network of medical practitioners, including physicians, experts, nurses, and healthcare providers; medical publications, journals, and research studies; a social network of patients; and/or combinations thereof.

More particularly, it is an object of the present disclosure to provide methods and systems for quantifying the science of medicine, i.e., to provide a quantitative value associated with medical procedures and diagnoses. In other words, medical procedures and diagnoses can be given a quantitative value or rating based on multiple factors, including the quantitative and qualitative information obtainable from published clinical studies related to the medical procedures and diagnoses. The quantitative value or rating of a specific medical procedure, therapeutic and/or diagnostic, can easily be compared to the quantitative value or rating of other medical procedures. By facilitating such comparison, physicians and other medical professionals (and patients and caretakers) can evaluate a variety of medical procedures, therapeutic or diagnostic, for the science of medicine or for recommendation to a patient while reducing the need to closely evaluate the merits of the choices of procedure through reading much of the relevant literature. A medical procedure may include the giving of any medical treatment, whether it is a pill, an actual physical procedure or intervention, a treatment with a medical device, surgery, etc.

It is another object of the present disclosure to provide methods and systems for quantifying the science of medicine, i.e., to provide a quantitative value associated with medical procedures and diagnoses, wherein the quantitative value is applicable as a criterion for reimbursement of medical and clinical procedures, treatments, diagnoses, and/or decisions including tests, medications, procedures, etc., and applicable as a benchmark for automatically measuring and tracking the quality of medical services by comparison.

Yet another object of the present disclosure is to provide systems and methods for social network connections among physicians (and others) for the identification of the quality of medical studies, identification of benchmark practices (or best practices) for a therapeutic and/or diagnostic procedure, and correlating the science of medicine supporting the benchmark practices for providing a quantitative value of the available science, practice, and quality of medical services.

These and other objects and aspects of the present disclosure will become apparent to those skilled in the art after a reading of the following description of the preferred embodiment when considered with the drawings, as they support the claimed disclosure. While systems and methods to quantify the science of medicine are disclosed, the systems and methods may also be applicable to quantify other sciences or fields that publish studies, including decisions, hypotheses, or theories, for example, physics, chemistry, biology, economics, social studies, etc.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a schematic diagram of a network-based system, according to many embodiments;

FIG. 2 is a flow diagram of a method for quantifying for evaluation purposes a medical procedure, according to many embodiments;

FIG. 3 is a flow diagram of a method for quantifying for evaluation purposes a medical procedure, according to many embodiments;

FIG. 3A is a flow diagram of a high level method to provide or generate a treatment score or grade, according to many embodiments;

FIG. 3B is a flow diagram of a method for providing a user interface to implement the methods of FIGS. 3 and 3A, according to many embodiments;

FIG. 3C shows an exemplary diagnostic input menu, according to many embodiments;

FIG. 4 shows an exemplary diagnostic hierarchy, according to many embodiments;

FIG. 5 shows an exemplary lists of prostate cancer diagnoses, according to many embodiments;

FIG. 6 shows an exemplary pancreatic cancer diagnosis, according to many embodiments;

FIG. 7A shows an exemplary list of treatments, scores, and grades, according to many embodiments;

FIG. 7B shows exemplary guidelines for the list of FIG. 7A, according to many embodiments;

FIG. 7C shows an exemplary list of treatment scores and grades for the list of FIG. 7A, according to many embodiments;

FIG. 7D shows an exemplary generic list of treatment scores and grades for a list of treatments, according to many embodiments;

FIGS. 8A and 8B show legends of converting Science of Medicine scores into grades, according to many embodiments;

FIG. 9 shows a list of data points pertinent to the quantification of the Science of Medicine behind a treatment, according to many embodiments;

FIG. 10 shows an exemplary scale for visualizing the evaluation of diagnoses, according to many embodiments;

FIGS. 10A and 10B show exemplary scales for visualizing the generation of a treatment score based upon a main statistic and secondary statistics, according to many embodiments;

FIGS. 10C and 10D show other exemplary scales for visualizing the generation of a treatment score based upon a main statistic and secondary statistics, according to many embodiments;

FIG. 11 shows a treatment score calculation screen, according to many embodiments;

FIG. 12 shows an exemplary treatment grading scale, according to many embodiments;

FIG. 13 shows an exemplary detailed treatment grading scale, according to many embodiments;

FIG. 14 shows an exemplary detailed treatment grading scale, according to many embodiments;

FIG. 15 shows an exemplary basic study template concentrating on one statistic, according to many embodiments;

FIG. 16 shows an exemplary study template to capture a statistic, according to many embodiments;

FIG. 17 shows an exemplary study template with entry categories for “soft data,” according to many embodiments;

FIG. 18 shows the right half of the study template of FIG. 17, according to many embodiments;

FIG. 19 shows an exemplary list of studies with data points, according to many embodiments;

FIG. 20 shows an exemplary list of studies with more data points, according to many embodiments;

FIG. 21 shows an exemplary feedback pane, according to many embodiments;

FIG. 22 shows a high-level flow chart of the generation of treatment scores for a diagnosis, according to many embodiments;

FIGS. 23 and 24 show grading charts for treatment score scaling guidelines, according to many embodiments;

FIG. 25 shows an exemplary study template including relevance and quality subsections, according to many embodiments;

FIG. 26 shows a table of relevance grades and ratings, according to many embodiments;

FIG. 27 shows a table of study ratings, according to many embodiments;

FIG. 28 shows a table of study ratings, according to many embodiments;

FIG. 29 shows exemplary graphics showing a ceiling on a relevant statistic, according to many embodiments;

FIG. 30 shows an exemplary table of treatments showing a carrot ceiling placed on a statistic, according to many embodiments;

FIG. 31 shows an exemplary table of treatments showing a line ceiling placed on a statistic, according to many embodiments;

FIG. 32 shows an table of study templates where a score can be provided for the study type, according to many embodiments;

FIGS. 33A and 33B show a study template where medical information can be allocated and visualized, according to many embodiments;

FIG. 34 shows a menu for generating a study template, according to many embodiments;

FIG. 35 shows an entry menu for a treatment name and a desired statistic, according to many embodiments;

FIG. 36 shows an overall user interface for managing multiple study templates; according to many embodiments;

FIG. 36A shows a diagnosis level information and input bar of the interface of FIG. 36;

FIG. 36B shows an exemplary complete study template for the medical information study area for the user interface of FIG. 36;

FIG. 36C shows a magnified statistic box for the user interface of FIG. 36;

FIG. 36D shows the medical information study area for the user interface of FIG. 36; and

FIG. 37 shows an exemplary treatment score analyzer, according to many embodiments.

### DETAILED DESCRIPTION

Referring now to the drawings in general, the illustrations are for the purpose of describing embodiments of the present disclosure and are not intended to limit the present disclosure thereto. The present disclosure provides systems and methods for quantification of the science of medicine relating to any medical procedure, therapeutic diagnosis, and/or decision. The quantification may be based upon relevant information from a multiplicity of sources, including patient-specific data and records, test results, research publications, medical publications, case studies, insurance risk data, and social network “live” or near-real-time peer input, review or ratings, and/or combinations thereof. Additionally, rating by medical practitioners may be supplemented by ratings from other relevant and/or knowledgeable raters including experts having a scientific background, engineers, technologists, medical students, students in other health fields, lawyers, bureaucrats, statisticians, patients, and any layperson.

While it may be known to provide models for evaluating medical procedures that may use a variety of data such as patient history, procedure history, experience required, success ratio and other data available through a network or database, few systems and methods have been disclosed for providing a quantification value associated with each and every medical procedure, therapy, diagnosis, or combinations thereof. The present disclosure in its various embodiments provides systems and methods for providing a quantification value associated with each and every medical procedure, therapy, diagnosis, or combinations thereof for providing automated benchmarking for quantifying the science of medicine which can help lead to identifying best practices.

The present disclosure provides automated systems, semi-automated systems, and manual systems and methods that transform qualitative information and data into a quantitative value that corresponds to a medical procedure, therapy, diagnosis, and/or decision. The quantitative value may be unique for that specific procedure, therapy, diagnosis, and/or combination thereof. In preferred embodiments, the quantitative value is generated from a multiplicity of factors, including research publications, case histories, patient records, tests; peer rating of research publications, procedures, and/or diagnoses; social network “live” rating inputs for specific case(s); and/or combinations thereof.

Preferably, a medical database is provided in a server computer or “cloud-based” system including medical information used to provide remote access to users of the system via distributed network to allow authorized physicians, patients, employers, and/or insurance companies to capture, store, retrieve, and/or disseminate any medical records from any computer having access to the system, such as via the Internet and secure login via unique user identification and password combination, Personal Identification Number (PIN), biometric identification, and/or combinations thereof.

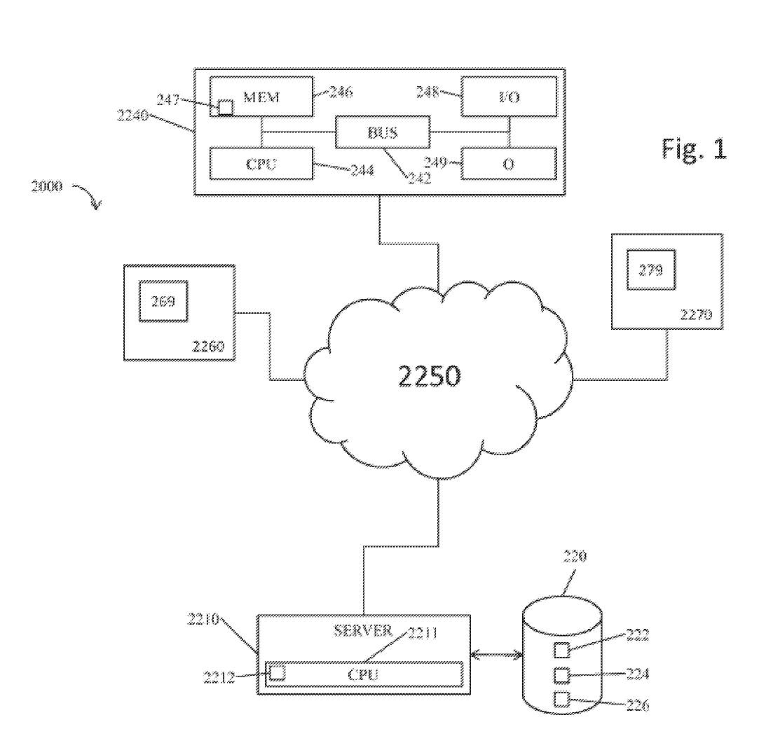

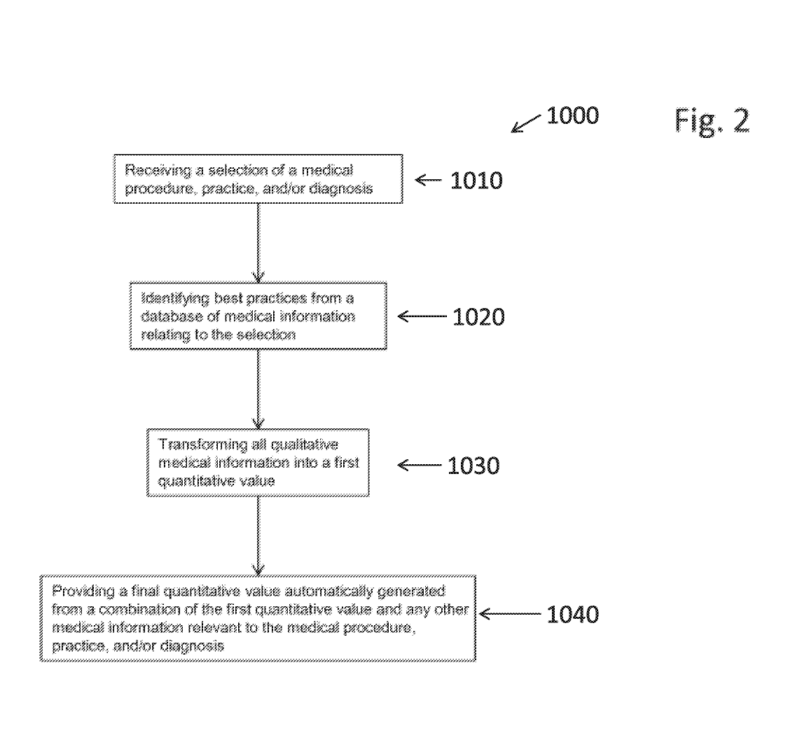

Preferably, a virtual network or cloud-based system is provided in support of a distributed network for accessing the medical database by a multiplicity of remote users, including but not limited to authorized physicians, patients, employers, and/or insurance companies, laypersons, etc. as illustrated in FIG. 1.

FIG. 1 is a schematic diagram of a networked system and remote server computer associated with the systems and methods of the present disclosure. As illustrated in FIG. 1, a basic schematic of some of the key components of the system including at least one remote server computer and network access to the system, according to the present disclosure are shown. The system 2000 is illustrated with a server 2210 having a processing unit 2111. The server 2210 may be constructed, configured and coupled to enable communication over a network 2250. The server may provide for user interconnection with the server over the network using a personal computer (PC) or other network device 2240 positioned remotely from the server. Furthermore, the system may be operable for a multiplicity of remote personal computers or terminals or network devices 2260, 2270, for example, in a client/server architecture, as shown. Alternatively or in combination, a user may interconnect through the network 2250 using a user device such as a personal digital assistant (PDA), mobile communication device, such as by way of example and not limited to a mobile phone, a cell phone, smart phone, laptop computer, netbook, a terminal, or any other computing device suitable for network connection. Also, alternative architectures may be used instead of the client/server architecture. For example, a thin client system or other suitable architecture may be used. The network 2250 may be the Internet, an intranet, or any other network suitable for searching, obtaining, and/or using information and/or communications. The system of the present disclosure may further include an operating system 2212 installed and running on the server 2210, enabling server 2210 to communicate through network 2250 with the users thereof. The operating system may be any operating system known in the art that is suitable for network communication. Additional software specific to the Science of Medicine (SOM) quantitative value generation based upon inputs, selections, and/or profiles of the user(s) or specific medical procedures, practices, and/or diagnose may be provided.

In systems according to the present disclosure, a system for providing automated, semi-automated, and manual rating of the science of medicine includes the following: a network-based computer system including at least one server computer in communication with a multiplicity of remote devices providing access to data stored within the at least one server computer, wherein the at least one server computer may be operable with software active thereon, the software transforming qualitative and quantitative information on medical procedures to a unique quantitative science of medicine (SOM) rating. Preferably, the system may further include online, remote access for authorized medical practitioner users and patients for initiating an inquiry into the remote server(s) database or repository of SOM ratings for a predetermined listing of medical procedures, practices, diagnoses, and combinations thereof.

Importantly, the qualitative and quantitative information on medical procedures may be transformed into a single, unique quantitative SOM rating based upon the following factors: a) whether or not at least one peer review study exists, or data from any source exists, that supports the medical procedure; and b) ranking by a social network of medical practitioners based upon their clinical experience.

In embodiments of the present disclosure, systems and methods including medical practitioner ranking inputs stored in a data repository at the remote server computer(s) provide for the medical practitioner ranking to be weighted such that the most recent inputs may be considered the most important and have greater influence on the overall ranking. It may be preferred that these inputs are provided in near real time to the inquiry by any remote user, i.e., less than about five years prior to the inquiry. This is a significant difference from any prior art, since medical journals and/or publications are considered in the SOM rating along with the medical practitioner ranking to transform all inputs into a single quantitative SOM code, percentage, or value. Medical journals, research publications and the like, especially when they have been under peer review, take many years to finalize and publish. However, they also offer important data-backed research and conclusions regarding medical procedures, practices, etc. And so, the combination of such highly credible references along with “near real time” inputs from medical practitioners based upon their relevant clinical experience by the system to transform the qualitative and quantitative information into a single quantitative value is highly beneficial for including credible references along with timely input from actual practice. Also, preferably, the ranking by a social network of medical practitioners based upon their clinical experience may include inputs within less than about two years prior to the inquiry, and more preferably, within less than about one year prior to the inquiry. Furthermore, beneficially, the system may provide the ranking by a social network of medical practitioners based upon their clinical experience includes inputs in near real time from the inquiry.

The SOM rating may be selected from SOM codes, percentages, ranking, and combinations thereof. The SOM rating may be output as an answer by the system, in response to an inquiry by a remote user accessing the system, the answer including automatically generated listing of best practice(s). And more preferably, the listing of best practice(s) may be provided in a ranked order from best or highest quantitative value to lowest, i.e., highest SOM rating to lowest.

In methods of the present disclosure the following steps are included, and illustrated in FIG. 2 showing a method 1000: (step 1010) providing a network-based computer system including at least one server computer in communication with a multiplicity of remote devices providing access to data stored within the at least one server computer, wherein the at least one server computer is operable with software active thereon for performing the steps of: receiving a selection of a medical procedure, practice, diagnosis, and/or decision; (step 1020) identifying practices (such as best practices) from a database of medical information relating to the selection, wherein the medical information includes qualitative medical information and quantitative medical information; (step 1030) transforming all qualitative medical information into a first quantitative value that corresponds uniquely to the medical procedure, practice, diagnosis, and/or decision; and (step 1040) providing a final quantitative value automatically, semiautomatically, or manually generated from a combination of the first quantitative value and any other quantitative medical information relevant to the medical procedure, practice, diagnosis, and/or decision, thereby providing an integrated, unique quantitative benchmark for the (best) practices for a specific medical procedure, practice, diagnosis, and/or decision. Preferably, the methods may further include the step of generating the first quantitative value from a multiplicity of factors, including research publications, case histories, patient records, tests; peer rating of research publications, procedures, and diagnoses; and/or social network “live” rating inputs for specific case(s).

In one embodiment of the present disclosure, the final quantitative value is based upon a scale of zero to 100, and is used as a treatment code for automatic comparison to a benchmark value, thereby assisting physicians and patients in decision regarding a course of action for medical treatment, and also providing a weighted data-based factor for determining insurance reimbursement level based upon the treatment code, i.e., the higher the number (0-100), the higher the quality of the procedure and therefore the higher insurance reimbursement amount. Thus, advantageously, insurance reimbursement for medical procedures can be determined in advance, and may be based upon quality of medical procedure or practice for a given diagnosis or condition.

Also, advantageously, while CPT codes are available for many procedures, there may be also many medical procedures without CPT codes established yet. The methods and systems of the present disclosure may provide automatic generation of a unique quantitative value for each and every procedure based upon the criteria used by the rating server and software, and accessible remotely by medical practitioners, including physicians, nurses, physician assistants, medical technicians, and the like, as well as patients, and other authorized users.

In another embodiment of the present disclosure, systems and methods may automatically or semi-automatically or manually generate three related quantitative values that are uniquely associated with a given medical or clinical treatment, procedure diagnosis, and/or decision. Those three related quantitative values are a Science of Medicine (SOM) percentage, a SOM score (or rating), and a SOM number or code, which may be used alone or in combination as outputs from the rating computer (remote server computer and software) available via the network for authorized user(s) accessing the rating computer from remote network devices, which may include, by way of example and not limitation, computers, smart phones, network or internet access devices, etc. Treatment Scores may be a subset of Science of Medicine Scores. Treatment Grades may be Treatment Scores as (e.g., alphabetical grades) instead of numbers.

In one example, the SOM percentage relating to any specific medical or clinical procedure, treatment, or diagnosis can range from 0 to 100%, and in some cases, the percentage can be negative—meaning that the harm outweighs the benefit. By way of illustrative example, if doctors were doing frontal lobotomies on patients with breast cancer, which makes no sense at all, the Science of Medicine percentage for that would be −100% (negative 100%).

Advantageously, the SOM values, either percentage, rating, or code, can provide a clear, concise, and unique quantitative value for any given procedure that may be automatically generated by the system and methods of the present disclosure based upon the medical social network's best medical advice based on the best medical literature available at the time of the inquiry to the system, and in the most easily grasped format possible (a single, unique value representing comparison to best practices, i.e., the best option for treatment under the totality of circumstances and information available). More specifically, the core of the algorithm used by the systems and methods of the present disclosure can ideally provide a minimum of two high quality, independently generated, randomized controlled studies that support a medical or clinical treatment, procedure, diagnosis, and/or decision for the system to automatically, semiautomatically, or manually generate a Science of Medicine percentage related to it at 100%. Furthermore, the treatment score or SOM percentage may represent access in real time to the most secret “inside medical information” possible, since it may include the advice of all physicians together through a social network, all providing inputs on how effective, safe and/or appropriate a medical or clinical treatment, procedure, diagnosis, and/or decision actually is, based upon experience, knowledge, etc. And by finding the best studies, and by sorting and sifting the data based on demographic information to remove biases, the output can be the most objective number possible.

In other words, the SOM percentage may be a way of summarizing the hardest available data from studies, however subjective and incomplete they may be, into the most objective and easily understood format possible, and generated automatically, semiautomatically, or manually by the system as a value, designed to separate fact from fiction to the fullest extent possible, provided by experts who are trained to do exactly this sort of thing. Preferably, a multiplicity of physician users can access the system, either at their own direction or they are automatically contacted based upon their user profiles stored in the database. Each of the physician users who are actively rating a select procedure, practice, diagnosis, and/or decision may provide inputs that are saved on the remote server computer(s) in connection with a given case, which may be anonymized to protect patient privacy data. The SOM percentage generated by the system may be the most objective number based on the medical literature, despite the fact that not enough studies have been done or imperfect studies have been done. Thus it may be a percentage that uses the user's or physician's skill at evaluating the medical literature to come up with the most accurate SOM percentage possible.

To some degree, the SOM percentage may be a gestalt number because there will be many situations where not enough studies, or not enough good studies have been done. But, the percentage may be based as much on the documented medical literature as possible. Physicians often make difficult decisions based on incomplete data virtually every day of their lives. Here they can make difficult ratings, as best they can, based on the published medical literature, although in the end there may always be incomplete data. It is a goal of the present disclosure is to generate the SOM percentage as close to the actual hard data as possible, i.e., to provide the most objective and quantitative accurate ranking for any given procedure, practice, etc. The SOM percentage can be contrasted with physicians' Clinical Experience (CE) percentage, which will be based more on their actual experiences practicing medicine.

By way of example, a urologist may rate the Science of Medicine percentage for doing a radical prostatectomy for localized prostate cancer very high based on their clinical experience because after doing surgery on men for prostate cancer, very few of those men ever come back to them with metastatic cancer. However, it may be evident that the urological literature says the Science of Medicine percentage is very low for this operation. That's why it can be important to compare both numbers, and to consider when bias, such as observer bias, is becoming a factor. Similarly, a cardiologist might rate the Science of Medicine percentage for doing cardiac stents for reducing the risk of heart attack low based on the medical literature, but might rate their Clinical Experience percentage much higher, as sometimes cardiologists see an immediate euphoria or improvement in patients after stents as the blood flow is improved, yet the controlled results in the medical literature are not nearly as encouraging. In the case wherein the rating physician has no clinical experience with the medical or clinical treatment, procedure, diagnosis, and/or decision being rating they would indicate “NA” that it is not applicable to them.

As of the date of the present disclosure, peer review of medical studies is often done by a handful of physicians who typically work for medical journals, which may allow for some bias to invade objectivity. For example, The New England Journal of Medicine and JAMA have repeatedly published opinion articles. Just having this opinion may cause bias to creep into the peer review process. Yet, this type of peer review, done by a small number of editors at a journal, is the prior art benchmark for the acceptability of a medical study. This is different from the present disclosure, which provides for at least one high quality study in order to realize a high quantitative value for the SOM percentage, rating, or code, or combination thereof. The present disclosure may provide for an increased or higher quality benchmark because it allows review by a very large group of physicians, or others, in near real time through a network and being remotely distributed from each other, and therefore effectively removing their biases. So then this method may provide a way to do a more rigorous, second level, of peer review, and by using the SOM database to remove biases you can get a third level of peer review. It may be worthwhile to make participating in this higher level of peer review part of the Continuing Medical Education process, and part of the requirement for renewing licenses, although it is not a requirement of the present disclosure.

Regarding the medical social network, ideally every medical practitioner, including physicians, around the world would be part of the Science of Medicine Social Network (SOM SN); however, practically, at least a multiplicity of licensed physicians from a diverse area of specialization or practice can be preferred. It would be better for there to be more physicians, particularly retired physicians, as they no longer have a financial stake in the game of peer review. Some biases may include, by way of example and not limitation, placebo effect, deference or respect for authority over data, lack of appreciation for detrimental side effects, lack of empathy, economic pressures, social pressures, and other internal and external pressures, and combinations thereof. Additionally, the present disclosure may provide for medical practitioners, experts, nurses, healthcare providers, patients, laypersons, and the like participating in the social network.

In another embodiment of the present disclosure, the SOM social network physician users or participants can also be encouraged to write original new medical review papers on medical or clinical procedures, treatments, diagnoses, and/or decision using the most highly rated and most relevant medical studies as determined by the Science of Medicine Social Network (SOM SN). These reviews can also be rated and sorted by date, ratings, or relevance to the medical or clinical procedures, treatments, diagnoses, and/or decision.

Medical practitioners may also be free to write opinion papers based on their clinical experience, sometimes without referring to the medical literature, and will be encouraged to publish “case reports,” as case reports are the springboard for new research hypotheses. These reports can also be rated. A score may be generated based on the opinion papers and surveys; and, by generating this score from a large number of opinion papers and surveys, the biases from individual medical practitioners can be minimized.

The participants may also be encouraged to write original new medical review papers on medical or clinical procedures, treatments, diagnoses, and/or decision using the most highly rated and most relevant medical studies as determined by the Science of Medicine Social Network (SOM SN). These reviews can also be rated and sorted by date, ratings, or relevance to the medical or clinical procedures, treatments, diagnoses, and/or decision.

Additionally, and optionally, the written contributions may include essays by physicians about treating patients, or about any subject, such as medical editorials, or editorials on other subjects. Poems may be a category too. This can allow the SOM SN to rate these writings so that good writers will rise to the top and be available for other purposes, especially as writers for our profession, the medical profession.

### EXAMPLES

The following are three examples where the SOM SN may have been used historically to lessen the damage caused by bad medical procedures or treatments such as lobotomies, early tuberculosis treatments, and unnecessary hysterectomies.

1. Lobotomy. By way of historical example, consider the frontal lobotomy procedure, which began in the 1930s and was flourishing in the 1940s and 1950s. As one of ordinary skill in the art will appreciate, it is a type of brain surgery where the frontal lobes of the brain are destroyed. Dr. Egas Moniz, a Portuguese physician actually won the Nobel Prize in Medicine for inventing the operation. That Nobel Prize looks inappropriate in retrospect. At first, they drilled holes in the head and destroyed some brain tissue by injecting alcohol. At times, simple knives were thrust into the brain. Later, they placed a retractable wire loop inside the brain and rotated it to destroy brain tissue. It was barbaric. The front of the brain is very important to us human beings. It is used for high level thought, helps us to make choices, to make predictions, and gives us our personalities. The frontal brain essentially makes us human. Dr. Moniz, the inventor of the lobotomy, and a colleague, operated on 20 patients with depression, schizophrenia, panic disorder, mania, catatonia, and manic-depression in the 1930s and published their results in 1936. They claimed that 35% of the patients improved greatly, 35% improved moderately and that in 30% there was no change. This is a perfect example of the kind of vested-interest observer bias the quantification of the Science of Medicine is designed to stop. As you might imagine, the frontal lobotomy was highly destructive to patients, yet, if you examine the medical literature at that time, which was mostly written by surgeons who profited from the operation, the literature was glowing, and focused on improving the technique, while avoiding any kind of controlled study being done. Side effects were seldom emphasized. President John F. Kennedy's younger sister Rosemary suffered from mental retardation and violent mood swings and her father Joe Kennedy had her undergo a frontal lobotomy in 1941, unbeknownst to her mother Rose. Reportedly, the operation left her with permanent urinary incontinence and unintelligible speech. This method will stop this kind of travesty. QUESTION: What was the Science of Medicine for doing the frontal lobotomy on patients with psychiatric problems? According to doctors who did the procedure at the time the Science of Medicine was 70%. Other doctors, however, began to write in opposition of the frontal lobotomy; these were often doctors who had known patients before the operation and saw them again after the operation. But the tremendous biases of the physicians promoting the frontal lobotomy won out for over two decades. ANSWER: The SOM percentage for doing the frontal lobotomy on patients with psychiatric problems is −100%, that's negative 100%! It always harmed the patient, but essentially never did them any good. It only succeeded, according to the harshest critiques, of turning them into vegetables—doing more harm than good. Examples like these are why the SOM systems and methods of the present disclosure are so important.

2. Tuberculosis. Tuberculosis (TB) was described by Hippocrates in 460 B.C. It has killed millions of people and still does; it actually killed 1.7 million people in 2009. Pulmonary tuberculosis, also called consumption, results in fever, coughing up blood, wasting away, and death. Tuberculosis is caused by a bacterium called Mycobacterium tuberculosis. In 1943, streptomycin, a new antibiotic was discovered. Previous antibiotics such as pyocyanase and lysozyme worked in the laboratory but were too toxic to even consider using them for human beings. Streptomycin worked in petri dishes and in laboratory animals, but was also toxic to humans. It causes side effects such as permanent dizziness, hearing loss, or kidney damage in a percentage of patients. The risk of permanent disability from taking streptomycin was very real. In the 1940s, there was a huge argument over the SOM of giving a toxic antibiotic like streptomycin to patients with pulmonary tuberculosis. Some people thought the Science of Medicine was greater than zero, while others, who had seen the horrible side effects from it, thought the Science of Medicine for taking it was actually negative. One clear fact was that people with pulmonary tuberculosis died more than 25% of the time. QUESTION: What is the Science of Medicine for taking streptomycin for pulmonary tuberculosis to prevent death? The first randomized controlled trial in medical history was done in Britain, and published in 1948, just to answer this question. The statistician was Austin Bradford Hill, who was later knighted for his work. It was a double-blinded study as neither patients nor doctors knew who got the streptomycin and who did not. At the end of the study 27% of the people with tuberculosis died in the control group of patients, while only 7% of patients died in the streptomycin-treated group. ANSWER: Back then, the Science of Medicine for taking streptomycin for pulmonary tuberculosis to prevent death was 20% based on this one study. When one considers later studies, and factors in the harmful side effects, the Science of Medicine (SOM) for giving streptomycin dropped to around 15%.

If all doctors and patients at the time knew that the SOM number was only around 15% for streptomycin saving your life, yes, people would have still taken the medicine, but the need to look for something better would have been abundantly clear. Rapid attempts would have been made to separate the patients into groups: those most likely to benefit and those most likely to be harmed. The SOM number would also be a great starting point for giving informed consent. Today, this medication would no doubt be banned for this use by the FDA. However, with the systems and methods of the present disclosure, it does not ban treatments completely, but leaves the decision up to the patient and doctor, and makes it clear that since the SOM number is so low, reimbursement for the medication by any insurance plan will be low, thus discouraging the use of medical or clinical treatments, procedures, and/or diagnoses with low Science of Medicine percentages and encouraging the development of better treatments. Complete bans kill innovation. Complete bans also kill patients who are willing to take the risks involved. Making ineffective treatments the standard of care—or Gold Standard—also kills innovation. What pushes innovation is everyone knowing the cold hard science. Fortunately, that era was a time of antibiotic discovery and six new anti-tuberculosis antibiotics would be invented in the 1950s. Most importantly, it was demonstrated that randomized controlled double-blinded studies give you the truth. A great deal of misinformation was settled by this study, changing history.

3. Hysterectomies. One of the worst abuses in medical history occurred even after the randomized controlled study had been recognized as the “Gold Standard” for Western medicine, and the entire sordid episode could have been prevented by the methods of the present disclosure. Doctors started doing unnecessary hysterectomies in the 1950s. Hysterectomies, which are the removal of the female uterus with or without the ovaries, became an epidemic in the USA. This was largely blamed on the profit motive of doing surgery, as well as paternalistic male attitudes. This bad episode in medical history helped to spur the feminist movement and the women's health movement of the 1960s. The hysterectomy is major surgery and thus the reimbursement for it was also “major.” Yet, the reasons given for doing the surgery were often unjustified. The stated reasons for doing hysterectomies are treating cancer, fibroids, abnormal vaginal bleeding, pelvic pain, for contraception, and doing it prophylactically to prevent ovarian or uterine cancer. Often these things did not make any sense at all. For example, there was clearly a time when the risk of dying from a hysterectomy was greater than the risk of dying from uterine cancer, yet the operation was done anyway. The side effects of a hysterectomy can be major—death, infection, bleeding, sexual dysfunction, and depression. The risk of death is around ½ percent. Urinary fistulas—abnormal connections—of the bladder to the vagina or of the ureter to the vagina also occur. This means the woman leaks urine out of the vagina. Post-operative fistulas of the rectum to the vagina can also occur. This means the woman leaks stool out of her vagina. These kinds of post-surgical side effects were often underreported in medical statistics. This is a reason why patient input into the Science of Medicine percentage would be very important. Patients, who have to live with these kinds of side effects often rank side effects as being far more serious than doctors do. Besides profit, sexism played a role. Most gynecologists at the time were men, so chauvinism and misogyny occurred. Sometimes, the male doctors' attitude was if you are not going to have children you don't need a uterus. Physicians told women that the operation would not affect their sexuality and if it did, it was psychological—their fault—and had nothing to do with the surgery. But sexual dysfunction was caused by the surgery. Hysterectomies can destroy hormone production, decrease lubrication, remove the possibility of an internal orgasm, and decrease sensitivity of the clitoris. Male doctors also treated women with a paternalistic attitude, telling them what to do instead of explaining all the options. The very word hysterectomy derives from the Latin hystericus, which is essentially defined as a neurotic condition of women related to them having a uterus. Studies found that male physicians were more willing to operate on women than upon themselves and that they were treating women like children, withholding information they thought might be “too much” for them. The major health insurance companies at the time were accidentally encouraging unnecessary hysterectomies because they were tending to pay for surgical and in-patient care much better than outpatient care. The Insurance Companies might never have made that mistake if the Science of Medicine behind hysterectiomies had been quantified at that time.

The hysterectomy epidemic was the perfect storm of greed, bad attitudes, unwise reimbursement policies, and lack of science. It's an excellent example of why biases need to be removed, because a surgeon's judgment can be impaired by indoctrination, biases, and self-interest. The SOM systems and methods of the present invention would have stopped this sad episode in American medical history. By 1970 over 4,000 studies had been done (Medline) that related to the hysterectomy, but no randomized controlled studies had been done. This allowed physicians to say anything they wanted to women about the need for the hysterectomy as the poor quality available data was open to wide variations in interpretation. For example, some physicians would tell women with fibroids of the uterus that they “had a tumor on the uterus” and this would scare them into thinking they had cancer, even though a fibroid tumor is benign 99.5% of the time. The poor science continues today; it needs to be fixed. QUESTION: What is the Science of Medicine percentage for a doing a hysterectomy on the average woman no longer wanting children with the average sized fibroid with average symptoms? ANSWER: 10%. Yet, because patients have no idea of how low the SOM percentage actually is for doing a hysterectomy for the average symptoms, they are easily talked into an operation which is not very scientific, instead of alternatives such as medical therapy or embolization, which may cost less, and be much safer for the patient. QUESTION: What is the Science of Medicine for doing a hysterectomy on the average woman no longer wanting children with LARGE fibroids and serious vaginal bleeding? ANSWER: 80%—based on the best medical studies today.

The algorithms that provide for the automated, semiautomated, and manual systems and methods of the present disclosure provide that doctors are networked and their demographic information is collected so that biases can be removed when necessary. For physicians, data collected would include such data as the state they live in, medical school they attended, residency they attended, current hospital affiliations and so on. Anything that could cause bias should be collected as demographic data.

The medical practitioners may be presented with a question about a medical or clinical treatment, procedure, diagnosis, and/or decision such as: What is the Science of Medicine for giving medication A to patients with diagnosis Z? The systems and methods of the present disclosure may provide an online, remote access for initiating an inquiry into the remote server(s) database or repository of ratings or SOM codes, percentages, or ranking, or combinations thereof; after making a selection of a procedure, practice, diagnosis, etc., the system automatically provides the best practice in a ranked order from best or highest quantitative value to lowest.

Medicine is a great field for this method because you can have one specialty looking over the shoulder of another. This can help to remove biases and vested interests from the results. Whenever data is interpreted, you need unbiased highly educated people to weigh in. Sometimes this may be the only way to remove the biases and indoctrination of an entire industry. A general point of this method is that when you remove the vested interests you can often get better ratings. Doctors doing operations also rating operations for reimbursement is a conflict of interest. It is possible that a large group of physicians could attempt to rate in a dishonest fashion because they are extremely well reimbursed for some medical or clinical treatment, procedure, diagnosis, and/or decision that is not scientific. This SOM SN can be designed to prevent such occurrences by allowing sorting of results based on demographic data and possible conflicts of interest.

Participants in the database might be asked to sign or follow an oath that they will make ratings based on reason, logic, and science, utilizing the medical literature to the best of their ability, and that they will do their best not be biased or corrupted by money. They will agree never to “sell” their ratings. They might want to also agree to practice medicine based on reason, logic, and science, while taking into account the physical as well as emotional needs of their patients.

The medical practitioners can give their Clinical Experience percentage for the medical or clinical treatment, procedure, diagnosis, and/or decision at hand first, as it requires no review of the literature, but is simply what they believe based on their experience and training to date. Physicians who do not have enough clinical experience with the medical or clinical treatment, procedure, diagnosis, and/or decision do not need to give a percentage. The clinical experience can also be used to add or subtract from the Science of Medicine treatment score which is based as much as possible on the data alone.

If necessary, for emergency situations, the systems and methods of the present disclosure can be initially set for defaulting the Science of Medicine number to 75%, 50%, 25%, or 0%, also where a lack of studies, information, or experience-based input is available, until the Science of Medicine is known. Alternatively, there could also be an emergency panel for emergency situations.

Medical practitioner raters may begin by rating studies for their relevance to that question. Next, they may rate the studies for their overall quality. As more ratings are done, the most relevant studies of the highest quality can be presented at the top of the list for all physicians to review while answering the question at hand. As part of rating the overall quality of a study, the raters may be asked to mark the characteristics of the studies. They may be asked to go through a checklist for each study. Is it randomized? Is it controlled? Is it prospective? Is it retrospective? How many patients were studied? Is the effect being studied large or small? Forcing the raters to mark the characteristics of the study, before they rate the overall quality of the study, may be a valuable reminder of the study's characteristics and how those features relate to quality.

Preferably, each rater will be rated as a rater of the SOM percentage, etc., and some of the third parties that use the SOM percentages from the database, may want to limit their results to the most highly rated raters only. The way the third parties sort the database information based on the demographic information and ratings may be up to them. Basically, when it comes to this database, everything that can be rated will be rated.

Prior art has tried to come up with ways to rate journal articles. One is to rate them on their impact, for example, showing how many times an article has been cited in other studies. Rating for impact may be a factor in systems and methods of the present disclosure, including a sorting system, or output presentation as well. There are search engines for “Journal Impact Factor” and “Author Impact Factor.” So then the SOM SN also may provide this data in up-to-date fashion for each physician rater. However, these methodologies are far from perfect, and so the SOM SN will provide with better ratings than these “impact ratings”, in particular since SOM SN outputs a qualitative value, rating, percentage, code, etc.

Every possible tool should be used to help rate the quality of medical studies. All public domain scoring systems to help evaluate studies and all those for which permission can be obtained should be used as tools when appropriate. For example, The Jadad Score is widely used.

The Jadad questions (paraphrased) are:

1. Is the study randomized? 2. Is the study double blind? 3. Is there a description of withdrawals and dropouts? One point is given for each yes answer. To receive additional points “yes” answers must be given to these two questions. 4. Was the method of randomization was described in the paper, and was that method appropriate? 5. Was the method of blinding described, and was it appropriate?

Points would be deducted if: The method of randomization was described, but was inappropriate or if the method of blinding was described, but was inappropriate. A randomized clinical trial could get a Jadad score of 5 if it was of the highest quality. As reviewers sit down to rate medical studies they should be given this tool to use as well as other tools like it.

There is also a longer checklist by Kenneth F. Shulz et al. that appears to be in the public domain for evaluating randomized controlled trials: http://www.plosmedicine.org/article/info:doi/10.1371/journal.pmed-0.1000251. This tool may also be utilized within the SOM SN, as should any others like it.

In fact, existing checklists, and checklists developed by the SOM SN should be used for every type of medical study as part of the evaluation process when possible. These could be pop-up tools available electronically. Each medical practitioner will be asked to give their Clinical Experience rating for each medical or clinical treatment, procedure, diagnosis, and/or decision (CE percentage.) Each medical or clinical treatment, procedure, diagnosis, and/or decision can have variations, co-morbidities or other situations such as age and sex can be added.

Next, based on the medical literature, each physician may give as objectively as possible, the Science of Medicine percentage behind each medical or clinical treatment, procedure, diagnosis, and/or decision. The SOM percentage of all raters may be averaged using all the standard formats such as mean, median, mode, geometric mean, and logarithmic mean, etc., and third party users can have the ability to remove outliers and raters based on demographic data. Other statistics can be provided as requested or suggested so that as many functions and manipulations can be done with the database as wanted.

SOM SN can further include a visible scale for where studies fall on the spectrum from 0 to 100%. For example, randomized controlled trials (RCTs) could go from 1% to 100% depending on the number of patients. Perhaps controlled prospective studies could go from 1% to 95% depending on the number of patients. If the SOM SN developed such a scale, it would help to give a visual guide to rating the quality of studies, and ultimately to rate the medical or clinical treatment, procedure, diagnosis, and/or decision.

There will occasionally be a situation with special circumstances where there is no science but everyone believes a medical or clinical treatment, procedure, diagnosis, and/or decision to be scientific. The present disclosure may provide for this with a Special Circumstances percentage. Women with ectopic pregnancy often die. The CE percentage for surgery might be 100%. The SOM percentage for surgery might be 70%. The Special Circumstances percentage for this surgery might be 90% simply because it's a situation where the risk to do proper studies is great.

The first guideline is that a medical or clinical treatment, procedure, diagnosis, and/or decision, to be rated 100% scientific, should have two independently done, high quality, randomized controlled trials (RCTs) supporting it. Since most RCTs are less than perfect in quality, it may be expected that most medical or clinical treatment, procedure, diagnosis, and/or decision with two high quality independently done RCTs supporting it would be rated in the 81 to 100% range. The second hard guideline may be that any medical or clinical treatment, procedure, diagnosis, and/or decision that has no studies or data supporting it would be rated 0 percent. The third hard guideline may be that a medical or clinical treatment, procedure, diagnosis, and/or decision that is net harmful to the patient would be rated with a negative percentage. The fourth hard guideline may be that a medical or clinical treatment, procedure, diagnosis, and/or decision with what is considered “average scientific evidence” behind it would be rated 50%. The fifth hard guideline may be that a medical or clinical treatment, procedure, diagnosis, and/or decision that only has one case report supporting it, has to be rated very low in most cases, 5% or less.

If two high quality randomized controlled studies can give you a Science of Medicine percentage of up to 100%, what would be the next best situation? Perhaps the next best situation would be one randomized controlled study and one or more large prospective studies that support the medical or clinical treatment, procedure, diagnosis, and/or decision. Perhaps that is the situation required to rate something 80 to 90%. If this is used, then any medical or clinical treatment, procedure, diagnosis, and/or decision that does not have one or more randomized controlled studies supporting it has to be rated <80%. But again, preferably, this is not a hard rule. There are often too many variations in the quality of such studies. Thus, SOM SN guidelines may be preferred, rather than a hard rule in this case.

After the first three hard criteria: two RCTs to achieve 100%, practices with no data may be rated 0%, and things that cause net harm to the patient get negative percentages, it may be very difficult to come up with rule that cannot be violated. This is why the fourth linchpin of the automated systems and methods of the present invention may provide that the Science of Medicine Social Networks (SOM SN) develops new methods for rating studies, and methods for rating the SOM percentage, and physicians describe their methods for coming up with ratings, and those methods are rated, until the best methods for rating the quality of studies and the SOM percentage rise to the top and can be used as reference articles for all the raters.

Regarding examples for exceptions, consider the following: SOM percentage may be preferably ranked as having “special circumstances” for things like pulse oximetry monitoring during surgery. The database can keep track of how many times a SOM percentage is marked as having special circumstances and sometimes a modified SOM percentage can be used in such situations. This may be the Special Circumstances percentage (SC percentage). For example, pulse oximetry to keep track of oxygen saturation in the blood is a common practice in anesthesia, being used virtually 100% of the time. It is cheap, easy, and does not harm the patient, but may provide a warning system if the patient might be doing poorly. However, there are no randomized controlled trials clearly supporting its use because of the “obviousness” of its benefit. If enough physicians within the specialty of anesthesiology flag the situation as special, and if enough physicians outside that specialty concur with the essays posted, that medical or clinical treatment, procedure, diagnosis, and/or decision should be given a special circumstances percentage as well as the regular SOM percentage, which is based on the medical literature alone.

The systems and methods of the present disclosure, by leveraging SOM SN may be designed to harness the collective intelligence of physicians and other experts. Research has shown that no one person or panel of people can keep up with the rate of change of technology or science. Mass collaboration may be needed to do this. You see this phenomenon in the “open source” software movement. It has been found that mass collaboration can reduce costs. For example, this SOM SN could replace thousands of medical boards and panels that are already trying to make these decisions for corporations and governments but are hopelessly overwhelmed. A huge group of physicians and other users can process the ever-expanding medical literature and come to conclusions far more rapidly than small panels can.

Advantageously, aspects and embodiments of the present disclosure provide the following benefits, which have been longstanding, unmet needs in the medical profession and to the general public accessing medical procedures and services:

1. It can create a social network and database. 2. It can organize the medical literature by quality and relevance for each medical or clinical treatment, procedure, diagnosis, and/or decision; essentially, a new method of peer review. It can allow variations for each medical or clinical treatment, procedure, diagnosis, and/or decision such as adding co-morbidities and techniques to be incorporated. 3. It can create new statistics called Science of Medicine Scores, Treatment Scores, Treatment Grades, the Clinical Experience percentage, the Science of Medicine percentage, and the Special Circumstances percentage. 4. It can remove biases by giving the ability to filter the Science of Medicine percentage statistic based on the demographic data and vested interests of the raters. 5. It can enable the Science of Medicine (SOM) percentage, CE percentage, or SC percentage to be tied to reimbursement. 6. The SOM percentage can be used for many other things such as informed consent, education, research, and innovation.

Step by step instructions for the quantification of the science of medicine—Introduction. The problem may be that there is no unbiased “product transparency” in healthcare for patients, physicians, and healthcare providers. Everyone agrees that a need exists to empower patients with knowledge. A need also exists to empower healthcare providers so that healthcare distribution can be more efficient.

Dr. Richard Fogoros describes the problem: “Medicine is complex and nuanced. In the U.S., doctors attend four years of college, then four years of medical school, then three years of residency; most add another two or three (or more) years of subspecialty training before they're turned loose to practice medicine . . . . To expect patients to become sophisticated enough to do much more than accept the recommendations' of their highly trained doctors is inherently problematic.”—Richard M. Fogoros, M.D., Fixing American Healthcare, 2007, (Publish Or Perish DBS, Pittsburgh), p. 217.

How is the problem solved? Dr. Fogoros goes on to say on page 301 of his book that, “Nobody knows what patient empowerment will actually look like because it hasn't been invented yet.”

The systems and methods of the present disclosure can empower patients, doctors, nurses, and all healthcare providers. It can revolutionize healthcare once it is understood and utilized. It will provide true “product transparency” for the first time in medical history.

Top Studies. Methods of the present disclosure can be used to establish the top 10, 20, 50, or even 100 most relevant and highest quality medical articles for any medical therapy or diagnostic procedure, and keep the database of studies updated. Each study can be rated for overall quality, but also for relevance to the medical or clinical treatment, procedure, diagnosis, and/or decision. Once the database of studies is established, each new physician or other user who looks at that same clinical problem will not have to repeat that research all over again. The SOM system may create a database of the best medical research articles rated for quality and relevance (essentially a peer-reviewed database) of articles pertinent to each medical or clinical treatment, procedure, diagnosis, and/or decision.

As an example of why this is needed follows: An inquiry about using a new antibiotic for a diagnosis was made. The three Drug Compendia that Medicare uses were all at least 2 years behind in evaluating the medical literature. The present disclosure would never be behind. All treatment and reimbursement decisions would be up to date and quantified.

Science of Medicine Score. Users may be asked to review the peer-reviewed database of best medical articles for any given medical or clinical treatment, procedure, diagnosis, and/or decision and give a Science of Medicine score for each medical or clinical treatment, procedure, diagnosis, and/or decision (from 0 to 100). The Science of Medicine score can be based on what the actual data (the hard science) says, and may comprise the overall score for how good a treatment the doctor believes that treatment to be based on the scientific data. Note that each individual study that has enough data can be used to produce a SOM score based on that one study, so that when the overall SOM score based on the entire collection of studies is given, it will be clear where the overall SOM score came from. The Science of Medicine score quantifies what is known, but just as importantly, it helps to make transparent what is not known.

Medical Practitioner Clinical Experience Score. After the Science of Medicine score, medical practitioners who see these patients are next asked to also give a Clinical Experience score (CE score). For example, the Science of Medicine score (SOM score) may only be 10 for placing a cardiac stent for chronic stable angina, but the practicing cardiologist may say “I see my patients getting immediate relief,” so that cardiologist may give a CE score of 90 for that practice.

Patient Clinical Experience Score. The patients can also be asked to provide a CE score based on their experience with a procedure. Patient CE scores can be for different time periods, such as immediately after the procedure and then at later times and intervals.

Comparisons. A big difference between any of the scores may reveal a problem. For example, there was a time when surgeons were reporting the frontal lobotomy to be 100% effective. Many poor quality studies supported that the frontal lobotomy was highly effective. However, the high quality studies said differently, but most patients and doctors had no idea. This system can point out and help to fix such discrepancies, because the differences between the SOM scores and the CE scores will be readily apparent. Where there is a large difference between the SOM score and the medical practitioner CE score and/or the patient CE score, there may be hype, perverse monetary incentives, bad science, or a powerful need to do more medical studies.

In addition, low SOM scores for any medical or clinical treatment, procedure, diagnosis, and/or decision may point out that there are not enough high quality studies, and will help to direct, and prioritize, medical research.

Science of Medicine Essays. Besides the SOM score and the CE scores, the next most important product created by this system may be the Science of Medicine essays. Physicians may be asked to write review essays in support of their SOM scores and CE scores. These essays may be critiqued and rated and may be published. These essays can enable a new type of medical article. SOM essays can teach medical statistics and critical thinking and they can be the most important form of continuing medical education yet devised. These essays essentially can continue the “Journal Club” education process, making it a lifelong endeavor for doctors. Journal Club will no longer be left behind in residency. These reviews are “doubly peer-reviewed,” because the articles on which the reviews may be based or will have been selected for quality and relevance by peer-review, and the written-up articles will also have been rated for quality by peer-review.

How Studies are Rated. Doctors may be asked to rate the top studies from 0 to 100 for each clinical situation (both for relevance and quality). When this is done in blinded fashion, and then the quality and relevance ratings are examined, there can sometimes very different lists of the “top studies” by different specialties of doctors. Each specialty may tend to be indoctrinated by its “famous people” into believing the famous people instead of the data. This “authority bias” or “eminence bias” can be too prevalent in medicine. “Commercial bias” may come into play as well. When it is in a specialty's financial interest to do a certain procedure, they are often more willing to accept poor quality, uncontrolled studies in support of their procedure. However, other experts reviewing the situation may clearly see this bias and will help to remove it from the final SOM Scores. There may also a “pharmaceutical bias,” where an industry may promote the literature they themselves funded, which our system helps to remove.

Double Peer Review. This process can give rise to what is call “double peer review.” First, the studies are peer reviewed for quality and relevance to a medical or clinical treatment, procedure, diagnosis, and/or decision, and then the review article based upon those studies can be reviewed for quality and relevance. This way, through “double peer review” the best review articles based upon the best studies are ensured.

Triple Peer Review. The present invention can also provide for a “triple peer review,” which is when the final review articles are rated against each other by professionals (or other experts) that are in the audience for that review article.

The essays may be produced as videos as well. Because of the Internet and cell phones, more and more people are using videos in preference to text.

Scoring Presentations. There are copious amounts of medical data that few can understand or compute. By using the 0-100 scoring system, this data can easily be translated into other formats. For example, letter grades can be assigned: one for each 20 percentiles in the positive range and F for anything with a negative SOM Score.

This gives scores of A, B, C, D, E, and F. For example, A may indicate the best quality evidence-based medicine studies and best quality treatment effect, E may indicate the lowest quality studies and lowest quality of treatment effect, and F may indicate a harmful treatment or procedure. Even with this rough focusing of the medical data, a vast improvement in understanding may occur. The treatment grades may be provided conveniently through a display or user interface of a mobile computing device such as a wearable computer, a smart watch, a mobile phone, or a tablet computer.

Reimbursement. Finally, the SOM score (or the CE score in some cases) may be tied to reimbursement. In this manner, the more scientific medical or clinical treatment, procedure, diagnosis, and/or decision can be reimbursed at a higher rate. This can drive patients to the most scientific and cost effective treatments and consequently save lives and money. This can solve the problem of how to distribute healthcare more efficiently, and can reduce costs for all healthcare providers that use the system. Since healthcare is a trillion dollar industry, any improvement in distribution can amount to millions or billions of dollars saved.

List of Steps. The following are exemplary method steps according to the present disclosure:

1) Create a social network of physicians (and others).

2) Create lists of diagnoses and treatments (and all medical or clinical treatment, procedure, diagnosis, and/or decision).

3) Organize the medical literature by quality and relevance.

4) Produce the Science of Medicine scores.

5) Produce the Clinical Experience scores.

6) Use data to remove or point out biases.

7) Utilize this system for Continuing Medical Education.

8) Produce Science of Medicine review articles based on the scores.

9) Produce Science of Medicine videos based upon the review articles.

10) Produce Codes for billing, diagnosis, and treatment.

11) Produce essays on how to prioritize research.

Conclusion. By quantifying the Science of Medicine, several things can be achieved: 1) patients can be empowered by making medical care more transparent, 2) medicine can be made more scientific by making the hard data more transparent, and by removing biases, and 3) the distribution of health care can be improved by allowing healthcare providers a more objective way to reimburse healthcare.

How It Works in Detail. The SOM Score may be far more sophisticated and valuable than any simple rating system now in existence. The algorithm can use demographic data to remove biases and the scores can improve in accuracy the longer the database exists. Here is a partial list of techniques that can actually be used by the Science of Medicine algorithm: co-intelligence, crowd wisdom, collective intelligence, the Delphi method, open-source medical algorithms, public domain tools, and artificial intelligence.

Techniques to remove biases and to point out when the experts are likely to be wrong or biased are disclosed herein. “Dashboards” are designed to point out these very issues and demonstrate the discrepancies and the likelihood of biases. Each end user can lay out their “dashboard” to discover what is in the data that is most important to them.

Techniques disclosed herein can allow the user to obtain the most accurate quantification for the Science of Medicine Score behind medical or clinical treatment, procedure, diagnosis, and/or decision. The end result may be a rating or score that is easily understood by everyone—patients, laypersons, doctors, nurses, allied healthcare professionals, webmasters, insurance companies, Medicare, Medicaid, and reporters. The database may be preferably updated daily in near real time by the SOM Network, taking into account every new medical study published almost as fast as they are published. Thus, the systems and methods of the present disclosure may quantify and make available to the user what everyone has always wanted to know: the inside medical information on what works—the knowledge that currently resides only inside the brains of our best physicians, nurses, other healthcare professionals, and sometimes the brightest and most experienced patients. This data can and will be displayed both together and separately as part of our process of removing biases and seeing problems never seen before.

Biases. The present invention may remove biases and rate the raters. Every step of the process is rated. In this way, each user of the database can pull out the data that is important to them. Perhaps a patient or third-party payer wants to compare how oncologists rate prostate cancer treatments compared to how urologists rate them. Perhaps they only want to see the ratings from the top 25% most highly rated physicians. They would be able to do all these things and more. The systems and methods of the present disclosure may rate the raters for their ratings and for their essays on the website or in the database, and rates their biographies and institutions as well.

Individualized. Note that while the SOM Scores start out being for a general diagnosis and treatment, over time they can be individualized to each and every patient.

Website Dominance. There are currently thousands of websites competing on the Internet for medical traffic. These websites are all doing the same thing: writing reviews of the medical literature. What they are not able to do is produce what everyone really needs, the Science of Medicine Score behind medical or clinical treatment, procedure, diagnosis, and/or decision—the most important piece of medical information. The website that accomplishes this quantification may become dominant over time because the Science of Medicine Score is the essential inside information. Imagine that a man suffers an acute heart attack. He writes to the Science of Medicine social network with his laptop from his hospital bed and says, “I have been offered long-term medical therapy, angioplasty, or open heart surgery. What are the Science of Medicine Scores for these things?” The man would actually be able to get accurate answers. No other website would be able to compete with such a service. Imagine if patients could do this for any medical question they had.

Physicians do not currently agree on the Studies. One of the reasons that the Science of Medicine Scores may be designed to remove biases is because different groups of physicians do not agree on the best studies for a given topic. In Journal Clubs, Mortality & Morbidity Conferences, in the comment and editorial sections of medical journals, and in the footnotes of review articles, you can see that the “experts” are not always basing their thinking on the same studies. They often tend to cite the studies that support their already existing point of view. This is why the SOM algorithm rates studies for both quality and relevance for the clinical situation being scored. This can get everyone on the same page using the highest quality and most relevant studies for their decision.

Most people will be surprised to learn that the majority of the medical or clinical treatment, procedure, diagnosis, and/or decision are not grade A. Most medical or clinical treatment, procedure, diagnosis, and/or decision are probably only grade C or below when one actually looks at the hard data behind them. This system can point out research that badly needs to be done.

Perhaps the A to F grading is all the precision that third-party payers would need for most payment decisions, since they are not necessarily making decisions on what to do, but only on how to reimburse at different levels for less effective therapy. For example:

Grade A—80% reimbursement.

Grade B—75% reimbursement.

Grade C—70% reimbursement.

Grade D—65% reimbursement.

Grade E—60% reimbursement.

Grade F—0% reimbursement.

The present disclosure can further provide for Insurance Companies and Government Healthcare programs adjusting their co-payments according to the grading of a procedure according to the present disclosure. Any change in reimbursement based upon science may help steer patients toward the best, most cost-effective care. This knowledge can get all parties talking about the Science of Medicine behind medical or clinical treatment, procedure, diagnosis, and/or decision. This can also make providers of care do better studies to try to get their reimbursement rates up for medical or clinical treatment, procedure, diagnosis, and/or decision that do indeed work, or would push them to innovate where treatments do not work well.

Growth. Over time the Science of Medicine social network can be expanded. Doctors from around the world, nurses, dentists, pharmacists, and, in fact, all allied healthcare professionals can be included. Also, scientists, mathematicians, patients and laypersons can be included. This will add to the ability to remove biases from the Science of Medicine Scores.

Journal Club. It is necessary to emphasize how important the Science of Medicine Journal Club would be for physicians. It can be frustrating to have to make a serious clinical decision at the bedside when there is incomplete data upon which to make that decision. Physicians do not want to practice guesswork with people's lives; doctors want to practice science. The same frustrations can be experienced throughout their careers. When the consultants come to the Emergency Room for emergencies to admit the patients, there are many questions for which there is no quantification of the data. Physicians all have the same problem: they never really know what they do know or do not know. The data has never organized enough, or available enough for them, because it has not been quantified.

Who should be in the Social Network? The SOM social network can be preferably open to everyone who wants to be in it: All the passionate people from all over the world who want to help someone or help themselves—the people for which this information is literally of life and death importance. Our rating systems will allow those who love science and know science the best to rise to the top.

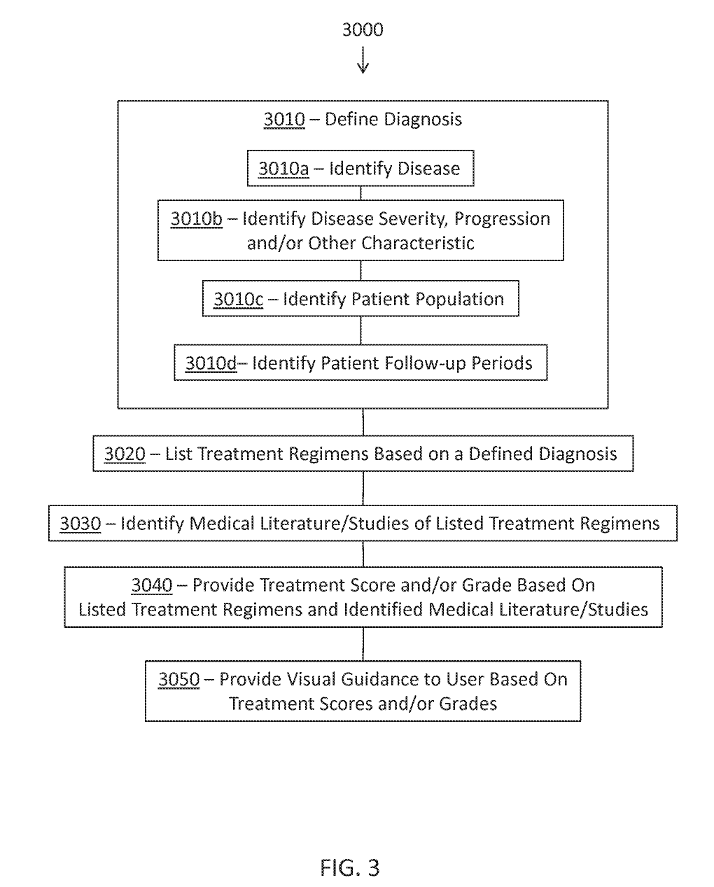

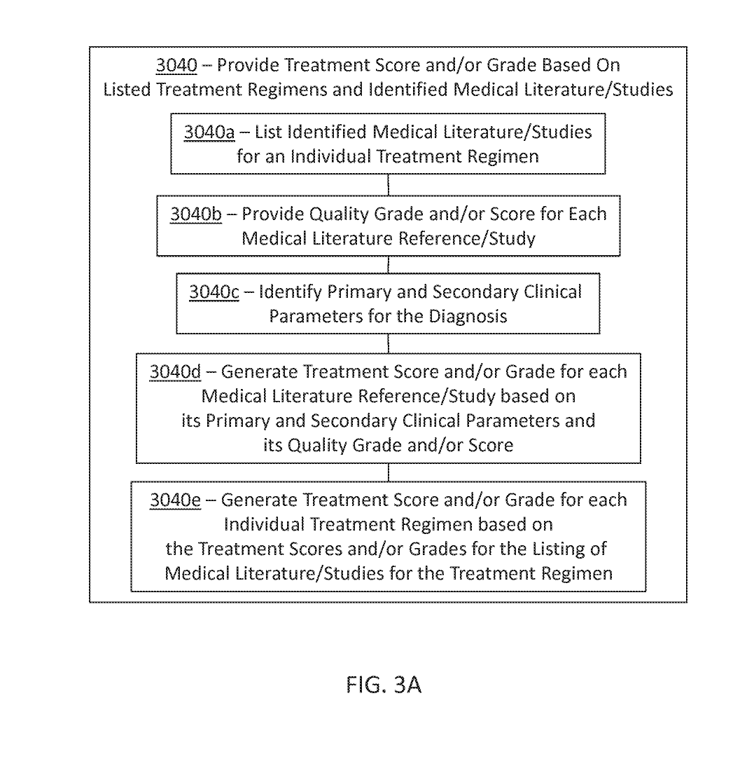

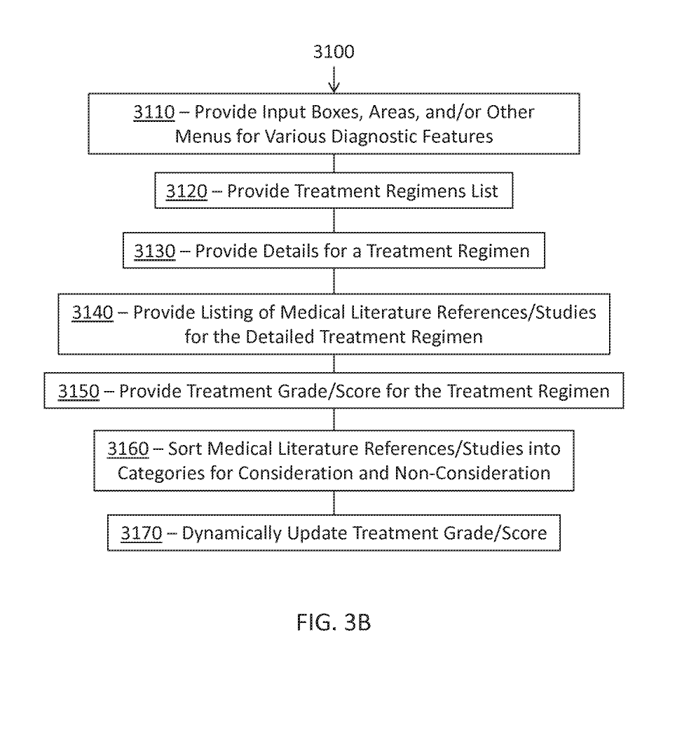

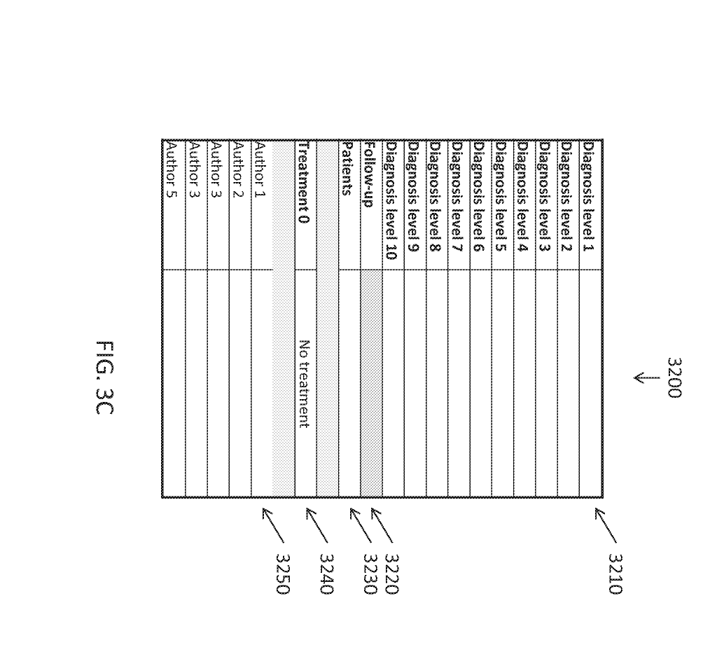

Generation of Precision Treatment Scores and/or Grades Based on Diagnostic Hierarchy. FIG. 3 shows a high-level flow diagram of a method 3000 of quantifying for evaluation purposes a medical procedure such as a therapeutic or diagnostic procedure. The computer-based system 2000 described above with reference to FIG. 1 may be used to implement the method 3000 or any of the methods described herein.

In a step 3010, a diagnosis may be defined. To define a diagnosis, many sub-steps may be taken. For example, the disease or condition may be identified in a step 3010a, the severity, progression, or other characteristics of the disease or condition may be identified in a step 3010b, the patient population of interest may be identified in a step 3010c, and the patient follow-up period of interest may be identified in a step 3010d. All or only a sub-set of these steps 3010a, 3010b, 3010c, or 3010d may be performed. For example, a diagnosis such as cancer may be identified and the diagnosis may be layered or characterized with increasing detail as follows: 1) cancer; 2) cancer, prostate; 3) cancer, prostate, stage 1, PSA 5; 4) cancer, prostate, stage 1, PSA 10; 5) cancer, prostate, stage 1, PSA 400; 6) cancer, prostate, stage 1, PSA 400, right-sided; and, 7) cancer, prostate, stage 1, PSA 400, left-sided.

In a step 3020, treatment regimens may be listed based on the defined diagnosis. The treatment regimens may be displayed on a user interface or display of a computing device, for example.

In a step 3030, medical literature and/or studies of the listed treatment regimens may be identified.

In a step 3040, treatment scores and/or grades may be generated and listed based on the listed treatment regimens and identified medical literature or studies. The treatment scores and/or grades may be generated in many ways as described herein.

In a step 3050, visual guidance based on the treatment scores may be provided to the user who may be a medical professional or patient. The visual guidance may be displayed on a user interface or display of a computing device, for example.

As described herein, treatment scores and/or grades for a treatment regimen or a diagnosis can be determined in many ways. As shown in FIG. 3A, for example, the step 3040 of providing a treatment score and/or grade based on listed treatment regimens and identified medical literature or studies may comprise a plurality of sub-steps.

In a sub-step 3040a, the identified medical literature/studies may be listed for an individual treatment regimen.

In a sub-step 3040b, a quality grade and/or score for each medical literature reference or study may be provided. The quality grade and/or score may be provided based on various criteria described in further detail below.

In a sub-step 3040c, the primary and secondary clinical parameters for the diagnosis may be identified. For example, the primary clinical parameter for the diagnosis may be overall survival rate and the secondary clinical parameters may be the probability of various side effects as described in further detail below.

In a sub-step 3040d, a treatment score and/or grade for each medical literature reference or study may be generated based on the identified primary and secondary clinical parameters and the quality grade and/or score of the medical literature reference or study itself. As described in further detail below, the generated treatment score and/or grade may be capped based on the quality grade and/or score of the medical literature reference or study. Thus, a medical literature reference or study describing a particular treatment regimen with a great overall survival rate may only have a mediocre overall treatment score and/or grade because the medical literature reference or study may have been conducted poorly.

In a sub-step 3040e, the treatment score and/or grade for the treatment regimen may be generated based on statistics from each medical literature reference or study describing the treatment regimen.

Although the above steps show the method 3000 of qualifying for evaluation purposes a medical procedure in accordance with many embodiments, a person of ordinary skill in the art will recognize many variations based on the teaching described herein. The steps may be completed in a different order. Steps may be added or omitted. Some of the steps may comprise sub-steps. Many of the steps may be repeated as often as beneficial.

One or more of the steps of the method 3000 may be performed with a processor and/or other logic circuitry of a computing device such as one described for use in the system 2000 above. The processor and/or other logic circuitry may be programmed to provide one or more of the steps of the method 3000, and the program may comprise program instructions stored on a computer readable memory or programmed steps of the processor and/or other logic circuitry.

To implement the method 3000, a user interface may be provided so that a user such as a layperson, physician or other medical professional can interact with the system 2000. As shown in FIG. 3B, a method 3100 provides a user interface to quantify for evaluation purposes a medical procedure such as a therapeutic or diagnostic procedure (e.g., with the method 3000 described above).

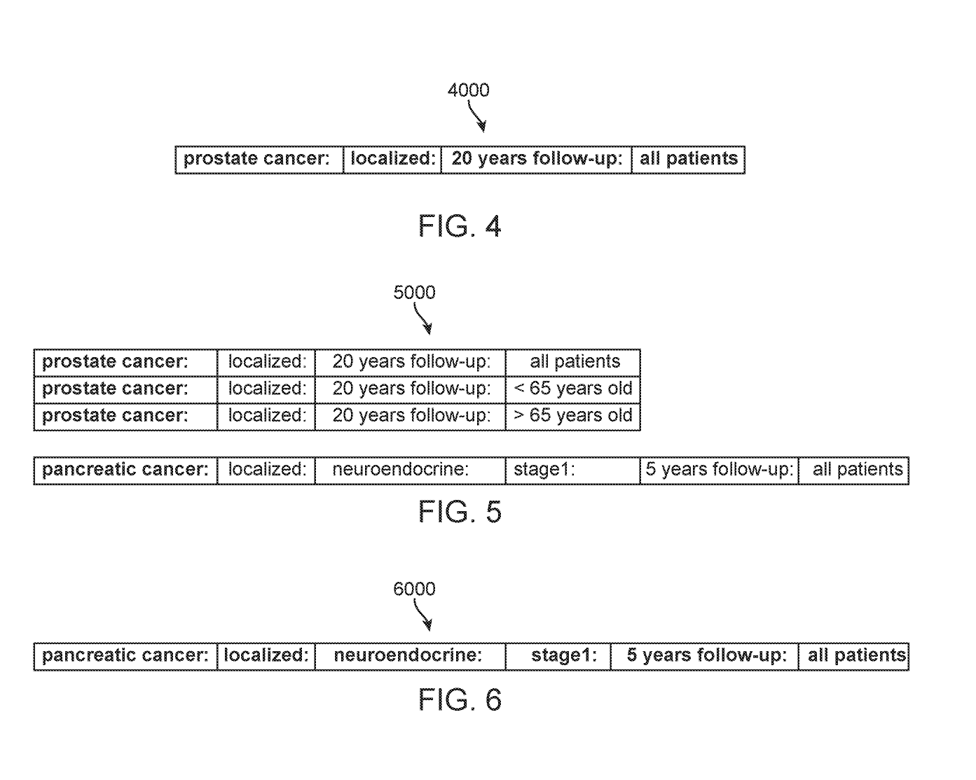

In a step 3110, input boxes, areas, and/or other menus for various diagnostic features to define a diagnosis may be provided. Examples of such input boxes, areas, and/or other menus are provided below by the input menu 3200 (FIG. 3), the diagnostic hierarchy 4000 (FIG. 4), the diagnostic list 5000 (FIG. 5), or the final diagnostic 6000 (FIG. 6). These input boxes, areas, and/or other menus may be provided on a webpage such as an index webpage, a tab such as a tab of a program or mobile app, a menu bar, or the like.

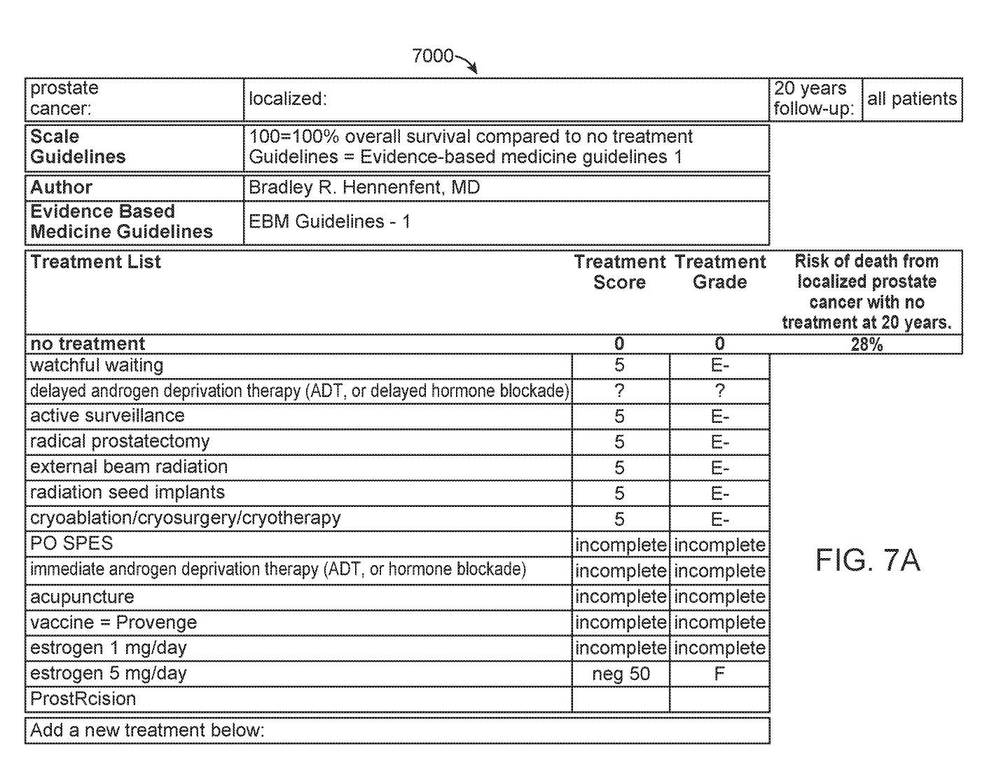

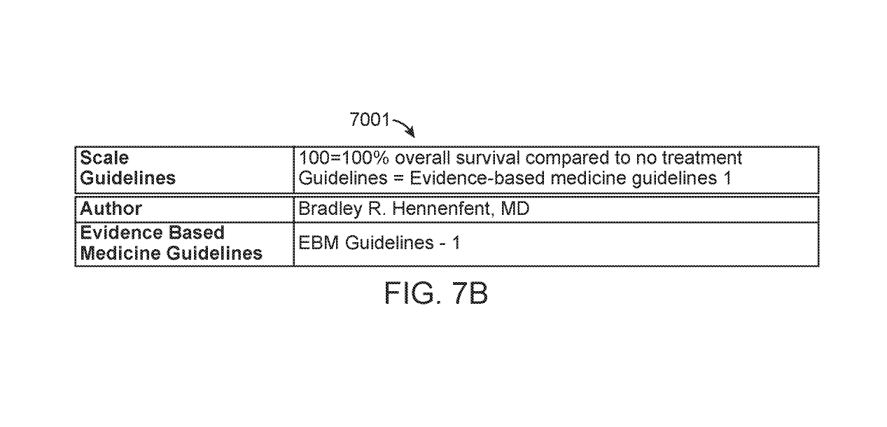

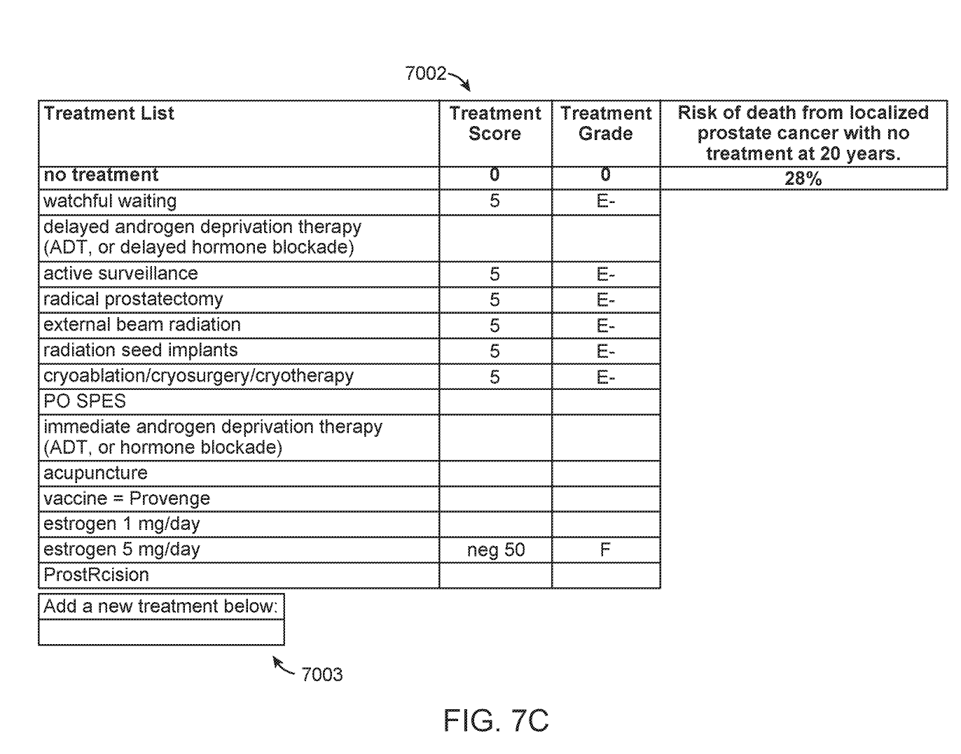

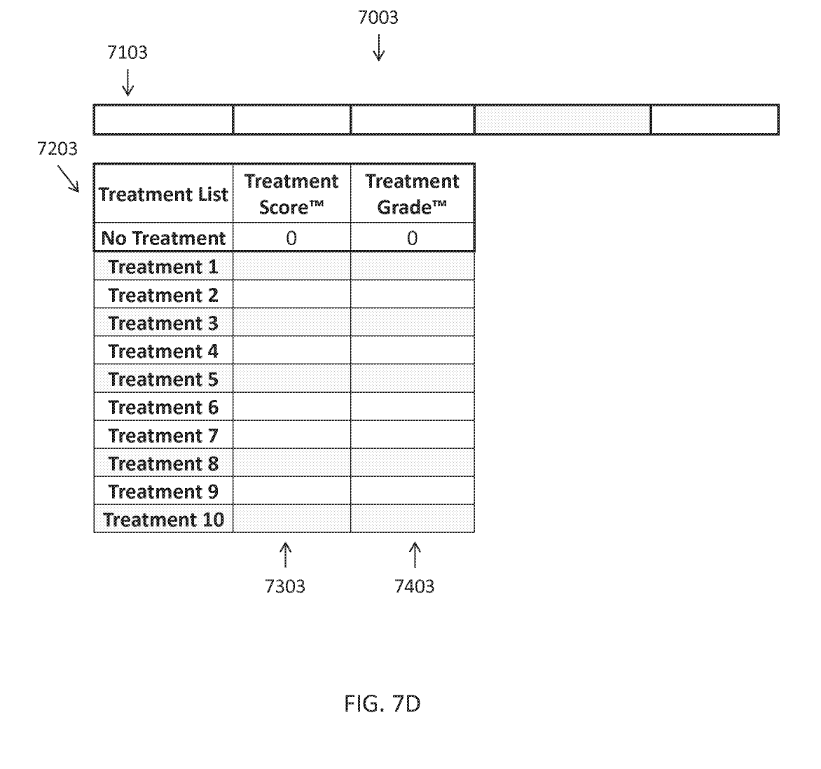

In a step 3120, a treatment regimen list may be provided. The treatment regimen list may comprise a list of treatment regimens along with their treatment scores and/or grades as shown by list 7000 (FIG. 7A) described below. As described further below, one or more legends may be provided to facilitate user interpretation of the treatment regimens listed and the treatment scores and/or grades. This treatment regimen list may be provided on the same or different webpage such as an index webpage, tab such as a tab of a program or mobile app, menu bar, or the like.

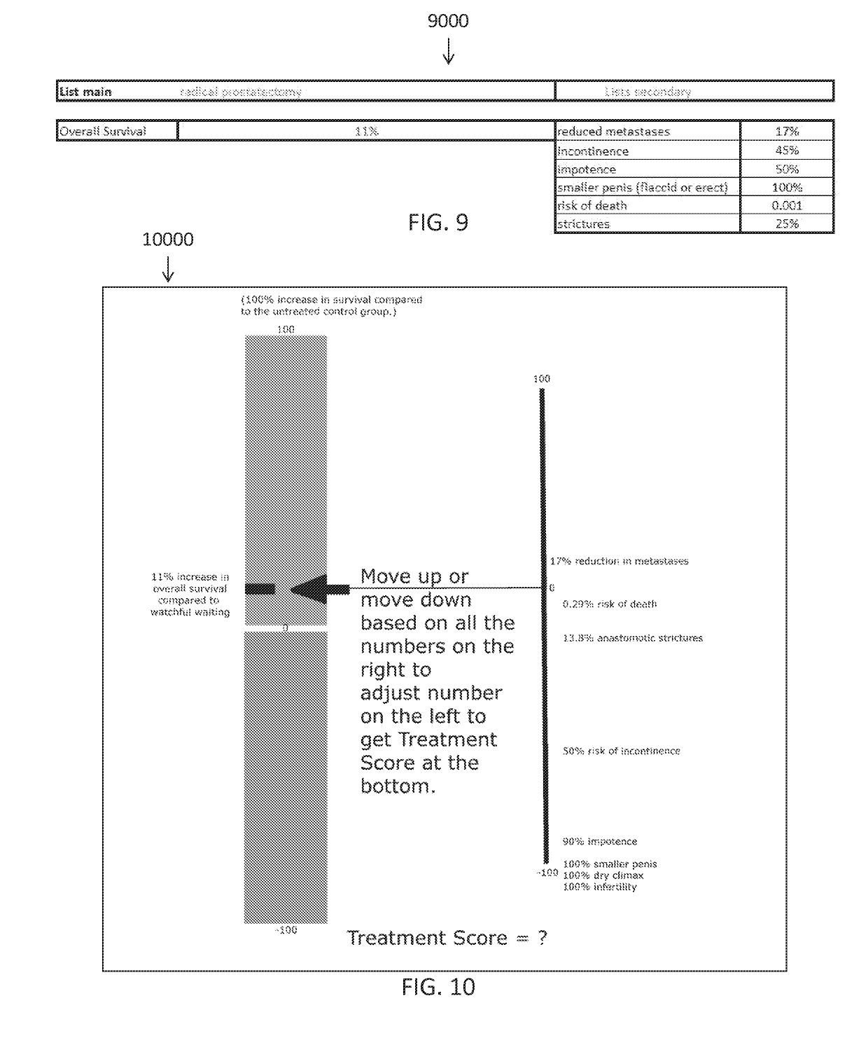

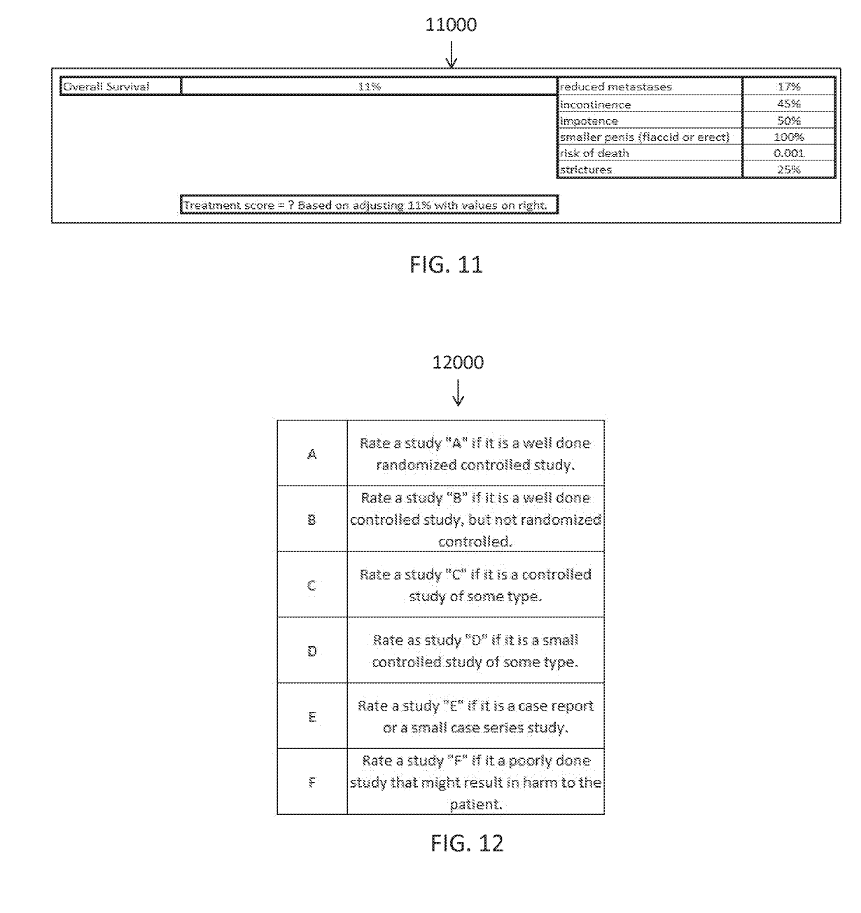

In a step 3130, details for an individual treatment regimen may be presented and the details may include the primary and secondary clinical parameters for the diagnosis. Such details are shown, for example, by lists 9000 and 11000 in FIGS. 9 and 11 below. These details may be provided on the same or different webpage such as an index webpage, tab such as a tab of a program or mobile app, menu bar, or the like.

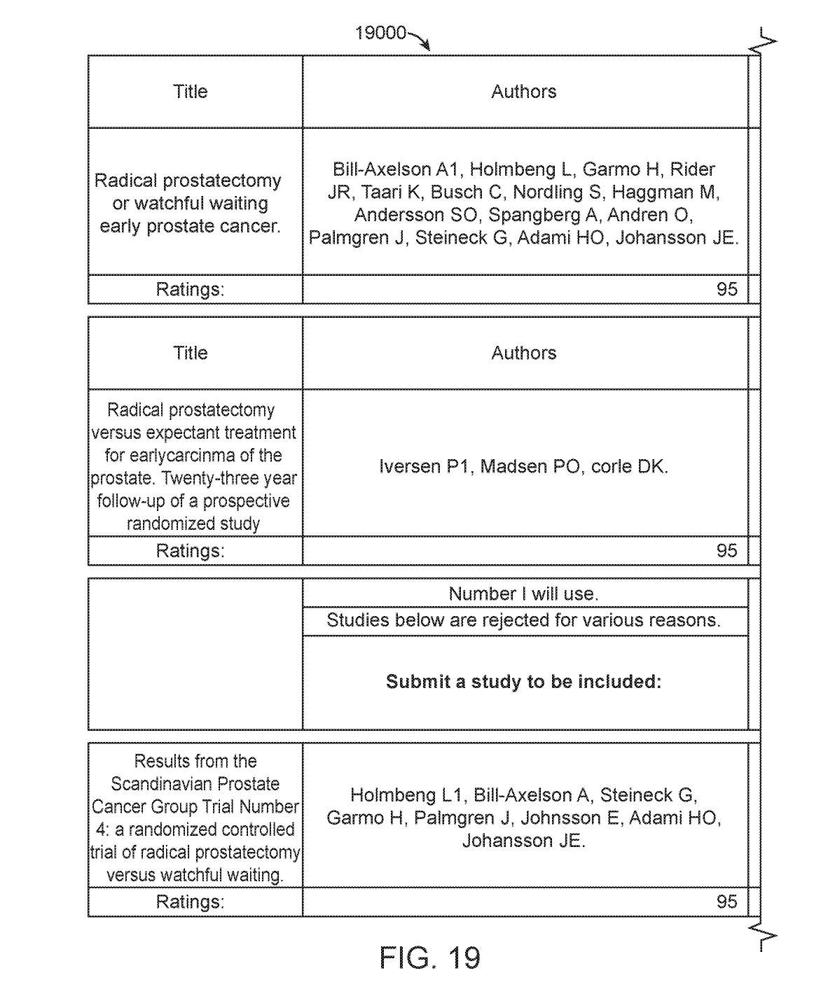

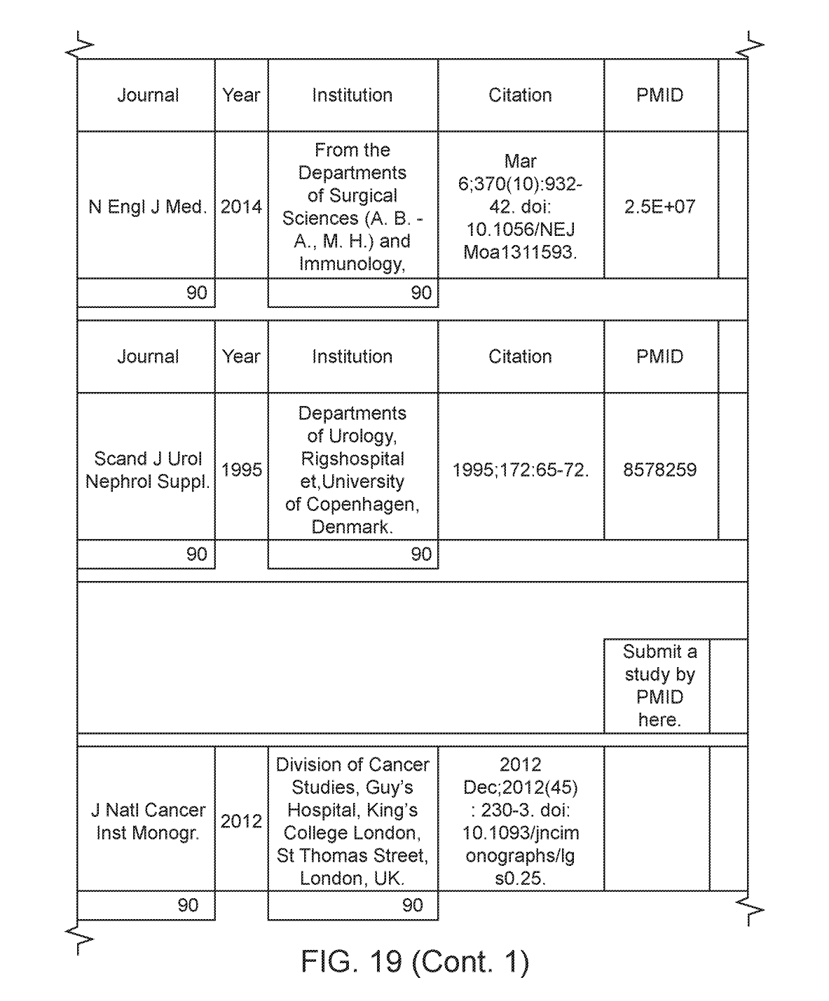

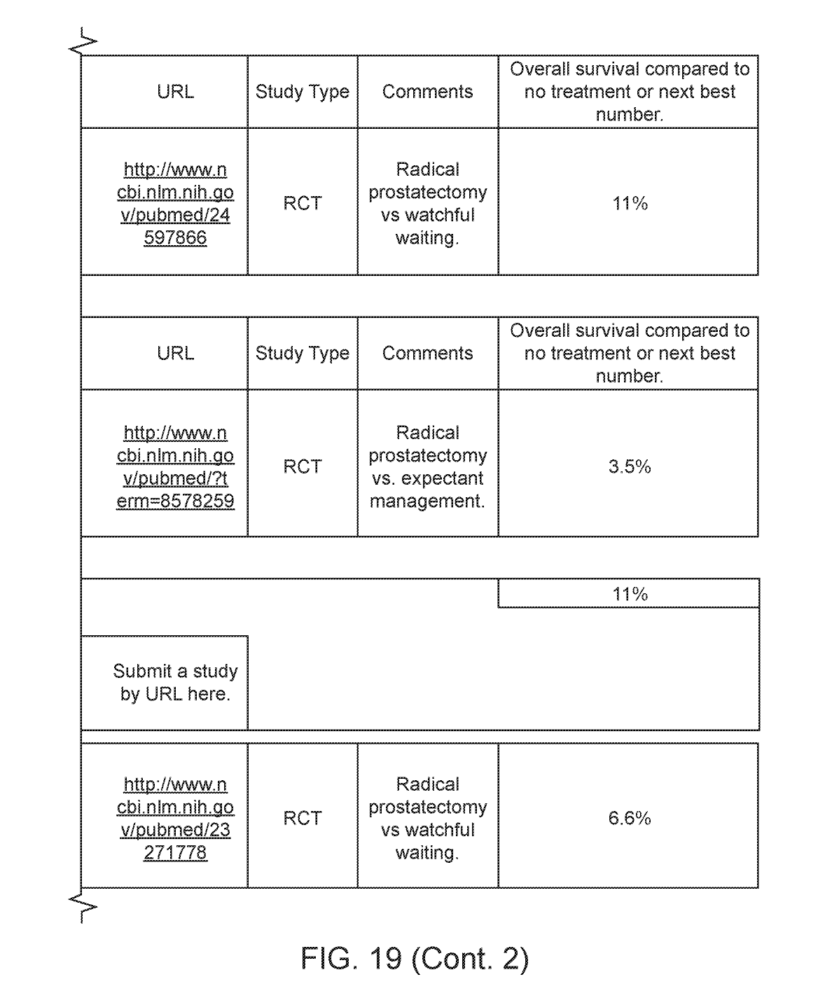

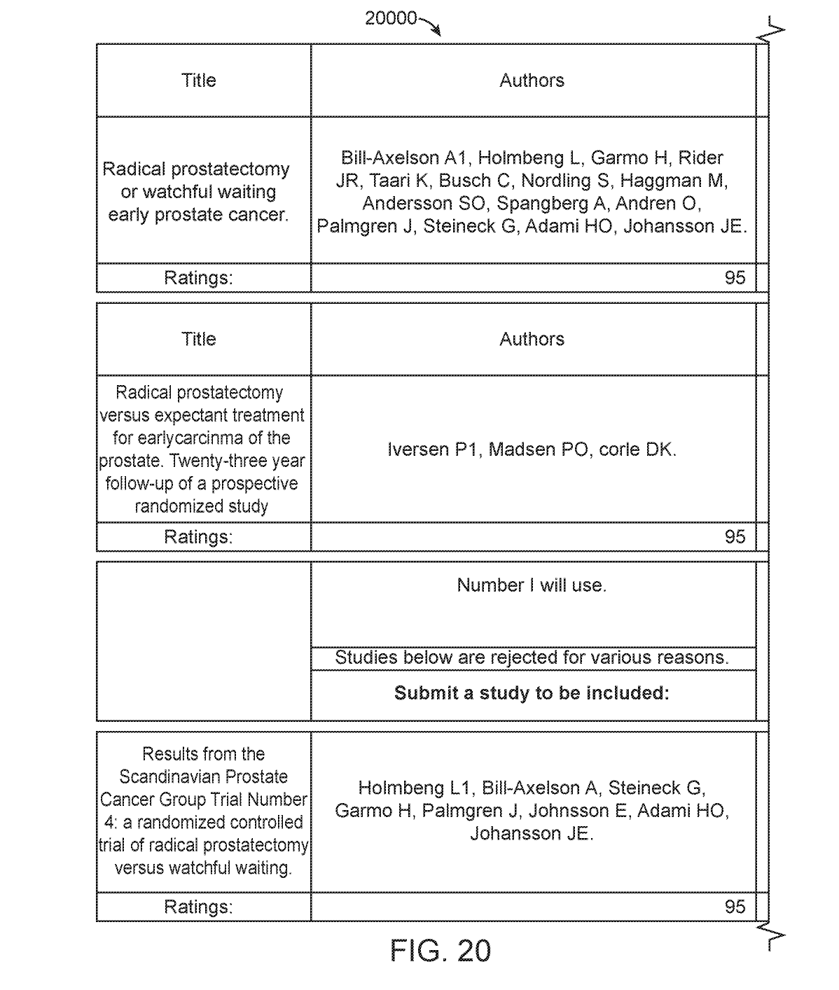

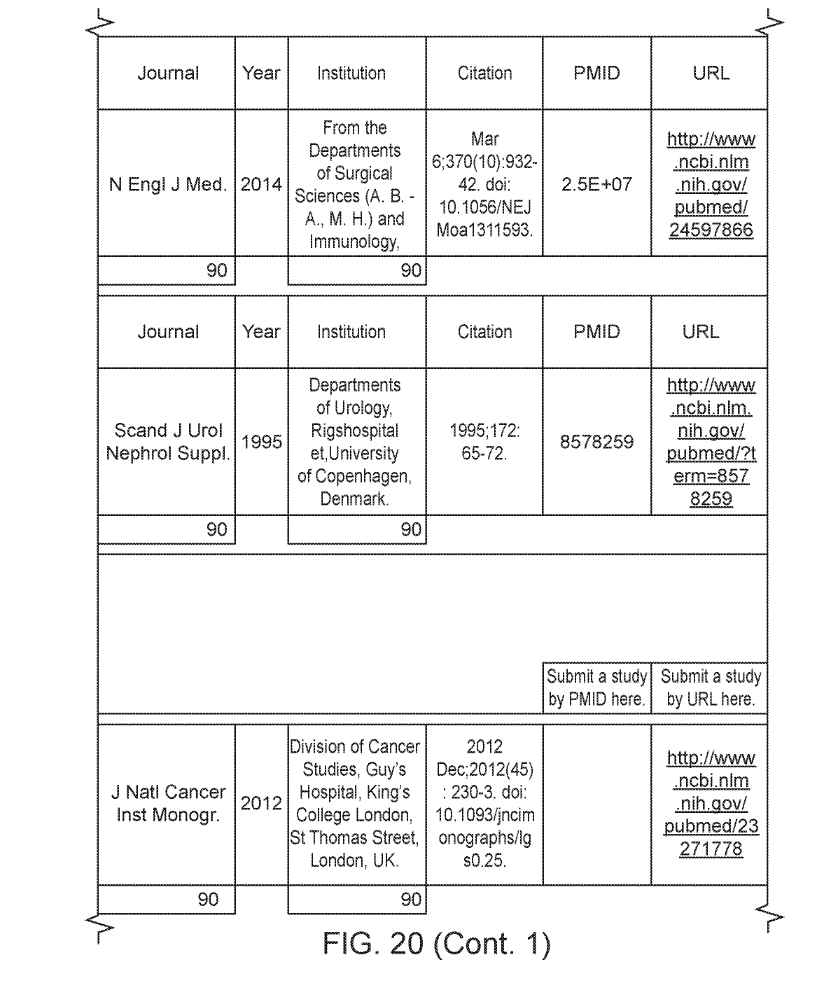

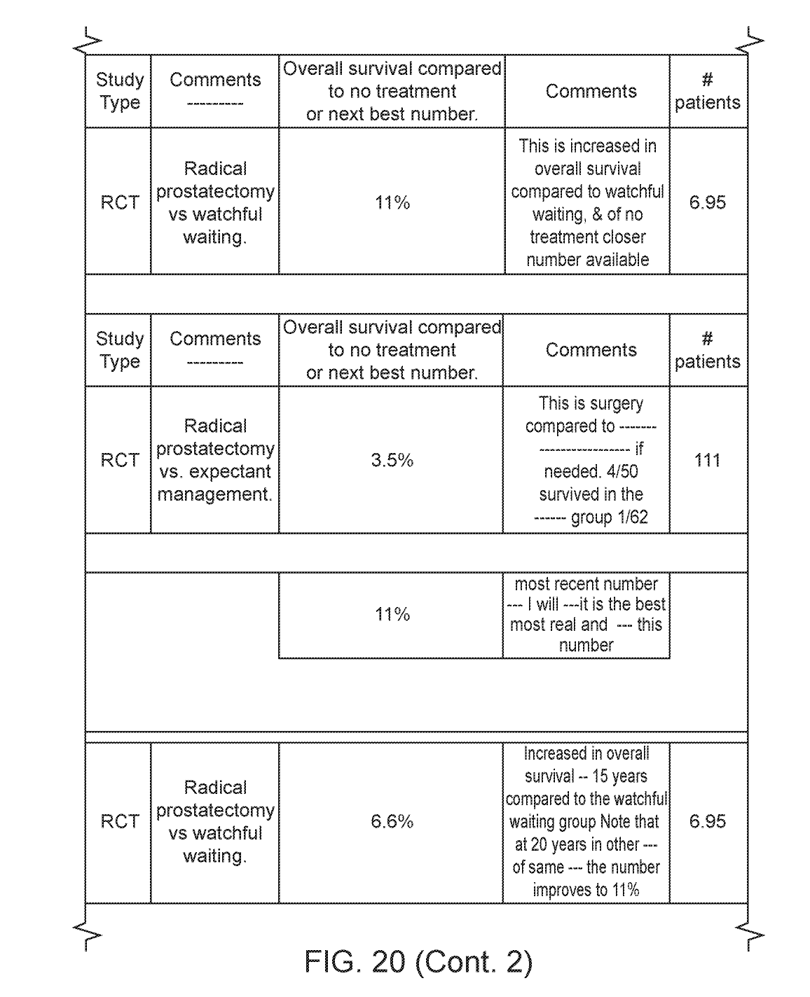

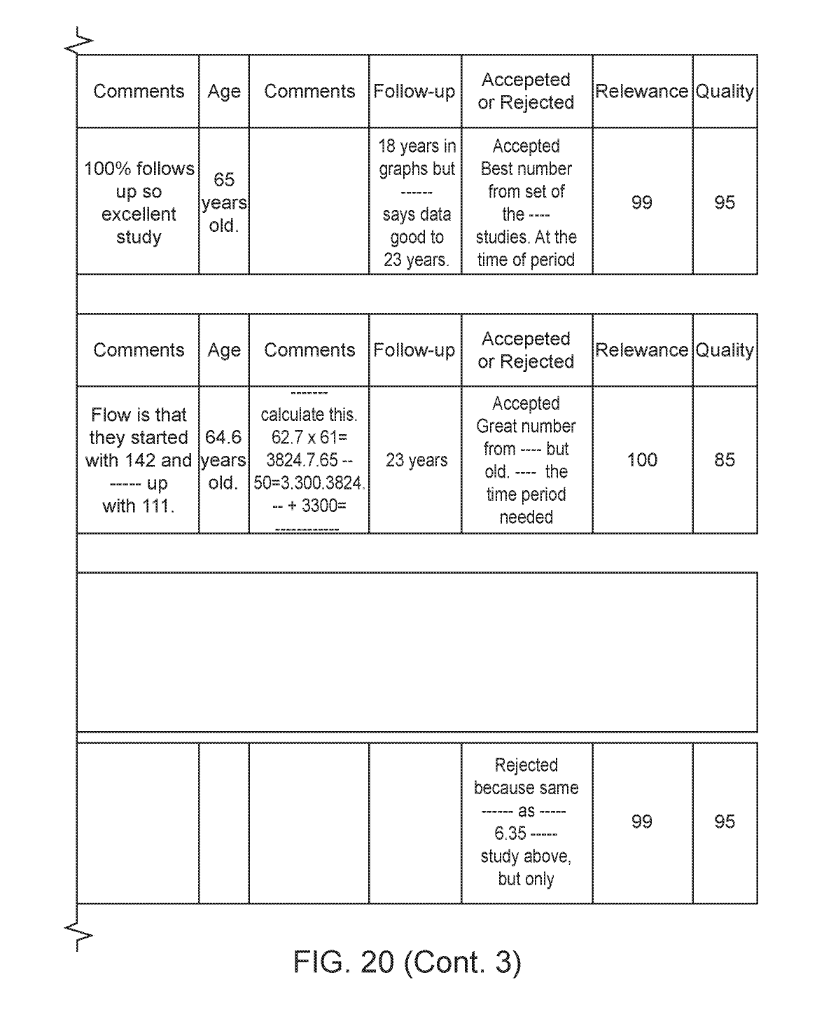

In a step 3140, a listing of medical literature references or studies for the detailed treatment regimen may be provided. Such a study listing is shown for example by the lists 19000 and 20000 in FIGS. 19 and 20 below. This listing of medical literature references or studies may be provided on the same or different webpage such as an index webpage, tab such as a tab of a program or mobile app, menu bar, or the like.

In a step 3150, the treatment grade or score for the treatment regimen can be provided. The treatment grade or score may be provided on the same or different webpage such as an index webpage, tab such as a tab of a program or mobile app, menu bar, or the like.

In a step 3160, the listing of medical literature references or studies may be user or computer sorted into categories for consideration and non-consideration. As the treatment grade/score for the treatment regimen is based on the plurality of medical literature references or studies considered, the treatment score may change depending on which of the references or studies is in the category for consideration. In a step 3170, the treatment grade/score may be dynamically (automatically, semi-automatically, or manually) updated. The treatment grade/score may be provided on the same webpage, tab, menu bar, or the like as the listing of medical literature references or studies. Accordingly, the dynamically (automatically, semi-automatically, or manually) updated treatment score may be displayed at the same time and at the same location as the sorting of the medical literature reference or study listing.

Although the above steps show the method 3100 of providing a user interface in accordance with many embodiments, a person of ordinary skill in the art will recognize many variations based on the teaching described herein. The steps may be completed in a different order. Steps may be added or omitted. Some of the steps may comprise sub-steps. Many of the steps may be repeated as often as beneficial.

One or more of the steps of the method 3100 may be performed with a processor and/or other logic circuitry of a computing device such as one described for use in the system 2000 above. The processor and/or other logic circuitry may be programmed to provide one or more of the steps of the method 3100, and the program may comprise program instructions stored on a computer readable memory or programmed steps of the processor and/or other logic circuitry.

Described below are embodiments of the system for the quantification of the science of medicine. In the systems described, new guidelines, scales, algorithms, and formulas can also be proposed and then rated and evaluated so that the best ideas rise to the top.

Currently there are few systems and methods for the quantification of the science of medicine. A separation of treatment regimens or protocols into upper 50% or lower 50% by quality or other factors would be an improvement. A separation of treatments into high-value, median value, and low value would be further progress. As described herein, systems and methods of the present disclosure use a 100 point treatment scale, or medical decision scale, and translate those into grades A-E, by the didecile, or to F for negatives.

There are often claims in medicine that are completely untrue that are sometimes accepted as common knowledge. By removing claims that have to be false, we can narrow the range of what must be true. It is often easy for example to see a report in the media, study the data, and conclude that the report was untrue. With the Science of Medicine System described herein, we will be able to document step-by-step why the report was untrue. A physician may say on TV or the Internet that a treatment cures cancer 90% of the time. The Science of Medicine System may then look at the data and say no, that treatment only cures cancer 10% of the time.

Visualization. The systems and methods of the present disclosure provide a way for various doctors (and all other users) to share their opinion on a treatment for a diagnosis to the world. Also provided are tools to help anyone organize the data so that they can come up with their quantifications of the Science of Medicine based on the existing science and their opinion when necessary, for the various treatments for various diagnoses, or for other medical decisions.

Every day doctors handle missing data and incomplete data, often through their own internal thought processes. The systems and methods of the present disclosure can show what they do visually within their own minds. This transparency enables others to work through the process, to comment on the process, and to improve the process.

Product transparency. True product transparency in medicine is desirable but not often found. For product transparency to work, it must be simple and understandable. No matter how complicated, statistical, and mathematical the back end is, ideally the front end should be very simple. The results of quantification, ideally, should be recognizable at a glance. When product transparency works, it is clearer to the consumer the quality of the product or service being purchased.

Today, when someone looks up a diagnosis to learn about the treatments, they are basically getting a review article. That review article is an opinion piece. Often review articles by 2 different authors on the same treatment do not even use the same a list of studies as their references. Part of our system focuses on developing lists of studies that are pertinent to decisions. The systems and methods of the present disclosure provide improved systems and methods of blocking down the list of best studies for a particular medical situation. And, by producing quantification, the interested party will not have to read review article after review article. The answers will basically be immediately available and summarized as treatment scores and treatment grades. There can also be a media transparency backed up by the hard data as one delves into the systems.

Transparency and Education go together. Part of the transparency is explaining terms, our methods, and the statistics. Our systems are such that each time a user clicks on anything (e.g., on a webpage, menu bar, mobile app menu item, or the like) or otherwise chooses anything (e.g., a term, or a statistic), an explanation can be provided.

When it comes to medical decision, doctors are often still using old methods. For example, when a medical doctor reads a medical journal, he may mark it all up, make his own calculations, circle all the most important statistics, and put the marked up journal in a filing cabinet. Over the years, an exemplary medical doctor may have a dozen or more filing cabinets filled with medical articles in multiple different locations, and may have lost track of hundreds of other studies. When a medical doctor wants to find that statistic calculated many years ago, the task may be virtually impossible and time consuming.

The systems and methods of the present disclosure give doctors and everyone the modern-day tools that they need to never lose track of their statistics and other important numbers. Doctors and others often need the organizational tools, visualization tools, and other tools, to make better medical decisions from the existing data.

Statistic may be flawed. Virtually every statistic in medicine is a flawed statistic. Almost every study in medicine is a flawed study or could be a better study. For example, the data may come from a study that is too small, a study that has biases, or a study is not exactly pertinent to the decision that must be made; there may be doubts about statistical methods behind the study, the statistic may need to be compared to another statistic that actually doesn't exist, and so on and so forth. The exact statistic we need may be missing. The language of the statistic may make it difficult to find. There is generally a lack of standardization of statistics throughout medical studies. What is desired is to get to the closest possible data for which to make a decision, or the best possible data, however flawed in each situation.

Lists. What is desired is a list of studies for every decision in healthcare. What is desired is the ability to keep track of these lists, and the ability to keep track of the data derived from these lists.

If necessary, a different study template may be provided for each list of studies.

Science and Art. The science of medicine is the hard facts upon which decisions are made. The art of medicine includes dealing with all the missing data, incomplete data, and flawed data. So the art of medicine is not just good bedside manner, it is also dealing with deficiencies in data when one has to make a decision. The art of medicine is dealing with bad data, missing data, flawed data, and incomplete data. The systems and methods of the present disclosure can capture and help to visualize the realistic decision process.

Medicine is generally full of hard numbers, fuzzy numbers, numbers that can be locked down, and numbers that must be qualified.

A goal of the present disclosure is objectivity. But in quantifying the science of medicine we may have to begin with subjectivity. We may have to subjectively define a scale. We may then have to get subjective opinions on where treatment exists on the scale. Then later, something may be published or someone may have a better idea and we can more objectively quantify the science of medicine for that treatment. Some things can be objectively quantified right now. Others may take time.

Treatment Scales: For Treating a Disease. Every disease can have a treatment scale or there is one that can be invented or defined for it. The main treatment scale for cancer might be overall survival or disease specific survival depending upon the rapidity and lethality of the cancer. Many diseases have existing scales or scores that can help. For benign prostatic hypertrophy, there is the International Prostate Symptom Score (I-PSS). There are several different pain scales. There is a symptom score for irritable bowel syndrome. There is the Glasgow coma scale. For chronic pelvic pain syndrome, there is a symptom score.

Every treatment for a disease generally has one most important data point or parameter that can be defined. Then, often several secondary data points or parameters may exist that can be taken into account to change the position that the treatment falls upon the main treatment scale.

Every treatment can have a treatment scale. One either has to find it or one has to define a new one. Every treatment generally has one single most important outcome statistic or already existing treatment scale. Does the patient live or die? Is the patient cured are not cured? Is the pain 100% gone or not? The scale can be created around the most important data points or outcome data points or parameters.

There may need to be adjustments on some treatment scales to correct for certain issues. For example, for rapidly lethal cancers disease specific survival may be appropriate. For slow-growing cancers, overall survival may be appropriate. Sometimes a cancer may fall in between the 2 extremes. Therefore the scale can be adjusted if necessary.

Treatment Scales/Conversion 100%. One benefit of having most or all of our scales be 100 point scales may be that they convert easily back and forth between 100% being the best. All kinds of scales can be converted onto the 100 point scale. The machine-software of the systems and methods of the present disclosure can automatically make these conversions for us.

Another reason that the 100% scale is a preferred scale in most situations is that many medical statistics are reported in percentages. Those that are not reported in percentages can be converted to percentages.

The A through E system may translate easily to a 100 point scale. Other systems can be translated to a 100 point scale as well.

We can also use shortcuts throughout the system. If the precision of a single number between 1 to 100 is not needed, a scale of A through E may instead be used, for example. The machine-software may simply automatically translate letters and numbers and numbers and letters when necessary. The same may be done for visual analogue scales, and all kinds of other scales, such as pain scales that have little to do with a 100 point system.

The decision process. Quantifying the science of medicine behind medical treatments and medical decisions generally involves being able to visualize the thought processes that physicians and other experts go through. The present disclosure provides tools/software/machines to capture and visualize the process.

It Starts with the Diagnosis. The quantification of the science of medicine for a treatment generally starts with defining the diagnosis. By contrast, the quantification of the science of medicine behind other medical decisions generally starts with defining that decision.

For a treatment, the diagnosis can be very general or specific. Over time, we can get more and more specific for every general diagnosis. Over time, we can “personalize” medicine more and more.

In the beginning, we can start with diagnoses that are specific enough to more easily quantify the data, because the diagnosis hierarchy can help us to separate the published medical studies into lists. FIG. 3 shows, for example, an input menu 3200 for entering diagnostic information. One or more levels of diagnostic information may be entered through one or more diagnostic input boxes 3210 of the input menu 3200. For example, a first level of diagnostic information may be “cancer,” a second level of diagnostic information may be “prostate,” and a third level of diagnostic information may be “localized.” The input menu 3200 may also comprise one or more input boxes 3220 for follow-up time or the length of time a population of patients or subject being studied is followed up for. For example, the follow-up time may be 20 years. The input menu 3200 may also comprise one or more input boxes 3230 for patient population type. For example, the patient population type may be “all patients.” The input menu 3200 may also comprise one or more boxes 3240 to display the treatment type. For example, the treatment type may be no treatment to establish a baseline. The input menu 3200 may also comprise one or more input boxes 3250 to enter author names if applicable. For example, a user may desire to generate a treatment score from studies authored by only a specific author or authors.

The medical literature often already tends to divide general diagnoses into more specific hierarchies and we can use these existing divisions to our advantage. Note that colors and font styles can be used for easier recognition of the disease diagnosis hierarchies for clarity if desired. FIG. 4 shows an exemplary diagnostic hierarchy 4000 which may be generated in part from the inputs provided by the user through the input menu 3200 (FIG. 3). For example, a first diagnostic level of the hierarchy 4000 may be of “cancer” (e.g., versus other general indications), a second diagnostic level of the hierarchy 4000 may be of “prostate” (e.g., versus other more specific indications), a third diagnostic level of the hierarchy 4000 may be of “localized” (e.g., versus “systemic” or other), a fourth diagnostic level of the hierarchy 4000 may be of “20 years follow-up” (e.g., versus other follow-up times), and a fifth diagnostic level of the hierarchy 4000 may be of “all patients” (e.g., versus patient subpopulations such as those younger or older than 65 years of age). Other diagnostic levels are also contemplated. As indicated in the aforementioned example, the diagnostic levels may vary from high, to medium, and to low levels of generality.

The diagnostic hierarchy 4000 may show “cancer: prostate: localized: 20 years follow-up: all patients.” But because the lay population may be more familiar with the term prostate cancer, or breast cancer, preferred embodiments may use that easier terminology on the “public face” of what we do (e.g., a webpage, a mobile application, or the like for non-professional users). A webpage of the systems of the present disclosure may have lists of diagnoses like that shown in the list 5000 of FIG. 5.

The body of prostate cancer literature generally separates into “all patients,” “patients less than 65 years old,” and “patients greater than 65 years old,” which is why we often chose these situations to quantify.

The evidence-based medicine Science of Medicine treatment Scores for these 3 different prostate cancer situations may vary in important ways. In approximate terms, for men greater than 65 years old the treatment score may be 0. For men less than 65 years old, the treatment score may be 20. For all men combined together and studied so far in the medical literature the treatment score may be 10.

Since approximately 80% of men who live to be greater than 80 years old have prostate cancer in their prostates, this kind of product transparency can be very valuable to a wide audience. People often contact physicians and say my “so and so” was just diagnosed with bladder cancer, or someone else will call because “so and so” has been diagnosed with lung cancer, what do you know about that? With our Science of Medicine System to quantify the treatments for medical diagnosis, physicians would be able to say go to the webpage provided by the systems of the present disclosure and point to the best type of medical review article: a medical review article that quantifies the science of medicine; a medical review article that leads one back to the exact statistics, or data points, upon which all of the decisions are made. These would also be medical review articles that have been reviewed, commented upon, and improved by others.

Pancreatic Cancer Example. FIG. 6 shows a diagnosis 6000 about pancreatic cancer, an example of how we can define a diagnosis. Pancreatic cancer is an extremely interesting disease for which to quantify the science of medicine, because it is so lethal. Desperate people are often looking for anything and everything to stay alive. We want to help them on their search by providing long treatment lists and providing nearly instant access to the data points that they really need to know to understand what has happened in the past.

Treatment Scores. One could say that the Science of Medicine System is a better way to write medical review articles. By “forcing” quantification to be done we can get a much better picture of the relative value of treatments or medical decisions.

For each diagnosis, the systems and methods provided herein for the quantification of the science of medicine can produce a list of treatments with their treatment scores and treatment grades. There may be a disease diagnosis hierarchy. There may be a defined treatment scale and there may be evidence-based medicine guidelines for how to use the treatment scale. There may be evidence-based medicine guidelines for how to rate and use studies. FIG. 7A shows a list 7000 of treatments, scores, and grades, for example.

There is often one statistic that is most important to the patient, which our system will try to include as well.

The scale guidelines, author, and evidence-based medicine guidelines 7001 from FIG. 7A have been enlarged in FIG. 7B.

Author Ratings and Demographics. Each of the authors who provides a review can be rated. Each of the authors can have data collected on them such as a set of background demographics such as college graduation, medical school graduation, residency graduation, the taking of certain tests that we may provide such as tests on math, statistics, and so forth that we may provide, etc.

Treatment Scores Enlarged. The treatment scores and treatment grades 7002 for list 7000 shown in FIG. 7A have been enlarged in FIG. 7C for easier viewing.

In FIG. 7C, we have a list of approximate treatment scores and treatment grades for some of the treatments for localized prostate cancer at 20 years for all patients. Note that for “no treatment,” the treatment score and treatment grade equal 0. By definition, the treatment for no treatment equals zero, and all other treatments are compared to no treatment. “No treatment” may also represent “no treatment with anything,” “no treatment by giving placebo,” “no treatment by giving a sham treatment,” or “no treatment by watchful waiting.”

FIG. 7D shows a generic treatment score and treatment grade output template 7003. The template 7003 may comprise a bar 7103 to show the diagnostic information selected. The template 7003 may further comprise a column list of treatments 7203 and column lists of treatment scores 7303 and grades 7403, respectively, to show the treatment scores and grades for the treatments.

One of our preferred embodiments is to show what happens with no treatment. In other words, to show what the natural history of the disease is. The treatment score and grade for no treatment provides a baseline from which other scored and graded treatments are compared.

Note, that there is generally one most important statistic from the patient's point of view that helps establish a baseline, and in this case we used “death from localized prostate cancer with no treatment at 20 years.” Patients may not realize that they may have a 72% percent chance of not dying from prostate cancer over 20 years if they do nothing. We might word the statistic in those terms. We can experiment to find the best statistic for teaching patients what they need to know. (Caution: 72% is currently on reviewer's opinion and this may not be our best number and many others will do an analysis later.) The particular “one statistic” used may vary from disease to disease and may be worded in many different ways. However, if deemed to be better for product transparency for patients, we may show more than one statistic. Such as, “risk of death from no treatment” equals 28%, and “odds are still being alive with no treatment” are 72%.

Note at the bottom of the treatment list 7002 is a box 7003 where another treatment can be added to the list. Users can suggest other Western medical treatments, herbal treatments, alternative medicine treatments, and so on and so forth.

Our goal is generally never to ignore any possible treatment, and show the existing data behind any possible treatment.

Anyone, or users, can suggest treatments that are not on the current list, and then our system can do quantifications for that treatment.

Confidence Intervals. When treatment scores are produced by more than one person, we can do statistics on the treatment scores. We can do averages. We can produce confidence intervals. We can do “manual confidence intervals” where the reviewer indicates how confident they are in their treatment scores. We can also do true mathematical confidence intervals. We can do weighted averages, and so on and so forth.

Worldwide. If we develop into a worldwide network, we can have large numbers of filters we can use to look at the data in different ways. We may find that a specialty that does a certain lucrative operation says that the treatment score is very high for that operation. In some cases, other specialties that are not financially involved will produce treatment scores that are very low for that operation. Historically, this type of thing has happened in medicine. Also, it happens that one specialty believes what another specialty says not realizing that what they say and do is not based on evidence-based medicine. Many of these kinds of issues can be made transparent by using filters and other systems to look at the data.

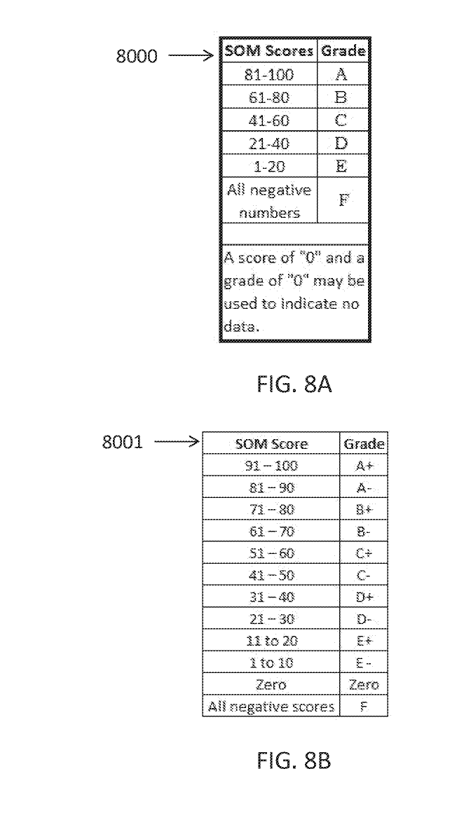

Scores and Grades. The treatment scores, which are automatically translated into grades whenever possible or needed by the machine/software system, come from our analyses of the medical literature. One of our embodiments of translating scores to grades would be as shown in the legend 8000 of FIG. 8A.

When we want more divisions in the grades we can use the ages old plus and minus system as shown in the legend 8001 of FIG. 8B. We can also break each grade into thirds, by breaking each didecile into thirds, for example: A+, A, and A−. Or, for example scores 90 and 91 could be considered grade A. Everything above 90 and 91 could be A+. Everything below 90 and 91 down to 81 could be A−.

Scores Come From. The Science of Medicine Scores, or Treatment Scores, generally come from the underlying medical literature. There are generally a set of data points that are pertinent to the quantification of the science of medicine behind the treatment. Each of the data points may have a list of studies from which that data point is derived. FIG. 9 shows a list 9000 of such data points.

In one of our methods of doing the analysis, the most important data point to the patient in treating prostate cancer is overall survival. Therefore, it is the main data point on the left in the list 9000. Modifiers to the main data point such as reducing metastases, which is a positive, or the negative side effects such as incontinence and impotence, and even death, are put on the right side of the list 9000 in this embodiment of our system.

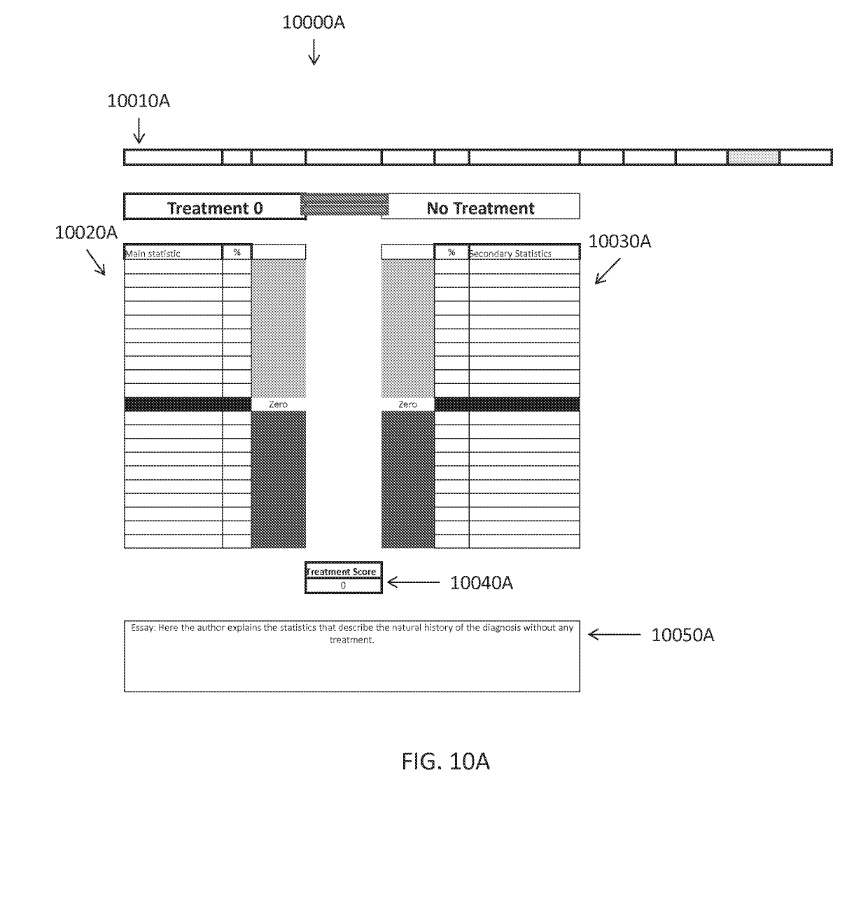

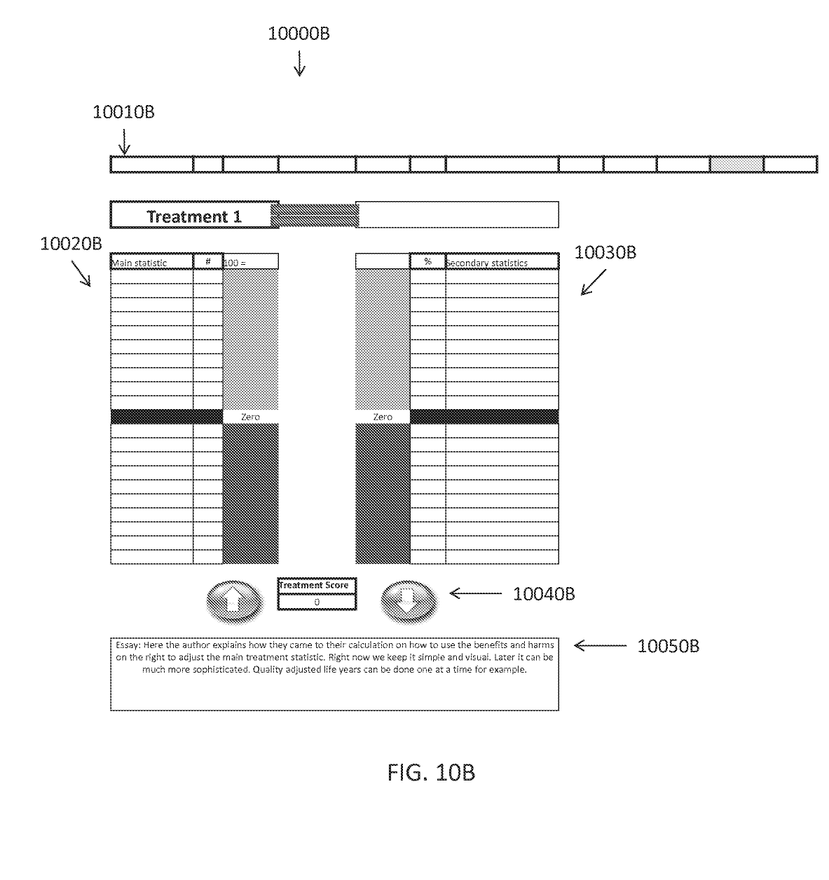

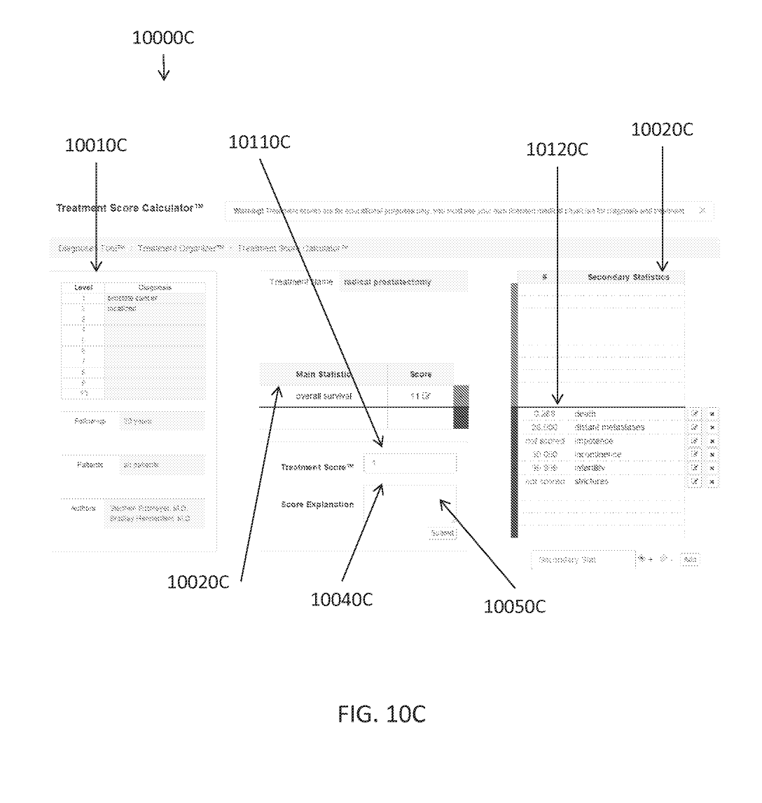

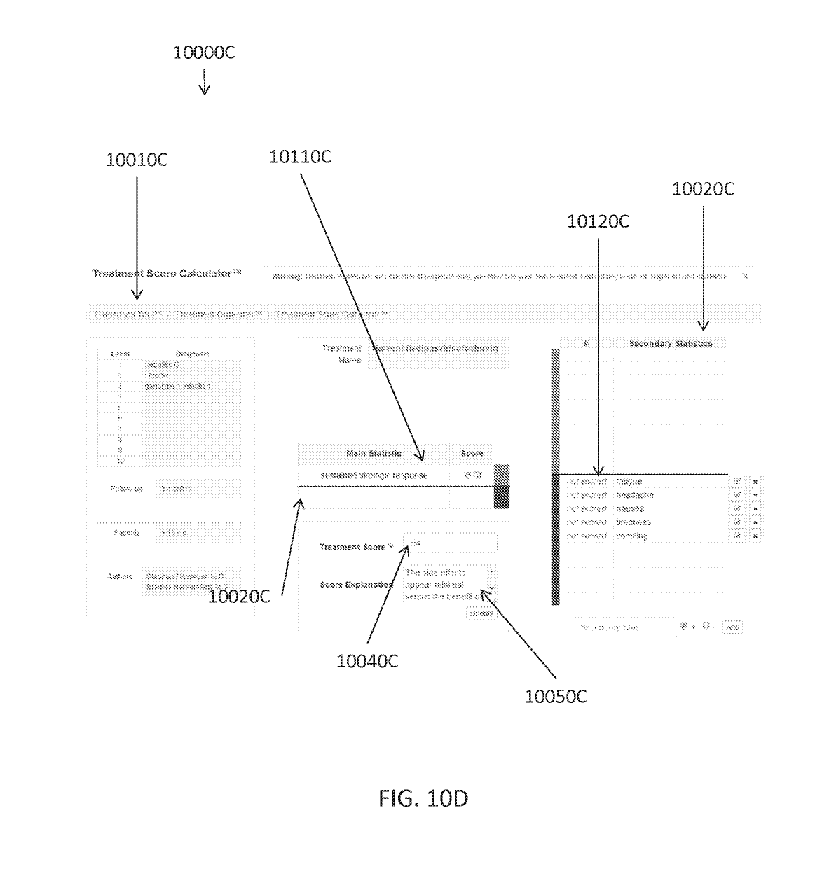

Visual Analogue Scale for Adjustments. Every treatment generally has a treatment scale for the diagnosis being evaluated. Every treatment generally has one main statistic such as “overall survival” in the case of localized prostate cancer that can be placed on the treatment scale. Each treatment usually several secondary data points that can represent additional positive benefits, or that can represent negative side effects. Embodiments of the present disclosure may provide for the visualization of all these data points simultaneously. This visualization may be provided through the user interface of the system 2000 described above, for example. In some embodiments, the visualization can be dynamically, automatically, semi-automatically, or manually updated as the treatment grade/score is dynamically, automatically, semi-automatically, or manually updated as the input parameters are updated. FIG. 10 shows a scales 10000 to help visualize main statistic and secondary data points, with the ability to slide one scale to adjust the treatment score output. In the scale 10000 shown by FIG. 10, note that the scale 10000 on the right goes from 0 to 100 on the top half, but also goes from 0 to NEGATIVE 100 on the bottom half. The positives and negatives on the right side must be weighed against the main statistic on the left side. A treatment score or grade for an individual treatment regimen or protocol listed (e.g., in list 7000 of FIG. 7A) may link to a scale 10000 which shows how the treatment score or grade has been calculated. The treatment score or grade may also be updated as well.

In the diagram or scale 10000 of FIG. 10, we actually want to be able to slide the arrow up and down to change our treatment score from the starting point of 11 to increase it or decrease it according to the criteria on the right. This would be a visual analog scale method of altering the treatment score using the visualization process.

This may be the simplest and easiest method for patients to understand. In FIG. 10, we are making the adjustment with all the secondary data points simultaneously. The scale on the left may represent the main statistic which may be overall survival rate. The left scale may be user or automatically adjusted based on the list 9000 of data points. Initially, the left scale may be set at a starting point of 11 based on the 11% overall survival rate indicated by the list 9000. The scale on the right provides a visualization of one or more secondary data points or parameters. Based on the secondary parameter(s) on the right scale, the left scale may be adjusted up or down. We can also have a separate scale for every secondary data point and make the adjustments one by one. The adjusted left scale provides the treatment score or grade. The adjustment may be automatically, semi-automatically, or manually calculated and the user need only select a set of secondary data points or parameters for selection. The calculated treatment score or grade may be different depending on which secondary data points or parameters are selected for consideration. The treatment score or grade may be dynamically, semi-automatically, or manually updated as secondary data points or parameters are selected for consideration or non-consideration.

We can also make all the adjustments by various mathematical formulas. Behind each of the secondary data points, could be mathematical formulas for quality adjusted life years, for adding and subtracting to the overall increase in survival based on various calculations. Essentially, the back end can be as complicated as necessary for any user, reviewer, or statistician. Perhaps, the back end can be understandable only by those with advanced degrees in medical biostatistics. However, we prefer the front end interfaces to be simple and easy enough for the average practicing physician, nurses, patients, and all other interested parties.

FIGS. 10A and 10B show exemplary treatment score calculation template menus 10000A and 10000B, respectively. These menus 10000A, 10000B may be used by a user such as a physician to list and weight main and secondary statistics to determine a treatment score. The menu 10000A comprises a diagnostic bar 10010A to show diagnostic information such as indication, study type, study population, etc. The menu 10000A further comprises a main statistic entry menu 10020A to enter the main statistic for the medical diagnostic or indication in question. The menu 10000B further comprises a secondary statistic entry menu 10030A to enter various secondary statistics for the medical diagnostic or indication in question. The menu 10000A further comprises a treatment score box 10040A where the user can enter the treatment score they determine or which displays an automatically generated treatment score generated from the main and secondary statistics. The menu 10000A further comprises a comment box 10050A. As shown in FIG. 10A, the menu 10000A may be applied for a no treatment scenario. The comment box 10050A may therefore be where the user may explain the statistic(s) that describe the natural history of the diagnostic without any treatment.

The template menu 10000B of FIG. 10B may be similar to the template menu 10000A of FIG. 10A and may similarly comprise a diagnostic bar 10010B, a main statistic entry menu 10020B, a secondary statistic entry menu 10030B, a treatment score box 10040B, and a comment box 10050B. As shown in FIG. 10B, the menu 10000B may be applied for a treatment scenario. The comment box 10050B may therefore be where the user may explain how they came to their calculation on how to use the benefits and harms on the secondary statistics menu 10030B to adjust the main treatment statistic menu 10020B.

FIG. 10C shows another exemplary treatment score calculation template menu or analyzer 10000C. The treatment score analyzer 10000C may similarly comprise a diagnostic box 10010C, a main statistic entry menu 10020C, a secondary statistic entry menu 10030C, a treatment score box 10040C, and a comment box 10050C. In this example, the treatment score analyzer 10000C is used for prostate cancer, localized, at 20 years of follow-up, for all patients. The treatment score 10110C would equal 11, which is the main statistic, if it were not for all the negative side effects. This user, when taking into account all the negative side effects listed in side effects box 10120C, has dropped the treatment score from 11 to 1. And, the user has done it manually in this case by clicking up and down arrows that appear to the right of the “Treatment Score” number 10110C in its cell when the mouse is put there. The process may be semi-automated or fully automated in circumstances where all the mathematics have been worked out. Manual and semi-automated systems may be provided to compare human results to machines results

FIG. 10D shows the treatment score analyzer 10000C used for Harvoni for hepatitis C. All of the side effects on the listed in box 10120C are relatively unimportant compared to the overall benefits of actually curing hepatitis C, shown in main statistic box 10110C. Even without filling in all the numbers on the side effects box 10120C, the user has a general idea of the treatment score 10040C is not going to be reduced by much. For now, the user has only reduced the treatment score 10040C from 95 to 94.

As shown in the treatment score calculation screen 11000 of FIG. 11, another visualization example would be to have column system set up. The main data point could be on the left. The adjustment data points could be on the right.

In the above four column example or screen 11000, we can see the main data point in red on the left side and the data points with which we must adjust that number to get to the treatment score on the right side.

We can make the adjustment using the adjustment numbers on the right as a group or individually. Various calculations and weights can be given to the numbers on the right side to make the adjustment calculation to come up with the treatment score.

Also, we may be able to add and subtract things from the list on the right. Perhaps someone wants to word the side effects in a different phraseology. Perhaps someone may want to define impotence into 2 or 3 different categories.

Visualize Thought Process. In many embodiments, the thought process of the evidence-based medicine physician is visualized, and can be improved as experience is gained.

Visualizing Real Life. The scale provided has a main statistic on the left and the adjustment statistics on the right, which can actually be slid up and down to adjust the statistic on the left to create a new output. This visualizes what goes on in the physician's head, and can mimic real life.

Show the Math. We have a system where we can show the math or show more complete explanations. Behind every cell can be a pop-up, or a new web page, or some other device that can explain about the data or text in the cell.

If a formula is used to calculate something that formula can be shown.

Review Article. One embodiment provides a type of medical review article based on the existing medical literature. We can quantify our results as we write the review article which can allow for the relative values of treatments to be determined. We may organize the data so that the actual data points can be seen simultaneously. We may organize the lists of studies so that they can be seen simultaneously. We may provide templates for references so the statistic (or data point) that goes with the reference template can be seen.

Study Scales/Guidelines. One of the biggest problems in healthcare is the preponderance of low-quality studies. One of our preferred embodiments, as shown by the grading scale 12000 of FIG. 12, may be that randomized controlled studies are grade A. Grades B, C, and D are other types of controlled studies. Uncontrolled case series studies or anecdotal studies would fall under grade E. Studies that are so bad they are potentially harmful would fall under grade F.

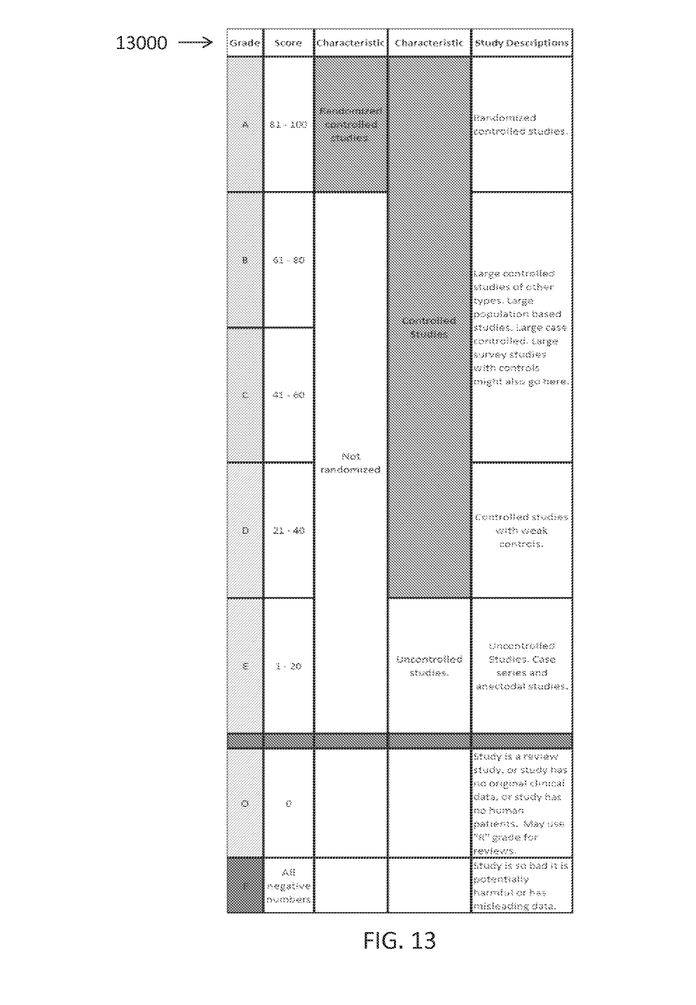

A more detailed graphic of this possible set of guidelines would be as shown by the grading scale 13000 of FIG. 13.

Study Scale 80/20 Split for Controlled vs. Uncontrolled Studies. We may have study guidelines to facilitate the rating of studies. A study scale may 80/20 split in favor of controlled studies as shown by scale 13000 of FIG. 13. In scale 13000, controlled studies are grade A-D and uncontrolled studies are grade E.

One potential scales for studies is one in which the grades A through C all require some type of controlled study. Grade A would be randomized controlled studies. Grades B and C would be other types of controlled studies. All the case series studies that are uncontrolled studies would fall in the grade D and E range.

We can have many different guidelines that can be evaluated and rated before deciding on the best ones to use for various situations.

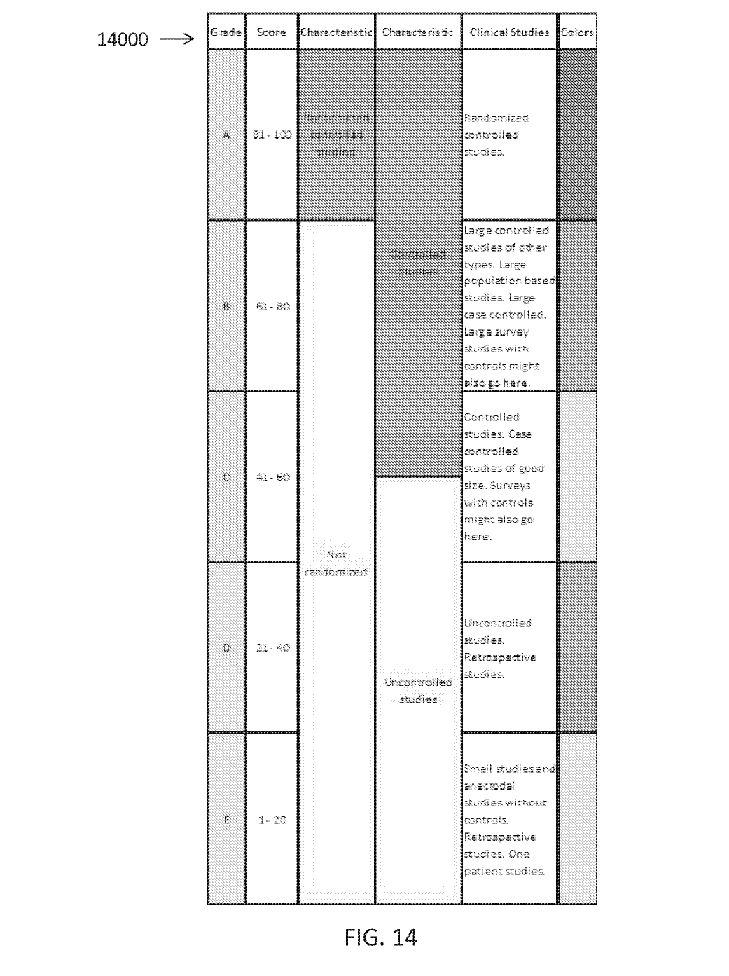

Study Scale 60/40 Controlled Uncontrolled. FIG. 14 shows another scale 14000 which splits the rating system controlled versus uncontrolled studies so the top 41-100 ratings are controlled, while 1-40 are uncontrolled.

A 50/50 split has also been tested. Other permutations exist, but some may be better than others in various circumstances.

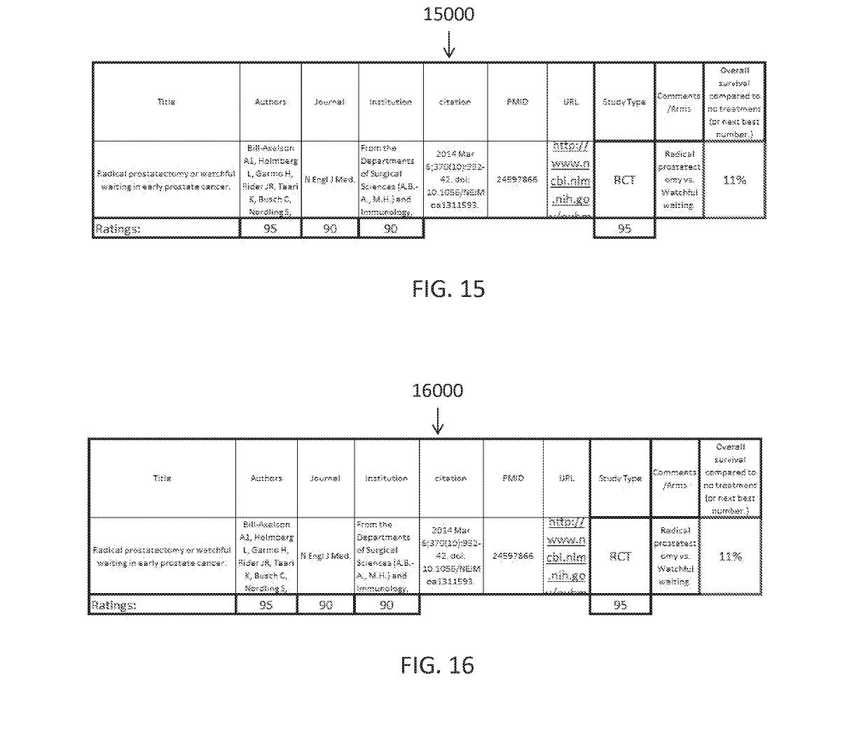

Template for Study Data Short. Embodiments of the present disclosure provide a way to have a reference by having the data point with the reference so it can be seen, so it can be commented upon, so it can be double-checked by others, so that many aspects of the reference can be rated, etc. FIG. 15 shows a basic study template 15000 concentrating on one statistic. This is one version of our template for showing a statistic from a study; in this case we are focusing on overall survival compared to no treatment (or next best number).

This study template 15000 is basically separated into the “hard information” and the soft information. The title, authors, the Journal, institutional information, citation, PMID, and URL are generally always present on Medline. The study type might have to be interpreted. The most important statistic we want might be buried inside the study or might have to be calculated from the existing data in the study. We can also rate the authors, Journal, institutions, and study types.

Providing a New Footnote. Embodiments of the present disclosure provide a kind of medical reference. Or, one might say a footnote used in a new way. It is a medical reference that combines the “hard” reference information, with the statistic we are looking for. That statistic can be presented with all the comments necessary, and other statistics that help to define the core statistic, along with any other comments that are necessary and educational as well. A preferred embodiment may be to concentrate on the one statistic we are trying to digest. One at a time with its comments and modifiers may be easier than long templates with many stats, comments, and modifiers.

Our new reference or footnote templates and style could be one of our most important features. All medical literature should be footnoted or and/or referenced in this way. With our reference system, you can see the hard data point along with all the reference data where it came from and along with several important modifying statistics and comments depending on how much room is available. FIG. 16 shows an exemplary study template 16000 to capture a statistic. Several longer versions can be used as well.

Archiving. Using the template system described above, we can capture archived data points all the way back to the beginning of the medical literature. As our database grows, people will be able to find every statistic no matter how far back in time pertinent to the medical decision at hand. And, if it is not pertinent, they will be able to see that the study was examined and rejected for that decision.

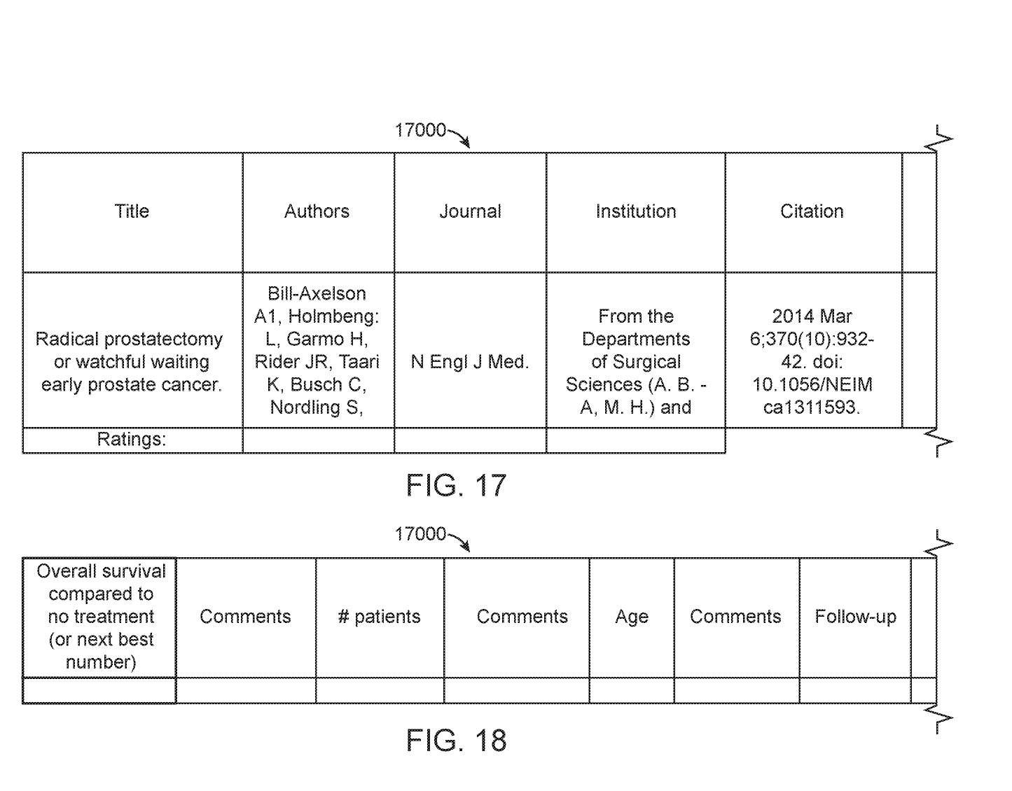

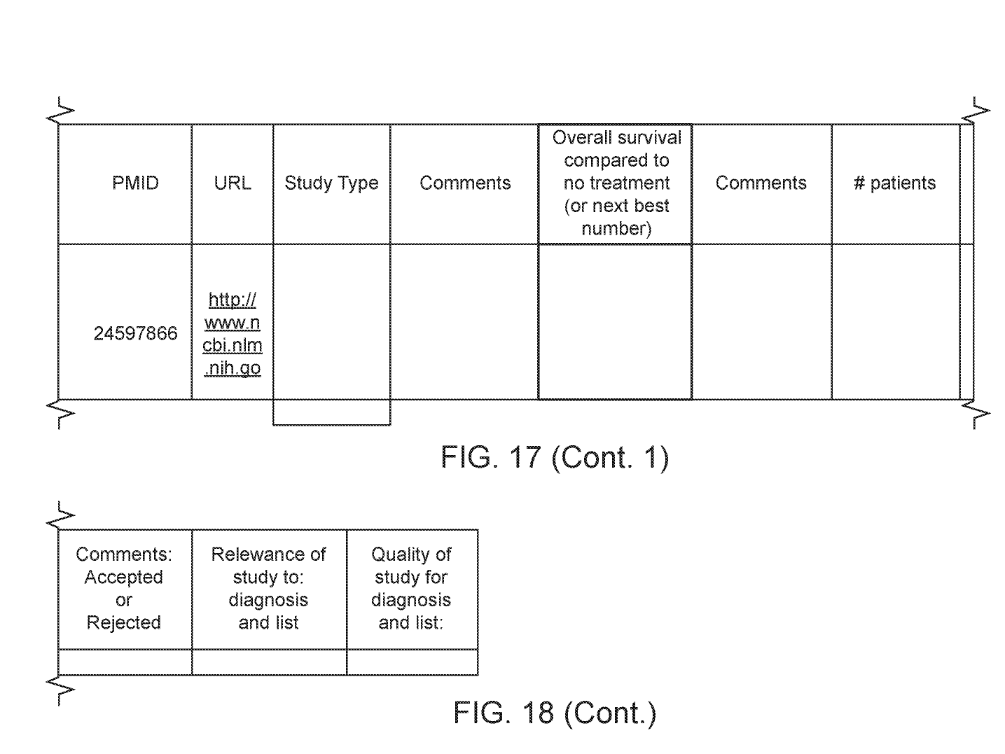

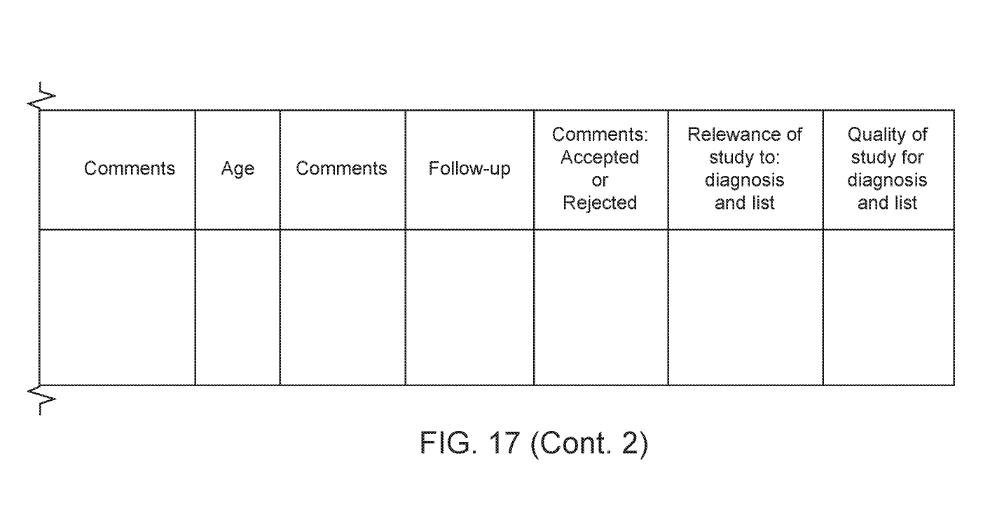

Template Long Study Data. We may want even more “hard data” and “soft data” in our study template that helps us to understand the one statistic we are looking for in a particular list of studies. FIG. 17 shows a study template 17000 with entry categories for more “hard data” and “soft data.”

This goes back to the axiom that every statistic in medicine is a “bad statistic”. For example, the main statistic we are focusing on in this template may need to be modified by the number of patients, age of the patients, follow-up time period, or other modifiers. And, each of those things may need to be commented upon for even further understanding. Most treatment statistics, and other clinical statistics, cannot be weighted the same because of the different variables that go into them.

Almost every statistic in healthcare is flawed. We handle flawed statistics by having templates that help us to harvest the data points, organize the data points, and to explain their flaws.

To make the longer version of the study template more easily readable, only the right half of the study template 17000 is shown in FIG. 18. Our main statistic can go in the red box and then it would be commented upon in the box next to it. The same thing may apply for the number of patients, the age, and the follow-up time period. We can have also have a box on whether we accepted or rejected this study in making our calculations. We can also have a box to rate the relevance of the study and the quality of the study.

Drag and Drop. Although in the embodiment described above we rate the relevance and the quality of the study, we may be able to do this by just dragging and dropping the template into position. We may not actually have to put in numbers or grades or whatever we're using to rate the quality and the relevance. The intent is to automate the process more and more.

We also intend to use the system that will automatically sort lists of studies when you put in a rating. Or, when you turn on the tool to do the sorting. The lowest rated studies and the unrated studies will keep moving to the bottom. In many embodiments, studies may be sorted based on the overall quality in the far right box.

List of Studies Selection. There are many ways to select the studies want to have a list in template form. Perhaps there will be box that can be checked to move those studies above the decision box so that their data will be included.

If you click boxes beside the top three that may give you a ceiling of 100 on the SOM Treatment Score scale, but if you check the box by all six, it might drop the ceiling to the average of all the ceilings. (For example, 100, 100, 100, 50, 50, and 50 would yield and average of 75.) This can help solve a problem in medicine which is basing medical decisions on weak science. When we check by the boxes to the side of the study, our ceiling could automatically be calculated by our software/machine. This will help keep people from picking a bunch of junk studies to say something works when it doesn't. There are many ways to weight the ceiling, such as boxes or use/unuse icons.

Template for Studies stacked one upon the other. FIG. 19 shows a list 19000 of studies with a “decision box” between them. FIG. 20 shows a list 20000 of studies with a “decision box” between them and further data points. Once we capture the data points we need, we can start stacking them upon one another. The most relevant studies and highest quality studies will generally be at the top. You will see the statistics we are looking for, perhaps highlighted in red boxes, as below. We can also have a divider. The studies above the divider will be used when we decide on the data points we are actually going to use in our calculations while the studies below the decision box have been rejected for one reason or another. They can remain in our list so we will know that we have already reviewed them. In the decision box, we can show the number that we are actually going to use in our final analysis. We can also explain on why we decided upon that number. Others may came along and submit a number another study to be considered. It may be hard to see in the rose-colored decision box but there can be an option to submit a study to be evaluated or included box there or elsewhere.

Our organizational system can let us shorten and expand the templates so that we can see the data we need to see in order to organize studies into lists that we can use and visualize. In the list 19000, the shorter template is used to see the numbers more easily. In the list 20000 of FIG. 20, the longer template is used but it may be harder to see the numbers. However, our machine/software can automatically organize the studies based in our ratings of quality and relevance. We may also be able to drag and drop the studies above or below the decision box, or to drag and drop them into the order want to use them. Visualization and organization are generally key.

Using this method, we can create long lists of studies and the important statistics from them. We can then organize, visualize, and manipulate them.

The study templates can be miniaturized into little blocks to move around. If we can drag and drop them and actually visualize the data we need, it will be a tremendous organizational tool.

Those doing reviews should have choices. For example, the choice of using the data from one study as the best number, or from all studies as a weighted average, or choosing a non-weighted average, and so forth.

Assumptions. We should list all our assumptions on every page. Just like a good study lists its flaws, we should list the flaws and assumptions in the appropriate locations.

List of Studies. Every treatment in medicine, every medical decision, every medical hypothesis, and every theory, are generally all essentially about lists of studies. One could say, it's all about lists. Lists of studies are used for almost every decision in medicine.

We list the best studies. One of our preferred ways of thinking is to try to do everything from the patient's point of view. Currently, academic institutions and government agencies ignore all the studies except for the very highest quality studies when they are trying to come up with best practices.

However, the patient often needs to know the best studies for every possible treatment. Even if those are low-quality studies, they often need to know where things stand. These lists are also needed for people who are trying to research that particular diagnosis or other clinical decision. We should know the best study, or studies, for every treatment, or medical decision, even if it is a poor quality study. Just knowing the best study for every treatment is generally a big deal, because that's where future research should start.

Many evidence-based medical decisions may ignore all the low level studies. However, in real life doctors and other healthcare providers must make treatment decisions. Therefore, our system generally does not ignore low-quality studies. We generally always look to find the highest quality study for the clinical situation and we list the best that we can find.

In addition, surprisingly, much of medicine is actually practiced based on low-quality studies. Everyone generally needs to know this including: the patients, the lay public, the doctors, nurses, all healthcare providers, and the media.

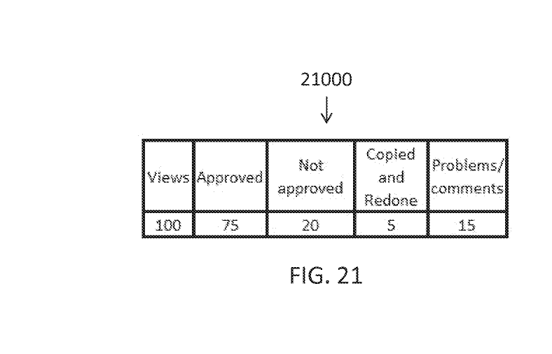

Feedback Pane. Almost every step in the process can have a feedback pane, and each page can have a feedback area, and each statistic can have a feedback system. FIG. 21 shows an exemplary feedback pane 21000.

We may have a social network that is constantly critiquing and making improvements. When a score, or anything else, is getting lots of criticism, we may insist that they create their own treatment scores. That way, they can see how the process is done and we can criticize them for improving their scores as well. This can be considered using crowd wisdom, or the Delphi technique, or a quality improvement system.

The work of finding all the references in data points should be able to be copied so that another person can use them to come to their own science of medicine conclusions within our system.

Our quality control system can tell us the status of a review (e.g., the last time the review updated, how others have rated it, the number of times it is been improved, how the biases have been removed, the lists of criticisms, etc.)

Feedback Idea. If someone does not agree what our user or expert put up as the science of medicine treatment scores, perhaps they can comment on it. But perhaps after so many criticisms, maybe the comments will not show up unless that critic goes to the trouble of producing science of medicine treatment scores themselves, and putting them up for criticism as well.

For example, if I put up my treatment score for a diagnosis, another user can accept my evidence-based medicine analysis of the literature by confirming it, or they can improve it and pass on their results, or they can pass on the situation entirely, or they can create their own analysis to put up for critique.

If someone thinks they can do better; we want them to do better. We generally want transparency and scrutiny and constant improvement.

We can have simple surveys as part of our feedback system. Do you recommend this treatment for your patients or not? And on and on, we can do surveys depending on the status of the user, whether they are a healthcare provider, have some other form of expertise, or are a patient or layperson.

Feedback. We can provide demographic data on who is doing or feedback. For example, we can set up our system so that we can see who the expert reviewers are, who has the appropriate expertise, and what the quality ratings or for a science of medicine treatment score, scales, guidelines, or anything else in our system.

Feedback Discussion. The systems and methods provided herein may include extensive feedback discussion pages (provided through a website, web forum, database, or the like, for example).

Lists of Treatments are Novel. The creation of long list of possible treatments is a new and novel invention in medicine. Typically, a review article will list the top 5 or 10 treatments. The systems and methods provided herein can examine any suggested treatment and will produce science of medicine treatment scores and treatment grades for that treatment. No matter how obscure, or offbeat, or if it is Western medicine, herbal medicine, or alternative medicine, we can find the best existing studies, and we can come up with the science of medicine treatment scores and treatment grades. We may have a list of 100 treatments for some diagnosis, but they will be presented from highest treatment score to lowest treatment score in most embodiments.

Simply having long lists of treatments and being able to find the data behind them the way we are doing it is a new and novel thing in medicine.

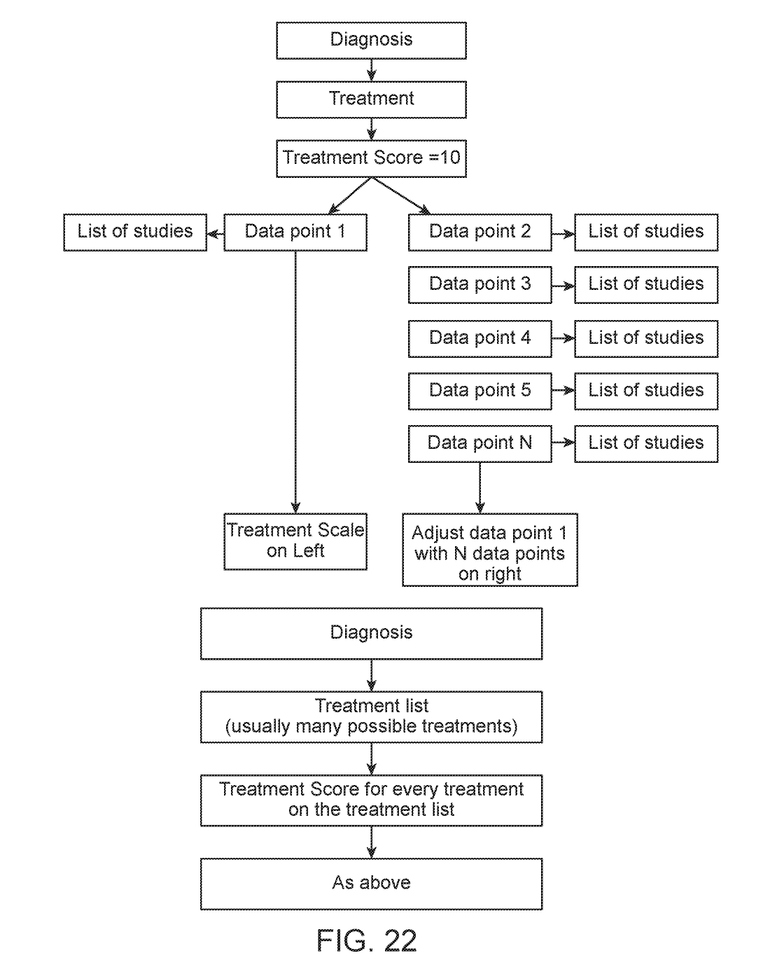

High Level Schematic. FIG. 22 shows a high level schematic 22000. The big picture schematic 22000 starts with the diagnosis. Then, there is a list of treatments for that diagnosis. Each treatment can have a treatment score. That treatment score was derived from a list of data points, or statistics, that are important for that treatment as described herein. Each of those data points has a list of studies from where it comes.

EBM Guidelines. Systems and methods of the present disclosure will generally have evidence-based medicine guidelines. These evidence-based medicine guidelines may be applicable to one diagnosis, or they may be pertinent to an entire group of diagnoses. We expect the evidence-based medicine guidelines to be constantly improving and to constantly be updated over time until the best systems become the most commonly used in our Science of Medicine System.

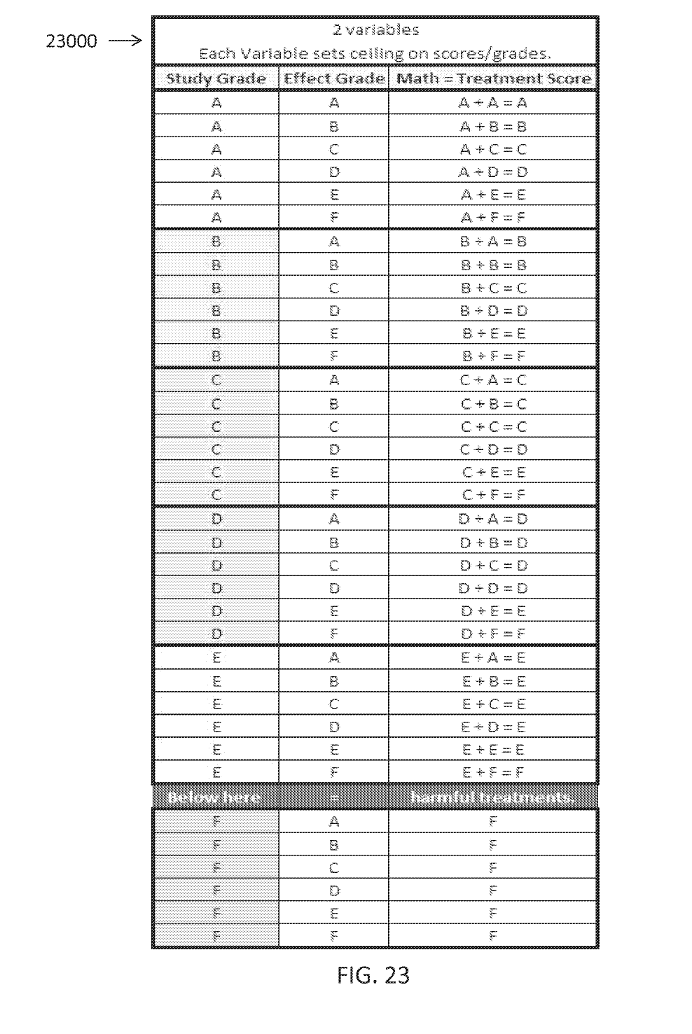

Two Variable Problem. Quantifying the science of medicine, in the big picture, is essentially a 2 variable problem. When we are talking about a treatment, the 2 variables are the “quality of the study” from which we get the data and the “quality of the treatment effect.” FIG. 23 shows a chart 23000 of the quality of the study and the quality of the effect as those variables set limits on the treatment scores and grades.

One of our potential guidelines, the current preferred guideline, is that the quality of the study, or the list of studies, sets the ceiling on the treatment score, and the quality of the treatment effect also sets the ceiling on the treatment score. If you have a grade A study, or list of grade a studies, the treatment score can be as high as grade A. However, if you have a grade E study, or list of grade E studies, the treatment score can only be as high as grade E.

The quality of the treatment effect may set a limit as well. If you have a grade A study but the treatment effect is grade E, the treatment score is going to end up being grade E.

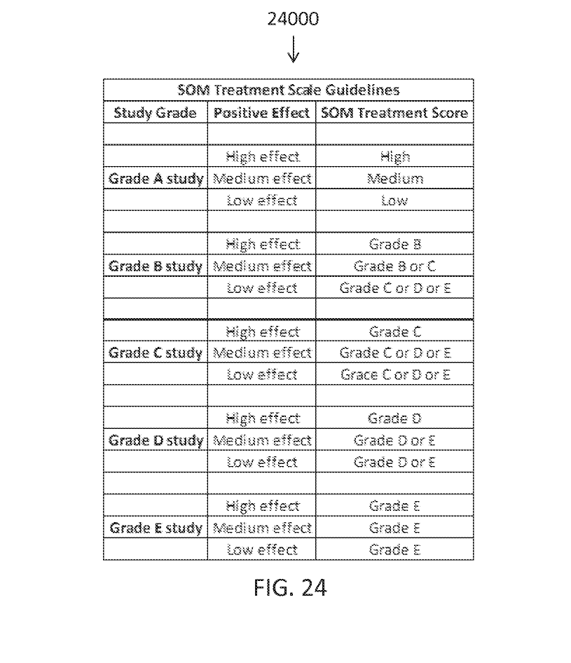

Study Quality and Effect put ceilings on Scores. FIG. 24 also shows a simplified chart 24000 of the 2 variable problem of the chart 22000. It can apply to a single study or a list of studies.

Ceilings on Lists of Studies. We can use several methods for putting ceilings on the list of studies. For example:

1. Average of the ceilings for all the studies.

2. Average of the ratings for all the studies.

3. Use ceiling of lowest quality study for all.

4. Use the ceiling of the highest quality study for all.

5. Weighted ceilings averaged out by using the quality ratings combined with the ceilings.

There should be “punishment” or downgrading for using less quality studies to make medical decisions. Using poor quality studies is how outrageous snake oil treatments have been introduced into the medical literature and how patients have sometimes suffered horribly. You can take a low-quality study and conclude that something is 100% effective. You can then take a high quality study and determine that the same treatment is virtually 0% effective.

Guideline for Output from a List of Studies. One of our preferred embodiments is that if 2 independently done high quality randomized controlled studies show that a treatment is around 91 or 92% effective in curing a disease, and there are no negative side effects or other mitigating factors, the treatment score for that treatment should be around grade A. If there is only one quality randomized study the situation may warrant an either an A or A−.

What is important to note is that if your treatment decision is based on all randomized controlled trials the top of the ceiling will be higher, even all the way up to 100, than if the list of studies you are basing your decision on includes lower quality studies such as case series studies or uncontrolled studies.

Basically, basing a decision on lower quality studies will generally result in a lower ceiling and a lower score.

In addition if the effect is low, the score will be lower. It is a 2 variable problem. The 1st variable is the quality of the studies which sets the ceiling, or range. The 2nd variable is the quality of the treatment effect which sets a ceiling as well.

Competition for Best Guidelines. Ongoing competition for best guidelines may be provided. Three randomized control studies may have a ceiling of 100. One randomized controlled study could have the ceiling of 100 if it is so large and so well done and so free of biases that there is little question of its results being valid.

Guidelines for Cures vs. Chronic Management. We can have different guidelines for things that can be cured and things that must be chronically managed.

In one of our preferred methods, if there is relief of symptoms, but a diagnosis must be chronically managed or treated, that would be scored less than curative therapy.

Maintenance. The Science of Medicine Database can be maintained because the number of high quality studies does not actually change that often. For example, the treatment score for localized prostate cancer, for several different treatments, has remained in the same decile or didecile for 20 years. This may be because once you have one high quality study is often years before another high quality study comes along with a different result.

Bedside manner. The Science of Medicine System should be like a good bedside manner. It should be so pleasant and understandable to the user that they will not necessarily be aware of highly complicated backend statistical data when it is present.

Consensus vs. Competition. We want to use many techniques to arrive at the best answer for the end-user. Consensus among the most highly rated reviewers on our system may be desired. It may be desired to see consensus from doctors in a certain specialty.

We do not necessarily always want consensus. It may be desired to have the decision of the best individual. Sometimes the wisdom of the individual is greater than that of the group. Sometimes only 2 or 3 people may get it right and everyone else may be wrong. We also want the end-users to be able to go through the system and come up with their own conclusions for treatment scores, or their own conclusions for other medical decisions.

Competition. The Science of Medicine System for the quantification of the science of medicine behind treatments, and other medical decisions, can be set up as a competition. One physician (or other user) may quantify the science of medicine behind the treatments for a certain diagnosis. A 2^{nd} physician (or user) may come along and copy all the work previously done, and then perhaps makes improvements, or uses of different studies, or reorders and reprioritize some certain studies. They come up with their own science of medicine treatment scores. Then using our feedback system, people can rate the results and see who they believe came up with the most evidence-based medicine conclusions.

Biases. We can have filters to just show the scores from certain demographic data. We can have global scores from all users. We can have filtered scores from one specialty, or any other demographic. This will enable us to use systems and techniques to remove biases.

Competition Metaphor. At Journal clubs in medical residencies all across the country, physicians often discuss a diagnosis and the pertinent medical literature. There is often one physician in the room who is the most intelligent, the most up to date, and the most experienced and who often has the most correct answer when it comes to treatments or other medical decisions. Our system is designed to try to get to that information. We can use competition, and other methods, to get to the best information.

Competition for Everything. Virtually every part of our system can be in competition (e.g., extracting the best data points, creating the best study scales, creating the best treatment scale, creating the best evidence-based medicine guidelines, coming up with the best treatment scores, coming up with the best Science of Medicine Scores for other decisions in medicine, etc.)

One embodiment of the Science of Medicine System is for there to be a competition to do the best quantification. Users may accept the quantification, critique the quantification, or attempt to do a better one.

Consensus. Another embodiment would be to use consensus and combined quantifications from certain parties who are highly rated parties or highly qualified parties.

Decentralize/Democratize. We are decentralizing the work to find the data in healthcare. We are decentralizing the quantification of the science of medicine process. We are “democratizing science”. We are empowering patients by making the medical decision process transparent and open for participation.

Challenges. We can set our system so that users can challenge a list of studies. They can challenge the statistic that was used. They can challenge the list of treatments. We have tried to set up every step so that it can be challenged and improved upon.

Computers/Laptops/Cell Phones/Etc. Our method of the Science of Medicine System for the quantification of the science of medicine can allow users to access input on many devices. Computers, notebooks, laptops, Cell phones, and so on can all be used. They can be used for review or for input.

Automation. Our system may be configured to be semi-automated. More and more automation can occur over time. Other processes such as artificial intelligence may be able to automate the system completely.

We have some formulas that can calculate the treatment scores. These “machine algorithms” can be compared to the semi-automatic algorithms that have human input.

Exceptions. We may have techniques to handle exceptions where there are problems with data. For example, we intend to produce a clinical experience score in situations where the practicing physician's, or other experts, clinical experience with patients is different from what the medical literature says in the past. What if a brand-new chemotherapy is curing 100% of the patients? A using clinical experience scores, comment sections, and other methods we can make this immediately transparent to people. The same thing goes for something that suddenly is curing everybody. It would then be unethical to do a randomized controlled study. It may be unethical to do any controlled study. One way we handle this is that that treatment would still have the highest score, even if it was based on case series data alone.

An important thing is that the relative values of all the treatments are clear and the science they are based on is clear.

But if we don't constantly point out that things don't have the best science behind the treatment, no one will be looking to improve the science for that treatment.

Reimbursement. Treatment scores or treatment grades can be tied to reimbursement to better distribute healthcare. Doing so will help incentivize higher-quality treatments over lower quality treatments. It will also help healthcare systems from going bankrupt.

In addition, one of our methods of doing scoring would put things that are non-curative lower on the SOM Treatment Scales. If this system is used, it might focus research on things that need to be cured, since reimbursement would be lower for non-curative things, there would be more incentive to find cures.

Education and Research. Our system can be an educational tool, research tool, and a possible reimbursement tool.

Copy the Work. Once someone has quantified the science of medicine for a certain diagnosis and the possible treatments, the next person has that work as their starting point. They can simply copy it all, or it can be automatically imported into their working space, and then they can improve the quantification of the science of medicine by adding new references or statistics or by moving around the references or statistics in a way they believe is more preferable or accurate. Or, they can start fresh and copy nothing from others.

Social network. By having the social network of physicians, nurses, allied health professionals, patients and others producing quantifications of the science of medicine, and treatment scores, we can generate all kinds of interesting statistics. We can use filters to see how different people from different backgrounds quantify the science of medicine. We can use this type of information to look for bias or prejudice in the quantifications.

New graphics. When we have enough data points, we can create static graphics, moving graphics, and graphics that are movies. The graphics with motion can display important differences and outliers in statistics to help us interpret what is right about the data and what is wrong about the data.

Ratings. We may have ratings for almost everything in the quantification of the science of medicine process. At the end, we will even ask people how well they believe they did their ratings. This can be a check against confidence bias or overconfidence bias. We can also have ways to check on how much time and effort people put into their ratings. Essentially as the system grows, more and more ratings and checks and balances can be put into place to improve the output. The raters and the users may be rated themselves in different embodiments of our system.

Identities. Many embodiments allow users on the Science of Medicine System have many different identities (e.g., an anonymous identity, a beginner's identity, an expert's identity, and so on and so forth.) The reputation of the person doing the quantification may be personalized so that people can pick and choose their own experts based on what is important to them about the expert's demographic data and other features.

Verifications. Many embodiments have ways to verify every single data point or statistic used.

Competition and Contests. Many embodiments may use competitions and contests to help us achieve the best quantifications of the science of medicine.

All electronic devices present and future. The systems of the present disclosure can work on computers, laptops, notebooks, tablets, cell phones, and any other future device.

Mathematical Algorithms. According to many embodiments, human judgment can be compared with various mathematical, or other, algorithms. For example, we can automatically come up with treatment scores for various treatments using mathematical formulas that are strongly based on the one most relevant statistic, or even completely based on the one most relevant statistic. These machine algorithms can be compared to our semi-automated human algorithms.

Aspects of the present disclosure also provide further systems and methods for provide scores for various treatments. An exemplary system for generating a score for a treatment may comprise a diagnosis subsystem for managing one or more diagnoses or indications, an organizational or treatment subsystem for managing one or more treatments for the one or more diagnoses or indications, a scoring subsystem for generating one or more scores for the one or more treatments, and an evaluation subsystem for managing the inputs used to generate the one or more scores. Each of these subsystems may comprise a user interface, and the user interfaces may interact with one another. The evaluation subsystem may also comprise one or more study templates referred to as STAR Blocks™ (where STAR may stand for “statistics and a reference”) and described herein and above.

The evaluation subsystem may comprise an interactive medical review article system for the public and all medical professionals. The evaluation subsystem may provide an interactive review and generation of relevant statistics for one or more medical review articles. The user interface of the evaluation subsystem may allow medical review article content to be organized and visualized in a predictable, familiar format. A user can follow the diagnosis to the treatments, to the ratings of the treatments (e.g., quality ratings for the science behind the treatments), to the statistics used, and to the references from which the statistics come.

The diagnosis subsystem may be provided for the public and all medical professionals as discussed herein and above. The diagnosis subsystem may allow for general or specific diagnoses, may allow the user to choose the main statistic, the time period of follow up, and to as specific as they want about the patients being reviewed.

The treatment subsystem may comprise a user interface that may allow lists of treatments to be organized. The treatment subsystem may be appropriate for use by the public and all medical professionals.

The scoring subsystem may be appropriate for use by the public and all medical professionals.

The evaluation subsystem may surround a main statistic with all the variables that may need to be taken into account to rate the quality of the statistic for the diagnosis we are studying. The evaluation subsystem may allow the public and all medical professionals to quantify or score a medical review article, for example, to quantify the quality of the science in the review article. The treatment score statistics may be capped or have a ceiling to reduce bias or signify the use of lower quality studies.

The systems of the present disclosure provide a novel, interactive way of rating and organizing one or more medical review articles and can allow user(s) to quantify the science of medicine behind treatments and other clinical decisions, organize relevant statistics together, and link statistics to references. The systems may comprise a publish/unpublished button which can allow users to publish their interactive medical reviews when ready.

With the systems of the present disclosure, even though the medical review may be present on a website and be interactive, when the user desires to print the medical review, it will print out the entire medical review in a brand-new format, that logically links all the text put into the system to all the graphics that are developed by the system. This means that the diagnosis tool or subsystem results, the treatment organizer or treatment subsystem results, the treatment score analyzer or scoring subsystem results, and the evaluation subsystem (e.g., STAR Block™) results can all print out in a logical and rational order as a new style of medical review never done before.

With the systems of the present disclosure provide areas to comment and areas whereby all the problems of a statistic, or of a study, and a list of all the biases and assumptions that must be made to come to a conclusion can be listed. These areas can also be printed out when the user prints out a medical review article using the systems.

The systems of the present disclosure may encompass developing statistics at a point in time. Flexibility in the point of time may be allowed. For instance, the follow-up can be immediately after treatment, five years after treatment, until death, or at any time in between including during treatment.

The scoring subsystem may list rows of the evaluation subsystem study templates (e.g., STAR Blocks™) and these rows may be moved around in the user interface. In the evaluation subsystem, “fuzzy numbers” may be shown as differentiated from hard numbers, such as by using standard deviations, confidence intervals and other typical statistical devices, but also possibly using color, shading, and other devices.

In many embodiments, the evaluation of treatments may be given a score in base 10 or base 100, making the mathematics throughout the system work easier. For example, studies may be rated on a 100 point scale. The main treatment effect can be normalized for placement on a 100 point scale, even if a three-point scale is used, or a four-point scale is used, or a 30 point scale is used as often the case in real life. The side effects and side benefits can also be normalized for placement on a 100 point scale. The relevance of a statistic can also be normalized for placement on a 100 point scale and the overall quality of a statistic for a diagnosis in the evaluation subsystem (e.g., STAR Blocks™) can be on a 100 point scale.

A ceiling can be placed on the treatment effect based on the quality of the study or studies used. Providing such a ceiling is a new development in medicine. The ceiling can also be placed because of relevance. A statistic that is about solid cancerous tumors, for example, may be less relevant than a statistic about a specific solid tumor such as cervical cancer.

The systems herein can be flexible so we can use multiple rating systems, study guidelines, and algorithms for different people who want different settings.

The 100 point scale can be divided into groups for grading. Such a grouping may be referred to as a “didecile,” a new term invented by the present inventor referring to 5 equal groups representing 20 numbers out of 1 to 100. As discussed herein and above, 81 to 100 points can be assigned as grade A, 61 to 80 points can be assigned as grade B, 41 to 60 points can be assigned as grade C, 21 to 40 points can be assigned as grade E, and 1 to 20 points can be assigned as grade E.

The systems herein may rate all treatments, including rating FDA approved treatments, non-FDA approved treatments, Western medicine, Eastern medicine, herbal medicines, homeopathic medicine, Ayurveda medicine, clinical trials, complimentary medicine, and every other possible form of alternative medicine and treatment. This means that doctors can see the medical literature from other types of medicine summarized as treatment scores or treatment grades and can follow the scores or grades to the exact references and statistics.

The systems herein can provide tools for medical professionals of one specialty to now look over the shoulder of the other specialties of medicine for the quality of their evidence based medicine. Currently, one specialty of medicine does not typically read the journals of another specialty of medicine. The systems herein can make it easy to look up the science of medicine that other specialties are using.

Much of the systems herein can be automated. Jadad scores and other open source rating systems can be incorporated to the systems herein. The systems herein can comprise a plurality of drop-down menus and other conveniences. The systems herein may support further statistics, for example, the total number of patients, breakdowns, percent male, percent female, and racial statistics can be added. The evaluation subsystem (e.g., STAR Blocks™) can be improved in many ways, for example, information such who did the study can be added (e.g., information as to whether the study was a government study, or a corporation funded study, information about any possible biases of the authors, information about other funding provided to the study, etc.). Verification subsystems may be added for the evaluation subsystem (e.g., STAR Blocks™).

In addition to generating scores for treatments at a time, the scores for treatments may be generated in a dynamic manner. For instance, further dimensions may be added to the generation of the scores such as volume over time as well as the static numbers at a period of time.

The systems herein may comprise validation subsystems. Reputation scores for the people who use our system to develop treatment scores may be provided. In fact, ways to rate every step of every process in our system may be provided. The systems herein may comprise ways to comment on every step of every process in our system. The systems herein may provide areas for users to suggest studies or future research to do. The present disclosure may provide methods so that a patient can generate a treatment score before treatment and then after having undergone treatment can generate further treatment scores having experienced the treatment personally. This may improve the accuracy of the treatment scores when done by patients.

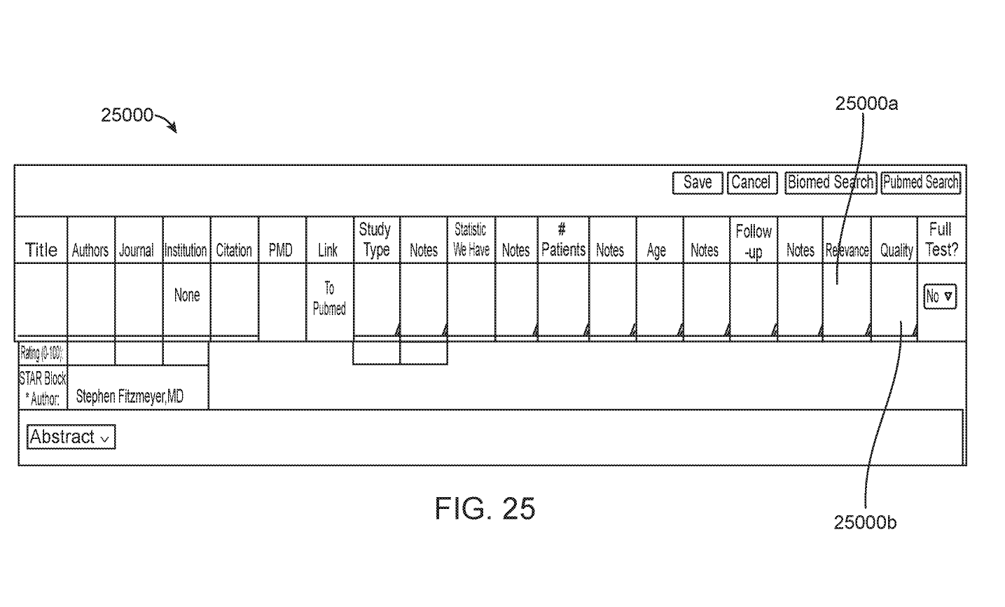

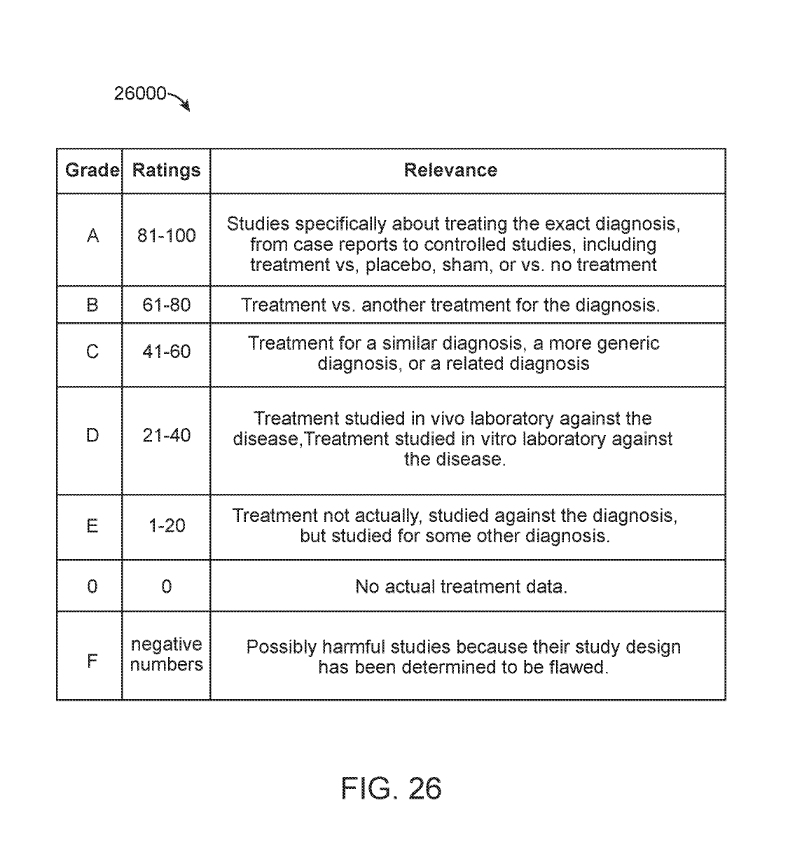

FIG. 25 shows an exemplary study template 25000. The study template 25000 may comprise a box 25000a for showing a relevance score or grade and a box 25000b for showing a quality score or grade. To clarify what the relevance score or grading means exactly, a relevance table can be provided. FIG. 26 shows an exemplary relevance table 26000. The quantitative grade or rating may be grouped into dideciles by different features of the study. The quantitative grade may be provided for the main or defining statistic of the medical review or study. In addition to relevance and study scores, boxes or inputs for reference number(s) and/or link(s) for the medical data may be provided, for example, a PMID number, a PubMed number, or a BioMed number. By inputting the reference number, the system can access the database for the medical data and download relevant information to populate the remainder of the study template. The study or review or other medical data may be automatically graded in response to the information gathered. A button may also be provided to empty the study template. Other forms of input may also be accepted, such as a “news story” or “blog post.” By having the URLs of these kinds of things in the system and actually rating them as well, it gives the lay audience a way to find and read educational materials, and also “first report” materials on new treatments, whether they have data we can use or not.

An 81-100% relevant or Grade A study may comprise a study that is specifically about treating the diagnosis with the treatment of current interest. For example, the study may comprise a case report about treating cancer with surgery or a randomized controlled study about treating cancer with surgery or placebo. The study may be 81-100% relevant or grade A if it compares the treatment with placebo, sham, or no treatment. An 81-100% relevant or grade A studies can be forward in time or backward in time, they can be prospective or retrospective.

Where there is no treatment, an 81-100% relevant study may be one that follows the natural history of a disease that is not treated at all. An 81-100% relevant study may be one that establishes the natural history of the disease without treatment.

Where secondary statistics are discussed, an 81-100% relevant study may be a study that tracks the side effects of the treatment for a certain diagnosis. Quality of life studies can be 100% relevant.

A 61-80% relevant or Grade B study may comprise a study about a treatment compared to another treatment, as opposed to comparing the treatment to no treatment, placebo, or sham. For example, the study may compare radiation to surgery instead of radiation to no treatment, placebo, or sham.

A 41-60% relevant or Grade C study may comprise a study that compares treatment to a related diagnosis or a more general diagnosis. For example, where the diagnosis is sepsis caused by E. coli, but the study is about a treatment given for sepsis in general.

A 21-40% relevant or Grade D study may comprise a study in which the treatment is studied in an in vivo laboratory against the disease or diagnosis.

A 1-20% relevant or Grade E study may comprise a study in which the treatment is not actually studied against the diagnosis but studied for some other diagnosis.

A 0% relevant or Grade 0 study may be one where there is no actual treatment data.

A negative number for relevance or Grade F study may be one where the study is possibly harmful because the study design has been determined to be flawed.

Once a list of studies organized by relevance to the topic is collected in the form of rows of filled out study templates, another next step may be to rate them for quality as described herein and above. The overall quality of the study described in the study template is often different than the quality rating for the study itself. A study can be extremely high quality but if it is off-topic then it cannot be as highly rated in quality for that particular treatment or that particular statistic. When rating the overall quality of the study, the quality and relevance of that statistic for that specific diagnosis is rated. The rating can be made in many ways with many formulas.

quality of study+relevance/2=quality Formula 1:

Using Formula 1, the system may add the quality score of the study and the relevance score of the study and divide by two. The result may equals the overall relevance of the study template (e.g., STAR Block™) for that statistic for that diagnosis.

### Example 1

Within the study template (e.g., STAR Block™), the quality of the study is 90. The relevance of the study is 100. 90+100=190. One hundred ninety÷2=85 for quality of the study template (e.g., STAR Block™) which goes in the far right cell of the study template (e.g., STAR Block™).

### Example 2

Within the study template (e.g., STAR Block™), the quality of the study is 20. The relevance of the study is 100. Twenty+100=120. One hundred twenty÷2=60 for quality of the study template (STAR Block™) which goes in the second to last far right cell of the study template (e.g., STAR Block™).

Formula 2: Using Formula 2, the relevance may be weighed higher in the future. The quality rating can take into account every rating the study template (e.g., STAR Block™) has within it.

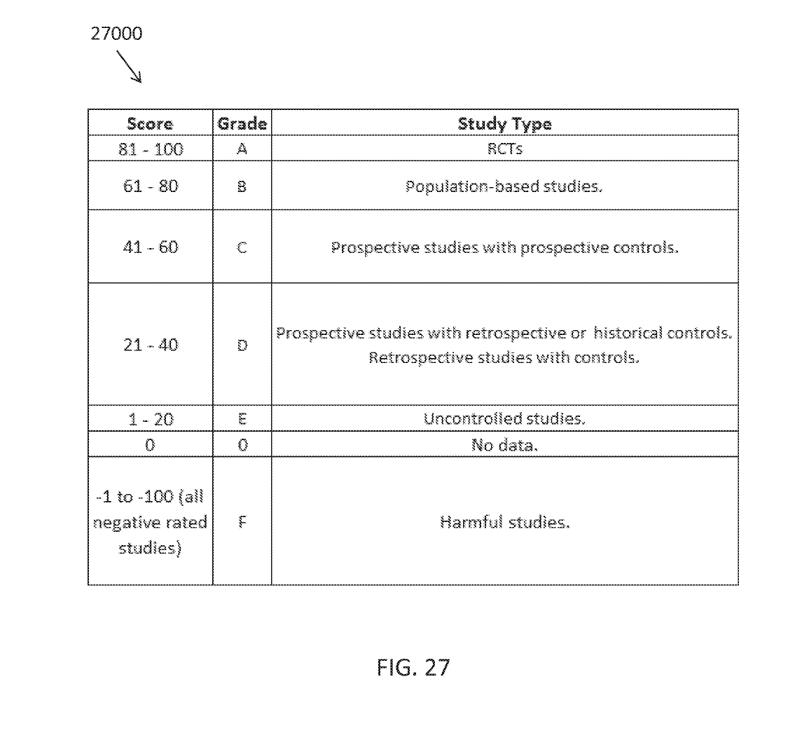

The score or rating for the main statistic for a medical study or review may be generated. The study quality may place a ceiling over the treatment effect that may be used. FIG. 27 shows a table 27000 of scores and grades with study types.

The highest-quality study in medicine is generally accepted to be the randomized controlled trial, randomized controlled trials combined into a meta-analysis, or randomized controlled trials combined into a combined data analysis. The lowest rated study in medicine is the case report, also known as the anecdote. A score of 81 to 100 or a grade of A may indicate a randomized controlled trial or a combination of RCTs. A score of 61 to 80 or a grade of B may indicate a population-based study. A score of 41 to 60 or a grade of C may indicate a prospective study with prospective control(s). Such studies reflect an average study in medicine. A score of 21 to 40 or a grade of D may indicate a prospective study with retrospective or historical control(s) or a retrospective study with control(s). A score of 1 to 20 or a grade of E may indicate an uncontrolled study. A score of 0 or a grade of 0 may indicate no data. Review articles without any new data can be rated “0” but are often an excellent starting point to find the studies with the data needed. They may be given a rating of “R” for instance. A negative score (−1 to −100) or a grade of F may indicate a harmful study. A study that is fraudulent and completely untrue may deserve a negative rating. Sometimes a treatment that was to benefit patients will turn out to be harmful, and then that treatment effect may be rated as negative. For example, a treatment designed to help people lose weight can cause so many heart issues, or other terrible side effects, it turns out to be harmful to the patient.

Grades and scores can be interchangeable similar in to the way shown by tables 8000, 8001 in FIGS. 8A and 8B described above.

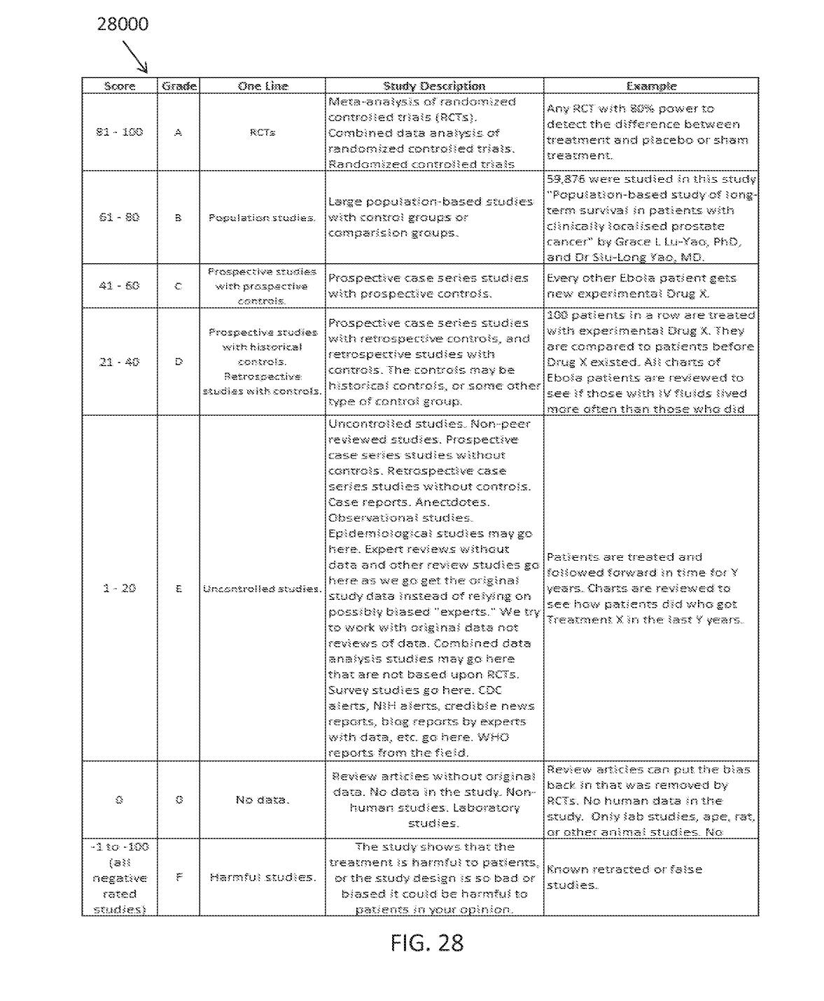

FIG. 28 shows a more detailed table 2800 of score and grades with study types.

The rating for the quality of the study and the statistic for the treatment effect may be presented by the study templates. The highest number of the two numbers may act as a ceiling on the statistic used.

While various ways of calculating scores or ratings are described, the system may encompass further ways of calculating and applying scores or ratings to improve the system such as to improve the rating and evaluation of evidence-based medicine.

Evidence-based medicine is about certainty. With what certainty do we think that the findings from a study are true? With the randomized controlled study we know the treatment effect is much more certain to be true. With a case report we know the treatment effect is much more likely to be due to chance alone or due to some sort of bias.

What we are trying to do is to separate studies by quality into at least five positive categories A, B, C, D, & E after translating their ratings into grades. We are also separating treatment effects by quality into at least five positive categories, A, B, C, D, & E as well (grade F means a negative in study quality or treatment effect).

In many embodiments, we are trying to evaluate all information from the patient's perspective. What studies or abstracts are available to the patient right now? We will start with them. What guidelines are easiest for patients to use? We will start with them. Organizing the medical literature like this would have prevented some of the great tragedies in medicine, tragedies like the frontal lobotomy scam, the epidemic of unnecessary hysterectomies, and the unnecessary arthroscopic lavages for arthritis of the knee.

In many instances, every type of treatment study can be derived from a case report. The case report is a study of one patient. When you combine many patients, you have a case series study. Case-series studies can be prospective or retrospective. They can be controlled or uncontrolled. They can be randomized or not randomized.

These study rating guidelines may be rough guidelines because the size of the studies matter. We are talking about what would be an average study of such and such a type in the medical literature. We have to ask questions like how does a randomized controlled study of two patients where the patient either lives or dies compare to the quality of a case series study of two patients where the patients either live or die?

As discussed above, the “ceiling” system can based on the study rating and the treatment effect. The rating of the quality of the study places a ceiling on how believable the treatment effect can be. What we do is use the quality of the study to place a ceiling over the treatment effect. To make this easier to understand we have created a table using grades as an example. The ceiling for the combination of study grade and effect grade may be implemented as shown in table 23000 in FIG. 23.

A ceiling may be imposed for various statistics, ratings, or scores, as discussed herein and above. The ceiling may be represented in many ways. The ceiling for a statistic, score, or grade may comprise as a visual device to demonstrate when the statistic, score, or grade, is limited by the quality of the medical study or medical studies used to derive it. This may be desired because in evidence-based medicine you must take into account the quality of the study as well as the statistic(s) from the study. The ceiling may also be imposed for relevance.

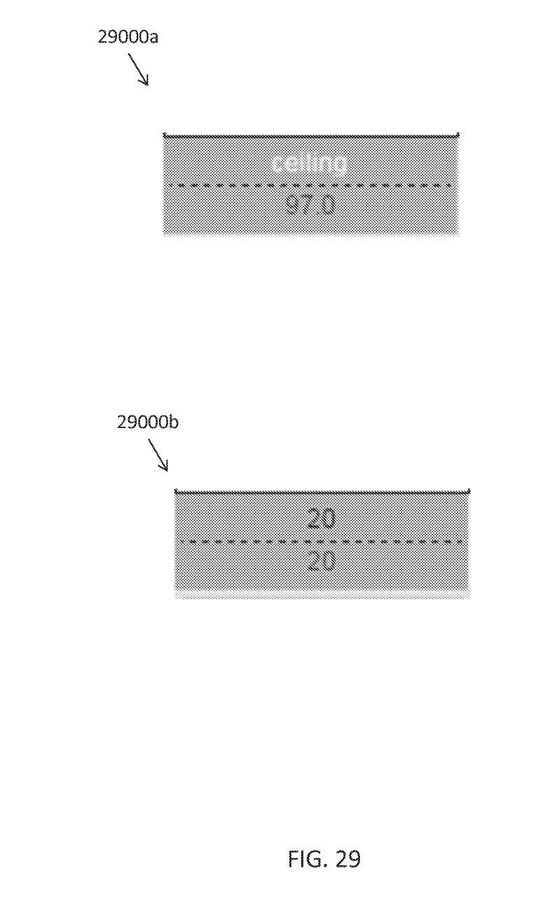

The ceiling may be represented as a simple graphic as shown in boxes 29000a and 29000b in FIG. 29. One method may be to place the word “ceiling” over the statistic, score, or grade as in box 29000a. Another method may be to place the phrase “ceiling on” or “ceiling off” over the statistic, score, or grade. Where a “ceiling off” in indicated, no ceiling is applied at all. Another method may be to have the word “ceiling” be bold in terms of its font when the ceiling is on, and be light or nearly “grayed out” when the ceiling is off Another method may be to have the word “ceiling” present as a label, and when the number for the ceiling is determined, the actual number replaces the “ceiling” area. For example, in the box 29000b, the word “ceiling” has been replaced by the number 20 because the quality of the study or studies used is 20 on our rating scale. Therefore, even though the statistic might've been 97.0, which it was in this case, the quality of the study or studies used is so low the statistic for actual reference and use has been reduced to 20 (i.e., a ceiling of 20 is imposed). The boxes 29000a and 29000b may comprise subsections of a study template or row (e.g., STAR Block™).

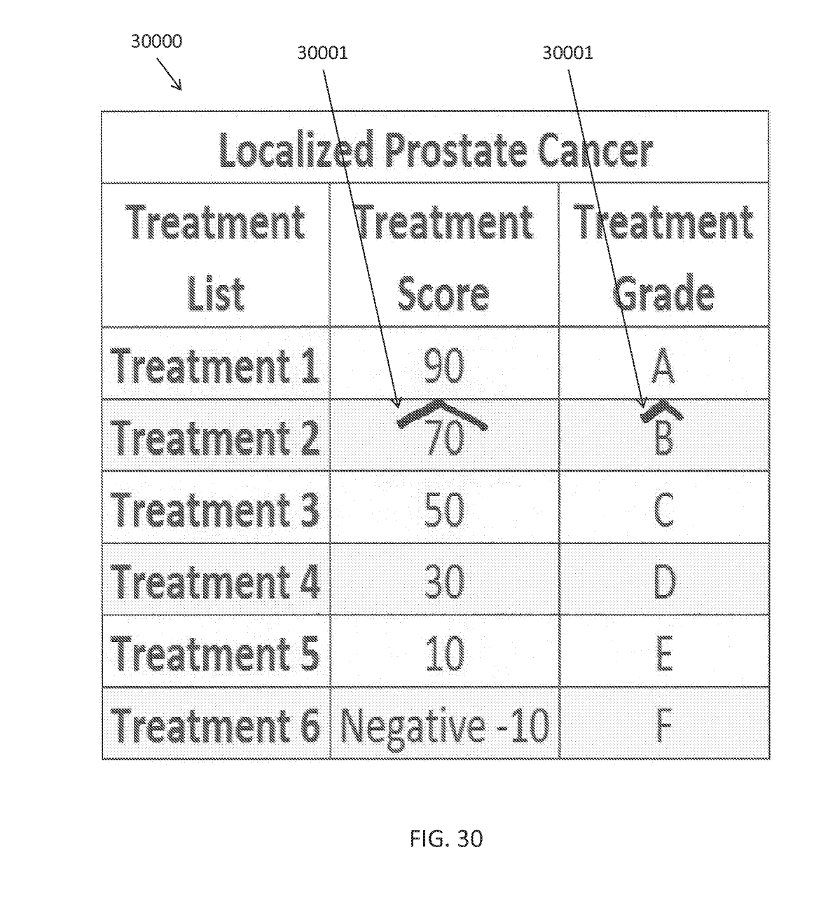

Another way to represent a ceiling may be to put a carrot ceiling 30001 over the statistic, treatment score, or treatment grade listed in a table of treatments 30000 as in FIG. 30, for example.

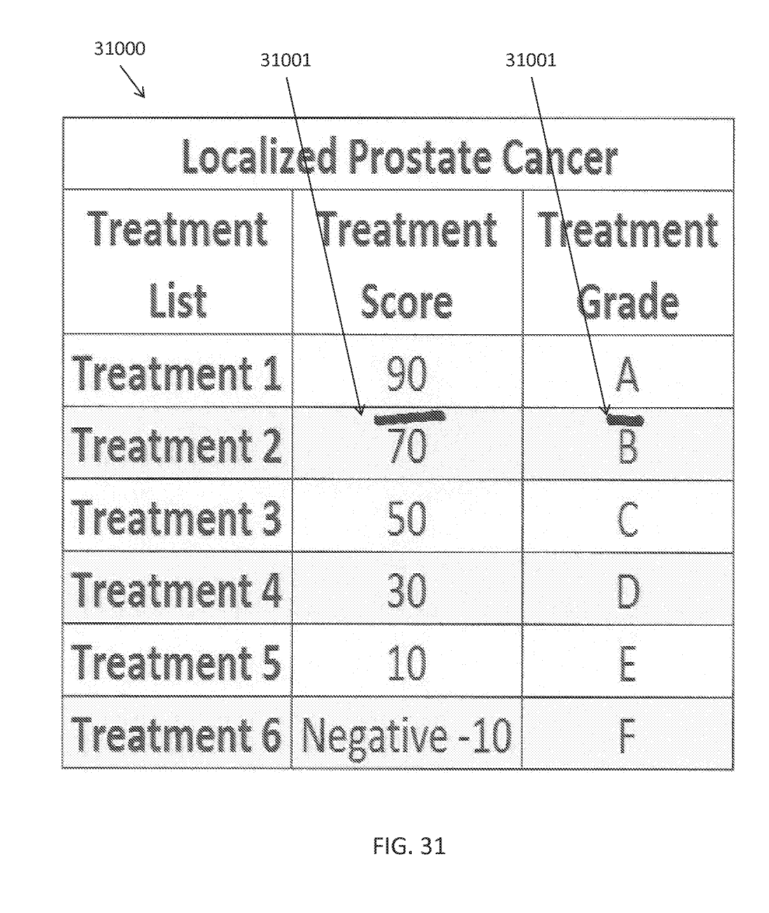

Another way to represent a ceiling may be to put a line ceiling 31001 over the statistic, treatment score, or treatment grade listed in a table of treatments 30000 as in FIG. 31, for example.

For practical purposes, such as spacing issues, the width of the carrot or line will probably have to be no wider than the number or the letter. The graphic below demonstrates this better. Ideally, when either a carrot or a line is used as a ceiling it would be no wider than the number or letter that is underneath it. In some embodiments, both carrot and line ceiling may be used in the same table of treatments.

Giving an example of the extremes in evidence based medicine can help with the understanding of the reasons to impose a ceiling. First, imagine that you have a perfect study. The perfect study is a randomized controlled trial, placebo-controlled, double blinded, it has an 80% statistical power or better, it has a large number of patients, and no patients are lost to follow-up. The quality of this study is 100 out of 100. Therefore there will not be any “ceiling” placed on any of the statistics obtained from this study.

However, at the other extreme you have a case report or an anecdote which only gets a quality rating of one. Therefore, 1 is the ceiling on any statistic coming from that case report.

A retrospective case series is also a very low quality study. It is only one step above the case report. Imagine that a physician wants to demonstrate that massage cures cancer. Perhaps he has done massage on thousand cancer patients and three of them are still alive today. Perhaps he decides to do a retrospective study of his patients to prove that massage cures cancer. Let's say that the physician can remember the names of three of his patients that got massage and survived cancer. The physician writes up a retrospective case series of only those three patients that survived cancer. Therefore his retrospective case series study shows a 100% overall survival for treating cancer with massage. The flaw in this scenario is that the 997 other patients all died from their cancer. However, in a retrospective case series study the person doing this study can be biased and can selectively pick and choose the patients. In one of our preferred embodiments of our rating system, a retrospective case series study of three nonconsecutive patients would only get a quality rating of 1. Therefore a ceiling would be placed over the statistic of 1. So, in our system that 100% overall survival statistic is reduced to 1 as the statistic for later use and evaluation. This is an example of how we use both the quality of the study and the statistic for the treatment effect when doing an evidence-based medicine review of the medical literature with the systems herein.

The systems herein may be built to be flexible so that any number of methods, guidelines or algorithms can be used. Ceilings may be put on numbers to indicate the situation when the treatment score has a ceiling on it because the quality of the studies is lower than the statistic for the treatment effect. A goal of the present disclosure may be to rate every study in medicine from 0 to 100 (negatives also allowed). Once studies are rated, these ratings can be used to put a ceiling on the treatment score, grade, or statistic.

The rating of the “quality of the study” and the “treatment effect” can go together in evidence-based medicine. In the systems herein, the highest one of the two can put a ceiling on the main statistic for use or evaluation (i.e., the “Statistic We'll Use”) to determine our starting point for the treatment score (or treatment grade). When the ceiling is caused by the treatment effect statistic there may be no need for a visual ceiling. However, when the ceiling is being placed because of the quality of the study or studies it would be helpful to have a visual ceiling.

What evidence-based medicine and science-based medicine are really about is certainty. With what certainty do we think that the findings from a study are true? With the randomized controlled study we know the treatment effect is much more likely to be true. With a case report we know the treatment effect is much more likely to be due to chance alone or due to some sort of bias. We put the type of study in the systems herein and currently we rate the type of study in the cell below the study or by the relevance of the study or studies used.

We may not need a visual way to see the rating when the ceiling is put on by the treatment effect. But we may need a visual way to see the ceiling over the statistic, score, or grade, when the ceiling is caused by the quality of the study or studies used.

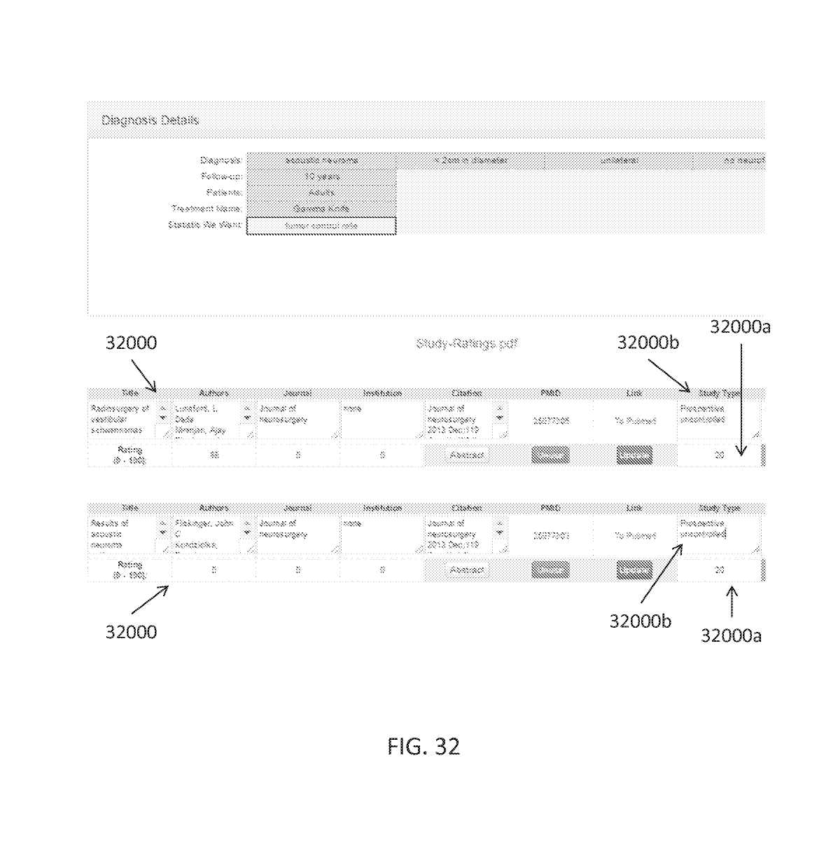

FIG. 32 shows an example in which studies are rated. FIG. 32 shows the information from a medical review placed in study templates 32000. Because the studies are prospective controlled studies, they may be assigned a quality rating of 20 out of 100, for example, in the entry box 32000a below the study type box 32000b which indicates qualitatively the study type.

Statistics in Clinical decision-making. When making clinical decisions, such as treatment decisions, in medicine the “Statistics We Want” or desirable statistics would typically be those from a very high quality randomized controlled trials. The “Statistics We Have” or the statistics currently available are often from lower quality studies. The “Statistic We'll Use” thus may have to take into account the statistic itself as well as the quality of the study or studies from which that statistic comes from. We try to sort out these problems on the STAR Blocks page, that is, the statistics and a reference page, where we surround each statistic with its reference data, ratings about the reference data, ratings about the relevance, ratings about the quality, and comments about different features of the study. Being able to see all these things simultaneously helps us visualize the “Statistic We'll Use” whether we come up with that statistic automatically, semi-automatically, or manually.

Graphical user interface. One of the goals of the present disclosure is to put a “graphical user interface” (GUI) on the thinking process of evidence-based medicine physicians. Another goal is that by putting a graphical user interface on the evidence-based medicine process we can make it simple enough so that essentially everyone can do it not just physicians or those medically or mathematically trained. If all users can do evidence-based medicine, it can allow for shared decision-making and patient empowerment. We want to bring evidence-based medicine to the masses. We are putting the GUI interface on the math problem described above. And, as much as possible, we are attempting to get all the assumptions and estimations that must be made on one page so that users can visualize these things more easily. Many medical decisions are based on a “house of cards” when all the problems and actual data can be visualized.

Statistic We Want, Statistic We Have, and the Statistic We'll Use. Also on the star blocks page we need to emphasize the statistics more. Because of the underlying math problem, and because we want to put a graphical user interface on it, on the STAR blocks page we have:

Statistic we want. When it comes to medical studies, the “Statistic We Want” is typically one from a perfect randomized controlled study. However, we often do not have such perfect statistics.

Statistic We Have. Often, the “Statistic(s) We Have” is from a lower quality study or from a combination of studies of different quality.

Statistic We'll Use. What this means is that the “Statistic We'll Use” for the main statistic or for the secondary statistic will be based upon the interpretation of the existing statistics and the quality of those statistics. What we find in medicine is that there is a great deal of variation in how people go through their individual thinking process to come up with the statistic they will use, which goes in the “Statistic We'll Use” cell. This is why there are estimations and assumptions in the clinical decision-making process. This is why on the Star Blocks Page after the user comes up with the “Statistic We'll Use” we have provided a comment section in the decision box area so that they can explain their thinking process so that it will be transparent to others.

Critique and improve. Our system is designed so that if someone comes along and critiques any user's conclusions about treatment scores, that critic can do their own treatment scores to see if they can do better. In addition, the original user can update their treatment scores based upon the critiques of others. Our system may be designed so that you can copy all the work of others as your starting point, or you can start fresh from the beginning Our system may also be designed so that different users can weigh the side effects and side benefits of treatments differently according to their own mathematical calculations, feelings, or beliefs.

STAR Blocks™. The STAR Block™ is a very important system. It can allow for a medical statistic to be captured with its reference and to be moved or imported en bloc to any other location for which it may be needed. For example, to the STAR Block™ page for a very similar or related diagnosis.

Feature. An important feature of the STAR Blocks™ is that if you rate the New England Journal of Medicine, for example, in one STAR Block™, that rating should automatically appear in all future's STAR Blocks™ done by that user that contain the New England Journal of Medicine.

If the user rates the Journal of the American Medical Association (JAMA), in one STAR Block™, and rates the British medical Journal in another STAR Block™, those ratings for those journals in that user's STAR Blocks™ should become part of future STAR Blocks™ created for that user.

The same may apply to the ratings for authors and institutions, when the authors and institutions are the same in future STAR Blocks™. Once they have been rated once, they can appear at all future STAR Blocks™ with the same rating.

We can also add and delete cells and features to the STAR Blocks™ as needed.

Important Feature: Moving Star Blocks around. The STAR Blocks™ may be converted into graphics with metadata, or we may continue to have them as cells in a spreadsheet or database. The fact that once a STAR Block™ is created that it can be moved with some or all of its data intact for use with other diagnoses is a very important advantage.

Another use for STAR Blocks™. We have come up with another very important use for the STAR Blocks™ besides capturing the “Statistic We Have.” Not only do we use them to get a statistic from a medical study, but we also use them to put review articles on the STAR Block™ page, and to put blog posts on the STAR Block™ page. We may also use them to put Internet advertisement essays on the STAR Block™ page. Basically, any review or any source of data can be put into a STAR Block and the link will be there to take any user to that source.

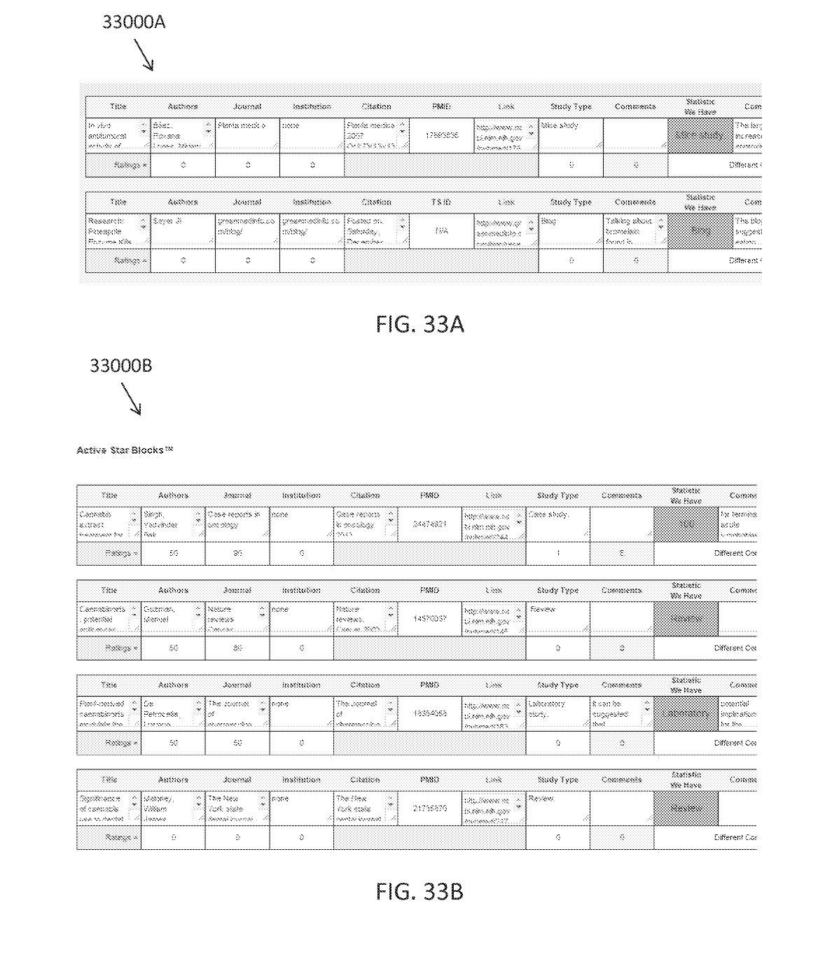

For example, in the two STAR Blocks™ 33000a shown in FIG. 33A, we do not actually have any statistic. Instead, we just note that the top medical study is a mice study, and that the bottom article is a blog post.

For example, a patient came to me with the blog post which glowed and glowed about how pineapples could cure cancer. So I read the article. The article eventually referenced the study. I went to that study and found out it was about an enzyme called bromelain from pineapples. I also found out that bromelain had never been studied in humans against the cancer we were talking about. The point being that the STAR Block™ helps us keep track of the original source of information that is spurring us to look into a treatment. If you search chemotherapy alternatives on the Internet you will find thousands of articles about substances that are allegedly better than chemotherapy. Using the STAR Blocks™ system we can put the original link into a STAR Block™ and use that as the starting point to review of the medical literature looking for real statistics from human studies to capture in other STAR Blocks™.

Review Articles in STAR Blocks™. In similar fashion, even though some medical review articles have no original data in them whatsoever, or no statistics for us to put in our STAR Blocks™, we still put many review articles in STAR Blocks™ so we will have a list of review articles for future reference. You can see in exemplary STAR Blocks™ 33000b in FIG. 33B the where the statistic would be it simply says “Review.” This can help users to find and keep track of the best review articles, or the already looked at review articles, on certain topics.

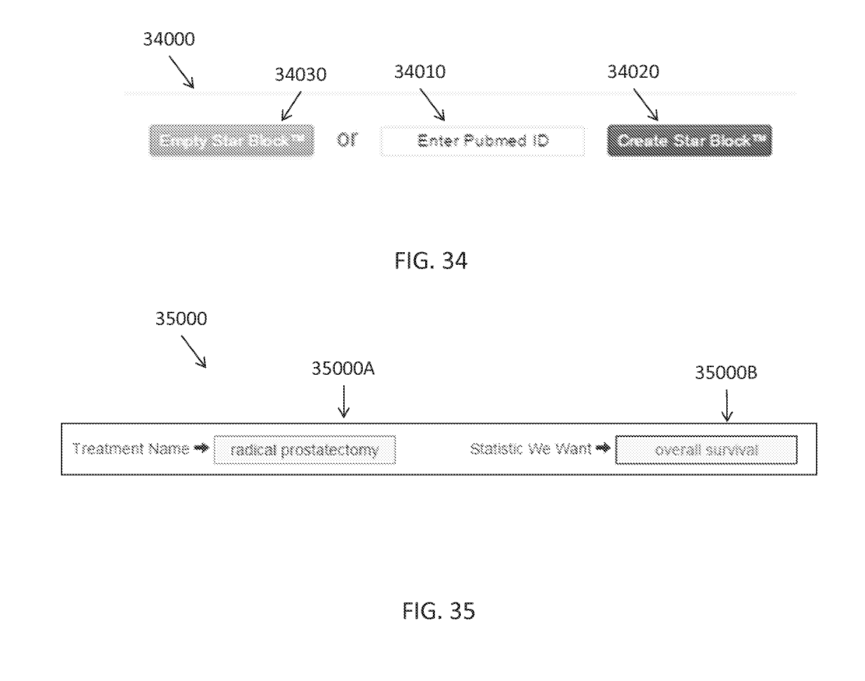

Creating a STAR Block™. Several methods may be provided to create STAR Blocks™. For example, a creation menu 34000 shown in FIG. 34 may be used and by entering a PubMed ID number or other journal article identifier in journal article identifier box 34010 and hitting the “Create Star Block” button 34020, a STAR Block will be created and the system automatically scrapes as much of the objective information as it can. We have done this for BioMed Central and PubMed Central identification numbers as well. We can do this for many such databases of medical articles. Also, one can create an empty STAR Block by clicking on “Empty Star Block” button 34030.

Collaboration. One point that has not been emphasized enough is that the system is designed so that one user can create treatment scores for a diagnosis, or that user can work with other users to collaboratively create treatment scores for a diagnosis. This is why on our diagnosis tool we allow more than one author, i.e. collaborators, to be inputted.

Interactive. The processes are highly interactive. Clicking somewhere on a diagnosis can take you to a treatment list. Clicking somewhere on a treatment list can take you to a treatment score analyzer. Clicking somewhere on the treatment score analyzer can take you to the STAR Block™ page. Clicking somewhere on the STAR Block™ page can take you to the source of the statistic for that STAR Block™. This type of organized and visual interactivity is in a new style that we have created.

Ceiling on the Statistic. The ceiling feature described above and herein can be an important option to use for the main statistic. In some embodiments, it can be used for the secondary statistics as well.

Another point about the ceiling being put on statistics and treatment scores is that the ceiling may not be put on just because of the quality of a study or studies, but may also be put on because of the low relevance of the study or studies.

For example, we may have a STAR Block™ of chemotherapy X for malignant melanoma. The statistic in the STAR Block™ may not have any ceiling on it because it is a high-quality randomized controlled study. However, some users may want to use that same chemotherapy X on a different solid cancer such as malignant cervical cancer and may want to use that same STAR Block™ and statistic in their list. However, now the relevance of that STAR Block™ and its statistic goes down because the diagnosis may not be the same.

This is another reason for putting a ceiling on the statistic and on the eventual treatment score that is derived using that statistic. It is just not as relevant because it was used on a cancer, but a different cancer. Some will argue that chemotherapy probably works on any solid tumor, but others will point out that chemo often doesn't work the same on any solid tumor.

To reiterate how the ceiling works. Once a statistic is captured in a STAR Block™, if the quality of the study is rated lower than the statistic, or if the relevance is not as high as we want it to be, a ceiling can be put on that statistic. The ceiling is put on when we put the “Statistic We'll Use” in the decision box. In fact in many embodiments, the ceiling is put exactly over the “Statistic We'll Use” in the decision box. It is the “Statistic We'll Use” that may get transferred into the Treatment Score Analyzer, whether it is for the main statistic or the secondary statistics.

In other words, we can look at the “Statistic (s) We Have” and we come up with the “Statistic We'll Use” and then we will put a ceiling on the “Statistic We'll Use” if indicated because of low quality of studies or low relevance of studies. In some embodiments, that ceiling will show up above the main statistic and above the eventual treatment score.

The ceiling may be an optional device that the users can use or not use based upon their own discretion. We already see that we use it much more for the main statistic and much less often for the secondary statistics.

Prevention as a treatment. Our system can also handle “prevention” as being a treatment. For example, giving a vaccine to prevent the disease from ever happening can be put under the treatment list for that disease, or it can be put under the treatment list for a special diagnostic category of that disease with the modifier “prevention” added. For example, there might be two diagnoses: 1) Measles, symptom resolution, 1 week, all patients; and, 2) Measles, prevention, lifetime, all patients.

The first diagnosis may focus on treating patients who currently have measles, while the second diagnosis may focus on the treatment scores for various vaccines, or other preventative measures, preventing measles from ever occurring in the first place.

Net Health Benefit. In the medical literature all kinds of statistics are given. Statistics such as overall survival, disease specific survival, the number needed to treat, event rates of side effects and so on and so forth. With our methods and systems, we are trying to get closer to statistics that are more important for the actual patient.

In some embodiments, when the main statistic is about survival, treatment scores can be considered to be closer to the “net health benefit” or the “net absolute health benefit” for the patient when dealing with life and death situations.

Exactly what the treatment score means can vary depending on what main statistic is being used. Sometimes the treatment scores is much more about “symptom resolution” than about survival. However, in many embodiments, we are getting far closer to the net health benefit, or the net absolute health benefit, for the patient than any statistic has ever done before. Our system can try to give the patient the information they need.

Statistics We Want, We Have, and We'll Use. We have created tools that will enable almost any user of any skill level to do an evidence-based medicine review of the existing data. Embodiments of the present disclosure put a graphical user interface on the process of determining the science of medicine behind any treatment or behind any other clinical decision and an accessible graphical user interface to show the determined science of medicine.

Statistic We Want. For every diagnosis there are many statistics that we want. We may want survival statistics, disease resolution statistics, side benefit statistics, negative side effect statistics, and so on. At the top of the Statistics and a Reference page (STAR Block™ page) we indicate the “Statistic We Want.” The Statistic We Want is typically a perfect statistic from a perfect randomized controlled study. However, that perfect statistic is often not available.

For example, we may have a treatment, such as the radical prostatectomy (shown in treatment box 35000a), and the “Statistic We Want” is overall survival (shown in statistic box 35000b) as shown in entry box 35000 in FIG. 35.

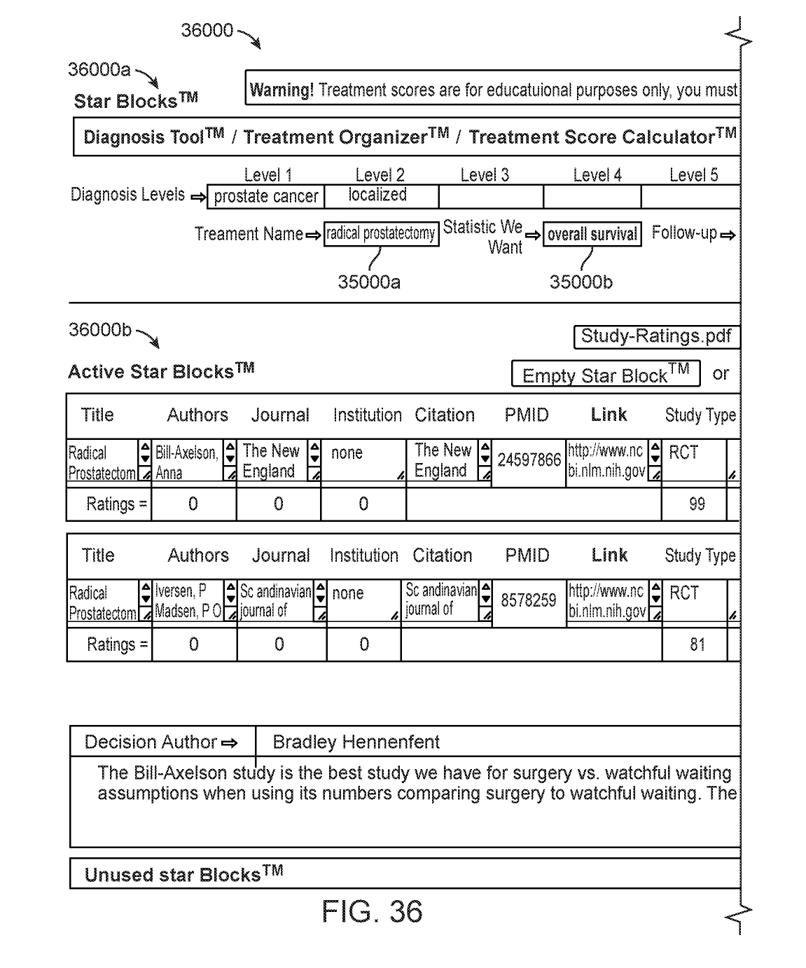

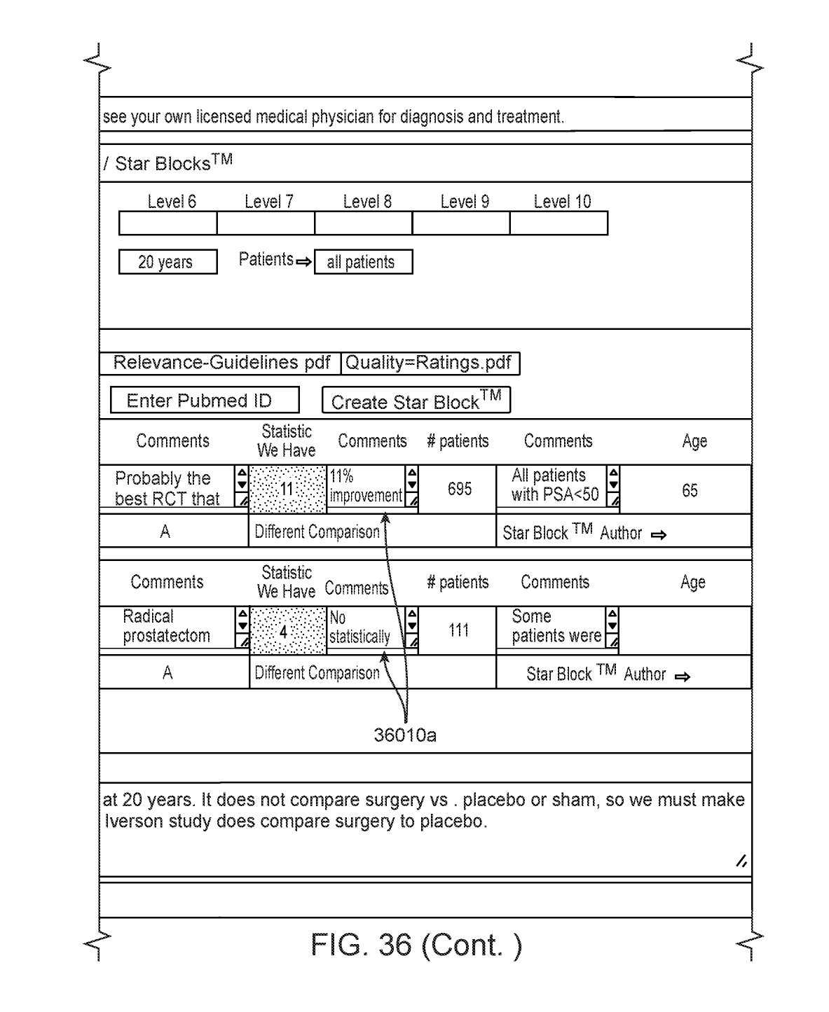

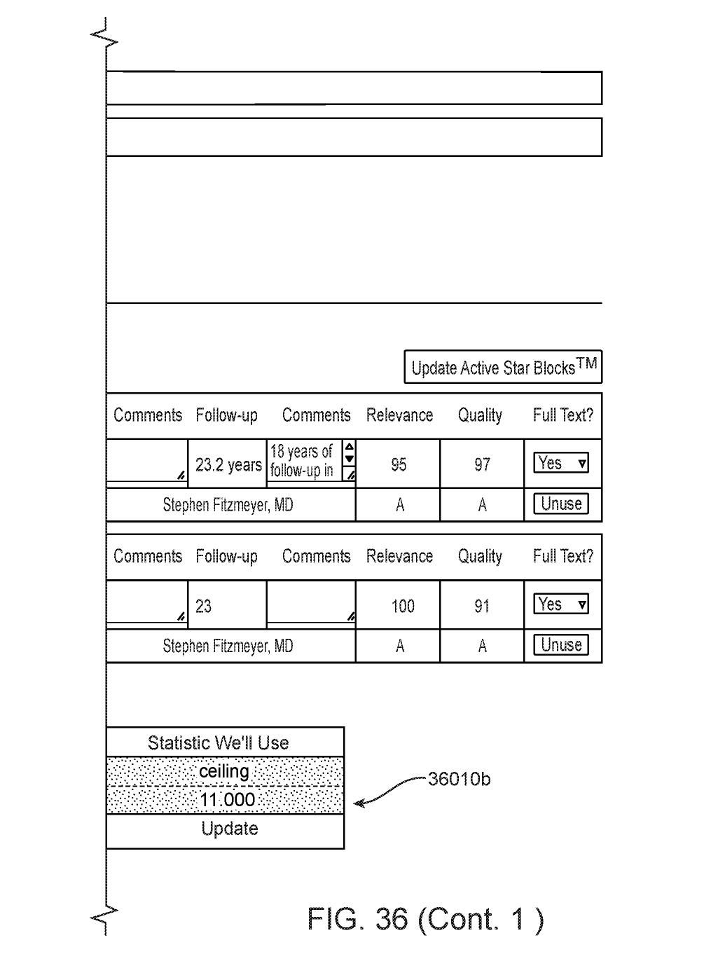

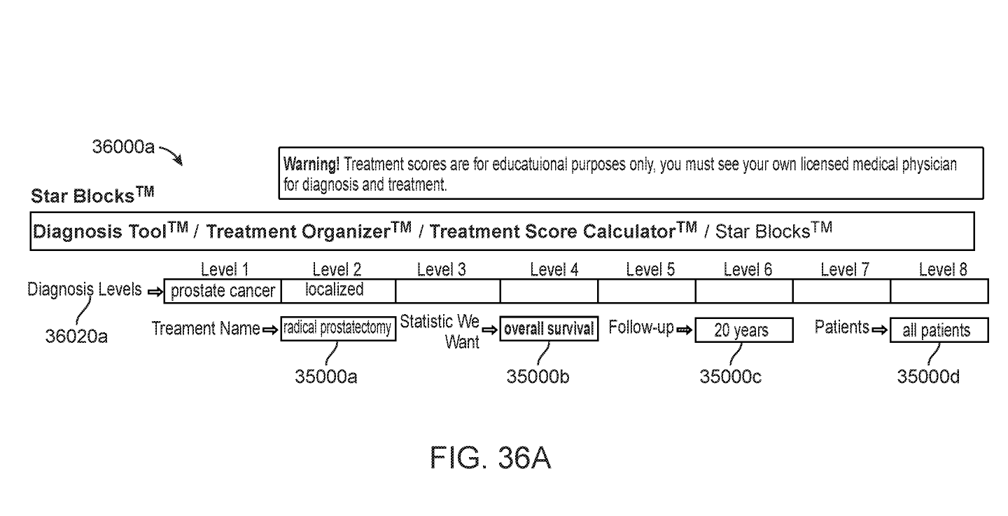

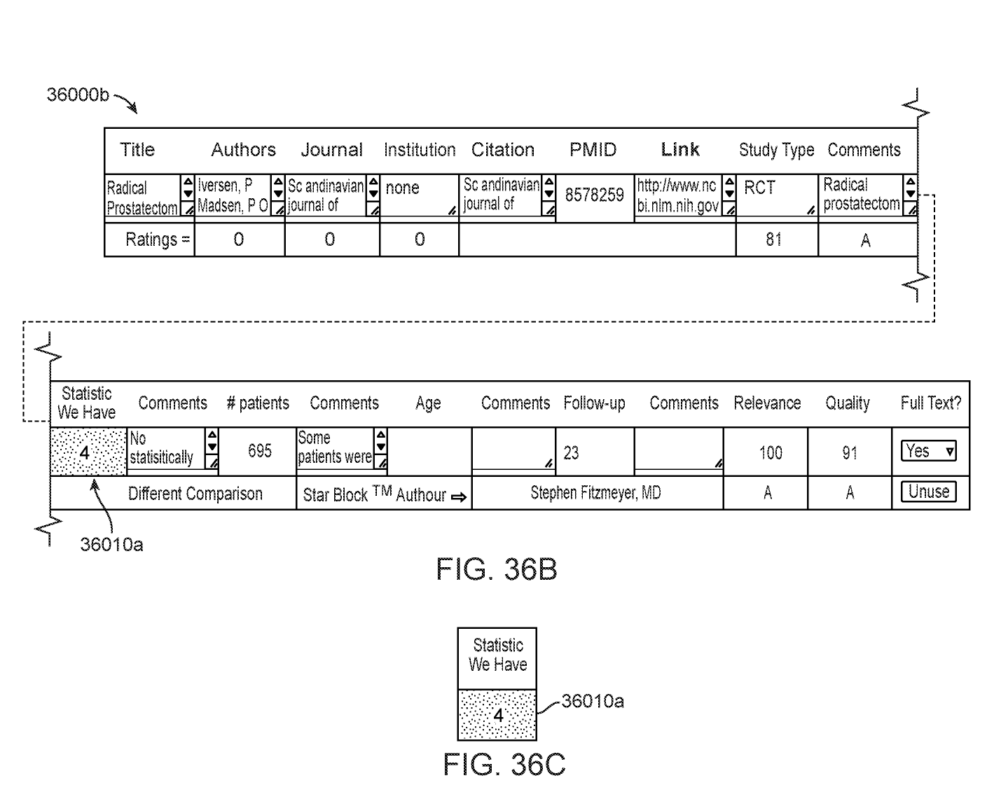

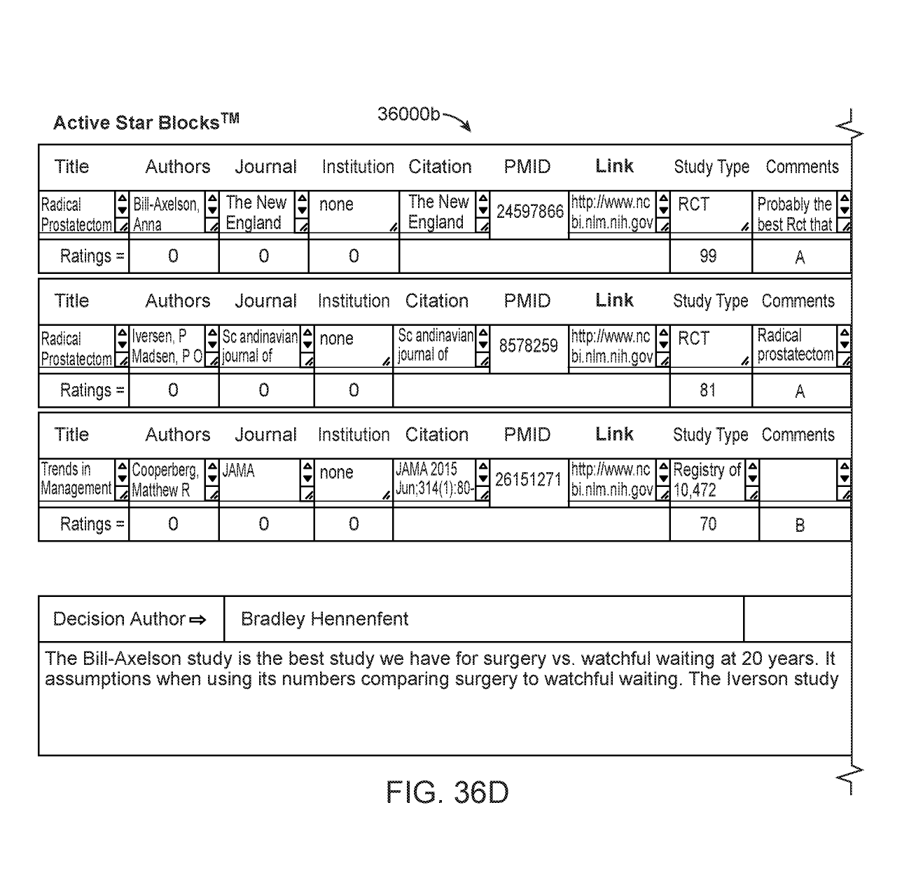

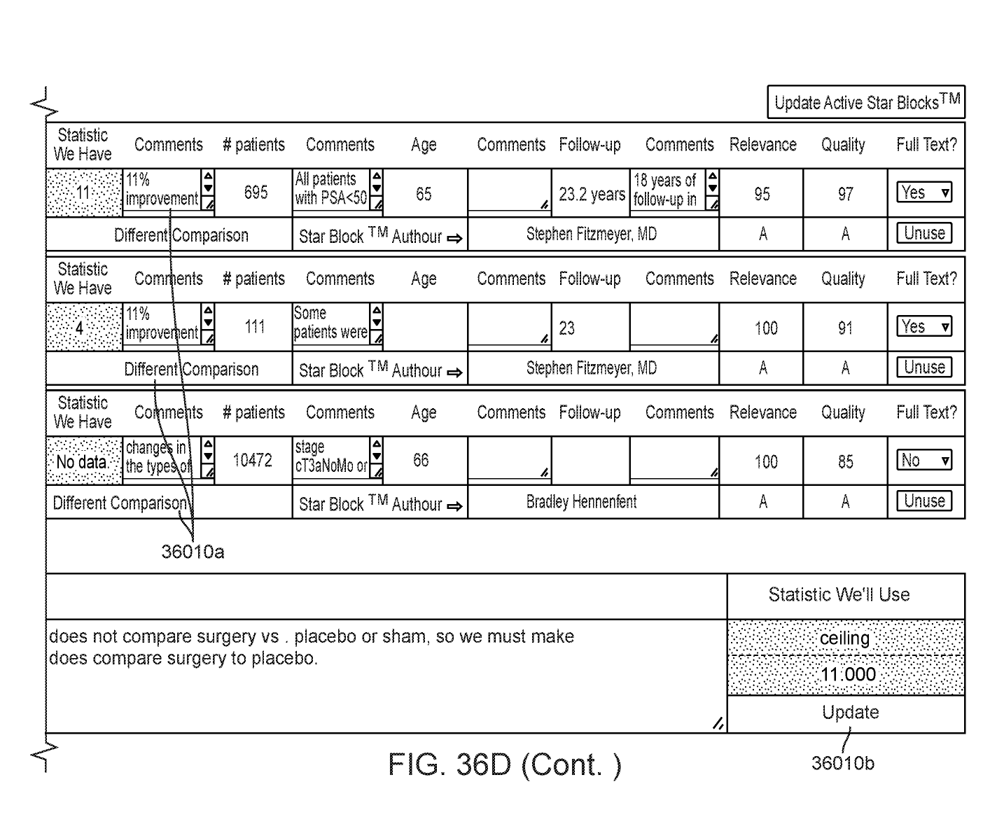

This can also be seen in the overall STAR Block™ page 36000 shown in FIG. 36, which may include a diagnosis level information and input bar 36000a and a medical study information area 36000b. The overall STAR Block™ page 36000 also includes boxes 36010a for “Statistics We Have” and a user input box 36010b for “Statistic We'll Use.”

The Diagnosis and the Statistic We Want. Note that on the Statistic and a Reference, or STAR Block page we list the diagnosis 36020, the treatment 35000a, the Statistic We Want 35000b, the follow-up period 35000c, and a description of the patients 35000d, as shown in FIG. 36A.

The Statistic We Have. The problem is that the Statistic We Want is almost never available to us as a perfect statistic from a perfect study. So what we do is we collect the “Statistics We Have” from less-than-perfect studies, trying to find the statistics from all the best existing studies. As shown in FIGS. 36B and 36C, we are using below the Statistic We Have in box 36010a.

We can find the best studies for the Statistic We Want and we come up with STAR Blocks™ containing the less-than-perfect statistics that we actually have, that currently go in the “Statistic We Have” cell. It is enlarged in FIG. 36C.

Lists of STAR Blocks™ with Statistics in Them. At this stage we have gone from the Statistic We Want, to a list of the statistics we actually have surrounded by their reference data as shown in medical study information area 36000b as shown in FIG. 36D. The Statistics We Have can come from various studies of various quality. We can take the list of Statistics We Have and we can separate them into statistics that are high enough quality to use in our decision and into statistics that we will not use in our decision for the “Statistic We'll Use.”

Statistic We'll Use. We can use what we call the “Decision Box”, shown as user input box 36010b in FIG. 36D, to separate our statistics into those we will use from those we will not use in our final decision for the “Statistic We'll Use.”

For example, we may decide to use the statistic from only one study such as the study with the statistic “11” because it is so much better than any other study in existence. It is a randomized controlled study and no patients were lost to follow-up. The other studies can be of lesser quality. For instance, we can place the STAR Blocks™ with the “Statistics We'll Use” above the decision box, the STAR Blocks™ containing the statistics we will not use below the decision box. This can help us to visualize the best data from the lower quality data.

Automatically, Semi-Automatically, and Manually. In some embodiments, the entire process done automatically with software. The process may also be performed semi-automatically and manually.

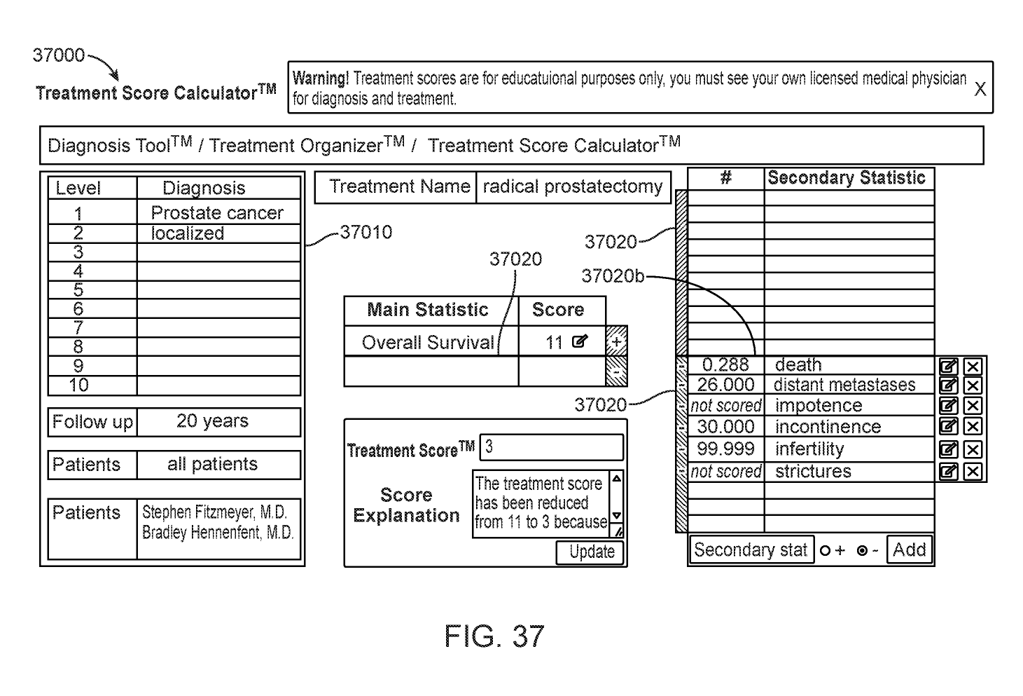

Treatment Score Analyzer. Our system allows us to collect the many different “Statistic(s) We'll Use” from as many studies as necessary and put them into our Treatment Score Analyzer. As shown in FIG. 37, for example, the treatment score analyzer 37000 can contain our diagnosis 37010, our main statistic 37020, and all the secondary statistics 37030. The treatment score analyzer 37000 can collect all the “Statistic(s) We'll Use” from all the STAR Block™ pages. All of these statistics may have been determined by using the STAR Block™ process to come up with the Statistic We'll Use, which is the number value we will use, for that particular statistic.

In the example in FIG. 37, we have collected the Statistic We'll Use for overall survival, and the “Statistic(s) We'll Use” for several of the negative side effects 37020b into the Treatment Score Analyzer 37000. In addition, because the side effects are so damaging, the main statistic 37020, the overall survival of 11, has been reduced to 3 as the final treatment score 37040.

As shown in FIG. 37, we have adjusted the treatment score using all the negative side effects 37020b simultaneously as a group. Alternatively, we can adjust for all the side effects 37020b individually or separately. We can make these adjustments using a visual analog scale for the entire group, for each side effect or side benefit individually, or we can make these adjustments using mathematical formulas, or even up and down arrows, or other techniques.

Importantly, the user can visualize the entire process, and the system can be done automatically, semi-automatically, or manually, depending on what the user is comfortable with and what the technology can provide.

We may be able to compare automatic processes, semi-automatic processes, and manual processes.

While preferred embodiments of the present disclosure have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1. A method for evaluating medical procedures or clinical studies, the method comprising:
receiving, at a computing device, a plurality of diagnostic features, the plurality of diagnostic features comprising one or more of a disease type, a disease progression, a follow-up time, or a patient population;
generating, with the computing device, a diagnosis in response to the received plurality of diagnostic features;
acquiring, from an online data source of at least one of peer-reviewed or non-peer reviewed medical information, a plurality of medical procedures or clinical or non-clinical studies or reports in response to the generated diagnosis, each of the medical procedures and clinical or non-clinical studies or reports comprising quantitative and qualitative information;
generating, with the computing device, an evaluation score of the plurality of medical procedures or clinical or non-clinical studies or reports in response to (i) the quantitative and qualitative medical information of the plurality of medical procedures or clinical or non-clinical studies or reports and to (ii) the plurality of diagnostic features; and
displaying the evaluation score of the plurality of medical procedures or clinical studies to a user, wherein the evaluation score is displayed on a display of a client computing device of the user.

2. The method of claim 1, wherein displaying the evaluation score of the plurality of medical procedures or clinical or non-clinical studies or reports comprises ordering the plurality of medical procedures or clinical or non-clinical studies or reports by evaluation score.

3. The method of claim 2, wherein ordering the plurality of medical procedures or clinical or non-clinical studies or reports by evaluation score comprises ordering the plurality of medical procedures or clinical or non-clinical studies or reports by descending order of evaluation score.

4. The method of claim 2, wherein ordering the plurality of medical procedures or clinical or non-clinical studies or reports by evaluation score comprises ordering the plurality of medical procedures or clinical or non-clinical studies or reports by ascending order of evaluation score.

5. The method of claim 1, wherein the quantitative and qualitative information of each of the medical procedures or clinical or non-clinical studies or reports comprises one or more of relevance, subject randomization, subject control, study population size, study authors, publication source, publication time, author rating, study type, study citations, source institution, survival rate, primary evaluation statistic, or other relevant statistic.

6. The method of claim 1, wherein the evaluation score is based on one or more of a scale from 0 to 100, −100 to 100, or A to F.

7. The method of claim 1, further comprising sorting the acquired plurality of medical procedures or clinical or non-clinical studies or reports into a first category for consideration and a second category for non-consideration, wherein the evaluation score is generated in response to the first category for consideration and not the second category for non-consideration.

8. The method of claim 7, wherein sorting, with the computing device, the acquired plurality of medical procedures or clinical or non-clinical studies or reports comprises providing a user control for the user to select an individual medical procedure or clinical or non-clinical study or report for categorization.

9. The method of claim 7, further comprising dynamically, automatically, semi-automatically, or manually updating the evaluation score as the acquired plurality of medical procedures or clinical or non-clinical studies or reports are sorted.

10. The method of claim 9, wherein the dynamically, automatically, semi-automatically, or manually updated evaluation score is provided to a user in near real-time.

11. The method of claim 1, wherein providing the evaluation score of the plurality of medical procedures or clinical or non-clinical studies or reports comprises displaying, with a display of the computing device, the evaluation score to a user.

12. A system for providing an evaluation of medical procedures or clinical or non-clinical studies or reports, the system comprising a network-based computer system including at least one server computer in communication with a multiplicity of client computing devices, wherein the at least one server computer is operable with software active thereon to (i) access an online data source of at least one of peer-reviewed or non-peer reviewed medical information, (ii) generate an evaluation score of a plurality of medical procedures or clinical or non-clinical studies or reports in response to quantitative and qualitative medical information from the at least one of peer-reviewed or non-peer reviewed medical information and a plurality of diagnostic features provided by users of the remote devices, and (ii) provide evaluation scores of the plurality of medical procedures or clinical or non-clinical studies or reports to the users through the remote devices, wherein the provided evaluation scores are displayed to at least one user through a display of the client computing device of the at least one user.

13. The system of claim 12, wherein the at least one of peer-reviewed or non-peer-reviewed medical information comprises medical literature publications describing the plurality of medical procedures or clinical or non-clinical studies or reports.

14. The system of claim 12, wherein the quantitative and qualitative medical information from the at least one of peer-reviewed or non-peer-reviewed medical information comprises quantitative and qualitative medical information of the plurality of medical procedures or clinical or non-clinical studies or reports.

15. The system of claim 14, wherein the quantitative and qualitative information of each of the at least one of medical procedures or clinical or non-clinical studies or reports comprises one or more of relevance, subject randomization, subject control, study population size, study authors, publication source, publication time, author rating, study type, study citations, source institution, survival rate, primary evaluation statistic, or other relevant statistic.

16. The system of claim 12, wherein the plurality of diagnostic features comprises one or more of a disease type, a disease progression, a follow-up time, or a patient population.

17. The system of claim 12, wherein the software active on the at least one server is configured to retrieve the peer-reviewed medical information from one or more online data sources of medical procedures or clinical or non-clinical studies or reports.

18. The system of claim 12, wherein the plurality of diagnostic features and the evaluation scores of the plurality of medical procedures or clinical or non-clinical studies or reports are provided through a social network comprising the network-based computer system.

19. The system of claim 18, wherein the social network is user-access restricted.

20. The system of claim 12, wherein the software active on the at least one server is configured to order the plurality of medical procedures or clinical or non-clinical studies or reports by evaluation score.

21. The system of claim 20, wherein providing the evaluation scores of the plurality of medical procedures or clinical or non-clinical studies or reports to the users through the remote devices comprises providing a user interface on the remote devices of the users, the user interface showing two or more of the user provided plurality of diagnostic features, the ordered plurality of medical procedures or clinical or non-clinical studies or reports, the evaluation scores, or the quantitative and qualitative medical information of the plurality of medical procedures or clinical or non-clinical studies or reports, wherein the user interface is displayed on displays of the client computing devices of the users.

22. The system of claim 21, wherein the user interface is further configured to provide a user control for an individual user to sort the ordered plurality of medical procedures or clinical or non-clinical studies or reports into a first category for consideration and a second category for non-consideration, wherein the evaluation score is generated in response to the first category for consideration and not the second category for non-consideration.

23. The system of claim 22, wherein the user control comprises a drag-and-drop function, an import function, a “decision box” separator, or some other way to move information around or within the system.

24. The system of claim 22, wherein the user interface is configured to update and display the evaluation scores in near real-time or longer in response to the individual user sorting the ordered plurality of medical procedures or clinical or non-clinical studies or reports.
